(19) United States
(12) Patent Application Publication
(10) Pub. No.: US 2015/0193979 A1
(43) Pub. Date: Jul. 9, 2015

(54) Multi-user virtual reality interaction environment

(71) Applicant: Andrej Grek, Bratislava (SK)

(72) Inventor: Andrej Grek, Bratislava (SK)

(73) Assignee: Andrej Grek, Bratislava (SK)

(21) Appl. No.: 14/150,000

(22) Filed: Jan. 8, 2014

(51) Int. Cl. G06T 19/00

(52) U.S. Cl. CPC G06T 19/006; G06T 19/003; G06T 2219/024; G06T 2219/2016

(57) ABSTRACT

Systems, devices, methods and computer-readable storage mediums storing instructions are provided that enable multi-user interaction with detailed virtual objects of a shared virtual space superimposed for all users identically on a shared physical space. Experiences that can be achieved by users of a multi-user group during such interaction are collectively called a multi-user virtual reality interaction environment experience. During the enabled interaction, users can collaborate and communicate simultaneously within the shared virtual space and the shared physical space. This results in both spaces being interrelated and intuitive to navigate and creates a virtual reality experience combined with physical reality, which is shared by all users. Interactions with the shared virtual space are performed using manually positioned and operated portable interactive devices with trackers, movement of which is tracked in the shared physical space and is used to control individual views of the detailed virtual objects of the shared virtual space.

### BACKGROUND

1. Field of the Invention

The present invention relates generally to multi-user interaction with virtual objects of a virtual 3D environment, rather called virtual space, and more particularly to multi-user interaction with detailed virtual objects of a shared virtual space that is at the same time superimposed for all users identically on a shared physical space, creating a multi-user virtual reality interaction environment experience with simultaneous virtual and physical collaboration and communication of users.

The present invention further relates to multi-user interaction with detailed virtual objects of a shared virtual space superimposed on a shared physical space, using portable interactive devices movement of which is tracked in the shared physical space, enabling navigation within the shared virtual space and interaction with detailed virtual objects, acting as virtual space view controlling devices and virtual cursor pointing devices, capable of registering input signals and at the same time displaying views of the shared virtual space.

2. Description of the Related Art

Virtual three-dimensional environments, or rather virtual spaces, are simulations of physical three-dimensional environment generated by computing devices, and populated with various virtual objects. Virtual spaces populated with virtual objects are widely used in software applications and many of them also enable multiple users to share the same virtual space, whether they are in separate geographical locations or also share the same physical space. Users interact with virtual spaces essentially by changing their views of the virtual spaces displayed on their display devices and by interacting with virtual objects of the virtual spaces. Various examples exist that provide users with such virtual space and virtual object interaction capabilities, and while utilizing a wide range configurations of display and input devices, the examples are not capable of enabling multi-user interaction with detailed virtual objects of a shared virtual space superimposed for all users identically on a shared physical space.

In many examples, software applications for interaction with virtual spaces are configured to receive input from various input devices and display views of virtual spaces on static display devices. Such examples include the majority of computer entertainment, engineering and design software applications that generate views of virtual spaces.

Computer entertainment software applications which enable multi-user access of virtual spaces are vastly focused on providing online connectivity of geographically separated users, and in such scenarios understandably do not provide users with ways to interact in a shared physical space.

Specialized engineering and design software applications that display views of virtual spaces, on the other hand, provide absolutely no way for multiple users to simultaneously share virtual spaces and collectively interact with virtual objects of those virtual spaces.

Some examples of software applications for interaction with virtual spaces, which use static display devices for displaying views of virtual spaces, are configured to receive input from input devices with motion sensing capability. These examples include software applications for game consoles or computers, which use hand operated controllers with variously achieved six degree of freedom motion sensing capability or which use body movement to perform input signals by capturing user or object movement using cameras.

Although software applications with such input mechanisms allow users to interact with virtual spaces while sharing the same physical space in front of a static display device, there is a separation between where users needs to concentrate their vision and where users perform their motion input signals. Therefore, despite being able to move to perform input signals, users are attached to a static display device and cannot rotate around and effectively utilize the shared physical space for interaction.

Such software applications, which are using static display devices for displaying views of virtual spaces, are not capable of creating a shared virtual space superimposed on a utilizable shared physical space. The resulting virtual space would be superimposed on physical space behind the static display device and users would be located outside of it.

Some recent examples of software applications for interaction with virtual spaces are configured to display views of virtual spaces on head-mounted display devices disabling or significantly limiting the views of users into surrounding physical space. Such display devices are often further configured to register head motion of users, while they are located in front of a motion-registering unit. Software applications, which utilize these display devices, then use the head motion to control views of virtual spaces.

Even though such software applications create a complete visual immersion for users, they also disconnect users visually from their surrounding physical space and require all interactions between users to take place in a virtual space, regardless of whether they are located in a shared physical space or not. This requirement limits usability of such interaction mechanisms in some multi-user scenarios, where physical face-to-face user communication is necessary, rendering software applications using the interaction mechanisms inappropriate. Furthermore, while using these software applications users are also attached to the static motion-registering unit to perform motion-based input signals and are unable to fully utilize the physical space for interaction.

Some more recent examples of software applications for interaction with virtual spaces display views of virtual spaces using head-mounted display devices that are tracked in physical space. These devices are tracked inside of tracking volumes covering not just small limited volumes generated in front of motion-registering units, but at least room-sized physical spaces that allow users to move around.

Software applications, which utilize such display devices that are tracked in physical space, are capable of translating physical movement of the display devices into movement of virtual cameras that define views of virtual spaces. Further input signals that cause the software applications to execute functions, which allow users to interact with virtual objects, are then performed by tracking motion of hands of users or by reading input from complementary input devices such as hand operated controllers.

Although these software applications can provide multiple users with a shared virtual space superimposed on a shared physical space and with ability to interact with virtual objects, in order to interact with details of virtual objects, users would need to move their heads into awkward positions to acquire views that show certain parts of detailed virtual objects, that reveal the contained details. The limitation of the previously mentioned software applications, due to which users cannot communicate face-to-face in physical space, applies as well.

Software applications for interaction with virtual spaces using head-mounted display devices for displaying views of virtual spaces are also more difficult to implement than those utilizing conventional display devices. This is due to the motion of virtual cameras that define views of virtual spaces needing to be in perfect synchronization with the motion of head-mounted display devices to prevent motion sickness of users. Providing views of virtual spaces from any other points of view than from first person views of virtual characters would also break immersion of users in virtual spaces, that is based on the illusion of users that the synchronization of movement of virtual cameras and movement of their heads is a result of users being present in or impersonating the virtual characters.

Furthermore, some software applications for interaction with virtual spaces using head-mounted display devices for displaying views of virtual spaces allow displaying detailed virtual objects. User interaction with such objects however, requires providing special software functions for zooming in on the details of the virtual objects or positioning of heads of users in anatomically very difficult, if not completely impossible to achieve, positions. Movement of a head in space requires the whole body to adjust and follow the movement, which can be very difficult. Viewing small parts of detailed virtual objects may require users to position their heads into positions that are out of their reach, and therefore may not be possible at all. The ability to interact with small parts of detailed virtual objects is therefore highly limited using such software applications.

Some software applications for interaction with virtual spaces using head-mounted display devices for displaying views of virtual spaces attempt to solve their inability to provide users with viewing and interacting capabilities with detailed virtual objects by providing special software functions for zooming in on details of those virtual objects. These software applications allow users to perform input signals for changing positions of virtual cameras or of other virtual objects and thereby allow users to enlarge virtual objects in their views of virtual spaces.

When a user of a multi-user group performs such input signals, even if these software applications generate a shared virtual space superimposed on a shared physical space, there is no possibility of these software applications maintaining a shared virtual space that is at the same time superimposed for all users identically on a shared physical space. Each user of the multi-user group who performs such input signals will be viewing a shared virtual space superimposed on a shared physical space in a different way.

Additionally, users who interact with virtual spaces superimposed on physical spaces using these software applications in conjunction with head-mounted display devices that are tracked in physical space, and who also use software functions for zooming in on details of virtual objects, cannot be at the same time present in a shared physical space. The problem that prevents users from being able to be in a shared physical space is that their shared virtual space is superimposed for each user differently. Positions of users that are marked in a shared virtual space would correspond to positions in a shared physical space, that would be completely different from true positions of users in the shared physical space. Due to head-mounted display devices restricting view of users into physical space, users would not be able to know true positions of other users in their shared space and would involuntarily collide with each other.

Further, such software applications for interaction with virtual spaces exist that are configured to display views of virtual spaces on head-mounted display devices overlaying views of surrounding physical space with views of virtual spaces, the resulting effect being called augmented reality. Although by using these software applications, users are able to see when a shared virtual space is superimposed on a shared physical space differently from other concurrent users, this method has most of the previously mentioned limitations.

Using head-mounted display devices tracked in physical space for interacting with detailed virtual objects of virtual spaces is impractical in general. Users cannot view small parts of detailed virtual objects or achieve certain viewing angles on virtual objects, as that would involve them positioning their heads in awkward or impossible positions. Moreover, users can keep their shared virtual spaces superimposed for all users identically on a shared physical space only if they do not use any software functions for zooming in on details of virtual objects.

Furthermore, such software applications for interaction with virtual spaces that utilize augmented reality and display views of virtual spaces overlaying views of physical space are compromising on the image quality of one of the views. When the combined views are displayed using head-mounted display devices that restrict view of users into surrounding physical space, both views are image streams and the image stream containing view of physical space is of lowered quality, due to it being captured by a physical camera, introducing image noise. When the combined views are achieved by displaying views of virtual spaces using semi-transparent head-mounted display devices that overlay a view of surrounding physical space with an image stream containing views of virtual spaces, the image stream containing views of virtual spaces is of lowered quality, due to it being displayed semi-transparent, losing brightness, contrast and color. Therefore, the resulting image quality of head-mounted display devices that are used with such software applications that utilize augmented reality, is always lower than the image quality of display devices displaying only views of virtual spaces.

Many examples of software applications for interaction with virtual spaces are configured to display views of virtual spaces using mobile handheld devices, such as tablets. The devices are almost universally capable of registering input signals and sometimes are also capable of sensing their own motion in physical space using accelerometers, gyroscopes, compasses and similar sensors. Software applications using such interactive devices to display views of virtual spaces and receive input signals for interacting with virtual objects of virtual spaces, utilize the sensed motion as input signals to control views of virtual spaces.

Such software applications allow interacting with detailed virtual objects using special software functions, such as zooming in on details of virtual objects and, due to the used handheld devices not restricting views of users into their surrounding physical space and due to them being portable, also allow multiple users to share the same physical space and collaborate and communicate simultaneously in virtual and in physical spaces. In spite of the mentioned capabilities, these software applications are not capable of generating a shared virtual space that is at the same time superimposed for all users identically on a shared physical space.

In some examples, software applications for interaction with virtual spaces use mobile handheld devices such as tablets that are tracking their surrounding physical space to determine their position in the surrounding physical space and display views of virtual spaces so that virtual spaces appear to be superimposed on the physical space. The views of virtual spaces generated by these software applications are controlled, by positioning of the handheld devices in physical space. Such interaction allows users to acquire an impression, that displays of the handheld devices are actually windows into virtual spaces.

These software applications are nonetheless limited, by being dependent on reference objects or images, which are used as markers when being tracked by the handheld devices that are tracking their surrounding physical space. Precision of handheld device based tracking further depends on large quantity of visual information on the reference objects or images. In order to allow the handheld devices to track at least a room-sized physical space and be able to zoom in on details of virtual objects, a large quantity of reference objects would need to be added on the perimeter of the physical space. Multiple users would not be able to share the same physical space, as they would block handheld devices of each of the users from tracking the reference objects located on the perimeter of their surrounding physical space. Software applications utilizing handheld device based tracking, are therefore unable to create a shared virtual space superimposed for all users identically on a shared physical space.

Further, some examples of software applications for interaction with virtual spaces use a single special-purpose handheld device for displaying views of virtual spaces and interacting with virtual objects, that is tracked in physical space by an external tracking device such as motion capture camera system. The tracking device tracks special tracking objects or markers positioned on the special-purpose handheld device and determines its position and rotation in the physical space, allowing software applications to generate views of virtual spaces based on the position and rotation of the special-purpose handheld device in the physical space, so that the views of virtual spaces displayed on the special-purpose handheld device appear superimposed on the physical space.

Because the tracking device is mostly capable of eliminating occlusion of tracking objects or markers with good coverage of the physical space by motion capture cameras, more than one user can easily occupy the same physical space without constantly blocking tracking of the special-purpose handheld device.

While displaying views of virtual spaces superimposed on the physical space on the special-purpose handheld device and allowing multiple users to be present and communicate physically in the same space pose no problem to these software applications, for tracking they rely solely on motion capture cameras with a narrow field of view, making the system unfeasible and unsuitable for being used in regular indoor environments. These software applications are also missing a mechanism of propagating tracking data to more than one computing device, such mechanism that would allow more than one independent special-purpose handheld device to acquire its own physical space positioning information and to display independent views of virtual spaces so that virtual spaces appear to be superimposed on the physical space. It is therefore not possible, while using these software applications, to create a shared virtual space that is at the same time superimposed for multiple users identically on a shared physical space.

Some examples of software applications for interaction with virtual spaces, that use mobile handheld devices such as tablets for interacting with virtual objects of virtual spaces and for displaying views of virtual spaces, allow users to acquire views of virtual spaces that contain details of virtual objects by precisely positioning their handheld devices in physical space. Interacting with these details of virtual objects further requires users to identify points in virtual space that are located on detailed virtual objects and to perform input signals that correspond to software functions that cause the desired interactions. These software applications are missing a mechanism of precisely identifying points in virtual space, rendering interaction with details of detailed virtual objects extremely difficult or completely impossible.

Moreover, these software applications use handheld devices that are positioned by hands of users in physical space, due to what it is extremely difficult to interact with virtual spaces by using display devices of sizes and weight comparable to desktop display devices. Sizes and weight of display devices used by handheld devices are therefore limited to sizes and weight of mobile devices.

Finally, most of the software applications for interaction with virtual spaces using mobile handheld devices such as tablets are relying on computing devices included in the handheld devices for processing power, and therefore have limited processing capabilities when compared to stationary computing devices.

Such software applications need to limit their contained virtual objects and possible interactions to allow mobile devices to display and process them with their limited processing capabilities. Therefore, displaying virtual spaces, which are comprised of many detailed virtual objects containing a vast amount of geometric features, is impossible using these software applications.

As a result, there is a strong need to solve the aforementioned problems to be able to create a multi-user virtual reality interaction environment with simultaneous virtual and physical collaboration and communication of users, by providing software applications for interaction with virtual spaces with solutions that enable multi-user groups to interact with detailed virtual objects of a shared virtual space that is at the same time superimposed for all users identically on a shared physical space.

It is in this context that the embodiments of the present invention arise.

### SUMMARY

The above deficiencies and other problems associated with software applications for interaction with virtual spaces attempting to provide multiple users with ability to simultaneously interact with detailed virtual objects of a shared virtual space superimposed for all users identically on a shared physical space, are reduced or eliminated, and additional advantages are provided by the following embodiments of the present invention.

Embodiments of the present invention provide systems, devices, methods and non-transitory computer-readable storage mediums storing instructions for enabling multi-user interaction with detailed virtual objects of a shared virtual space at the same time superimposed for all users identically on a shared physical space. It should be appreciated that the present invention can be implemented in numerous ways, such as a system, a device, a method, or as a non-transitory computer-readable storage medium storing one or more programs, which comprise instructions. Several inventive embodiments of the present invention are described below.

In one embodiment, a method for enabling multi-user interaction with detailed virtual objects of a shared virtual space superimposed for all users identically on a shared physical space is provided. The method is being implemented at a computing device connected to one unique portable interactive device with a tracker. One operation of the method comprises accessing a multi-user virtual reality session. The multi-user virtual reality session is managing a shared virtual space. In another operation, at least one virtual camera object is placed into the shared virtual space. Each included virtual camera object is configured to comprise at least one virtual camera.

In another operation, a view of the shared virtual space is generated for each virtual camera of each included virtual camera object. Each view of the shared virtual space is defined by the field of view of a corresponding virtual camera. In another operation, a graphical user interface overlay is generated. The graphical user interface overlay is configured to comprise a virtual cursor that is encompassing points in the shared virtual space. In another operation, each view of the shared virtual space along with the graphical user interface overlay is transmitted to the portable interactive device to be displayed. The transmitting operation is performed using a connection between the computing device and the portable interactive device.

In another operation, the shared virtual space is populated with at least one detailed virtual object. In another operation, tracking data is acquired from a tracking server. The tracking data is used to determine the position and rotation of the portable interactive device in the shared physical space. In another operation, transformation is applied to each included virtual camera object in the shared virtual space. This transformation is based on the acquired tracking data and a superimposing transformation. The operation of applying the transformation allows control of the view of the shared virtual space and the points encompassed by the virtual cursor with manual movement of the portable interactive device within the shared physical space.

In another operation, the shared virtual space is superimposed on the shared physical space, by setting the superimposing transformation, which is being applied to each included virtual camera object. In another operation, points in the shared virtual space encompassed by the virtual cursor are identified. The identified points are located on one or more detailed virtual objects that the virtual space is populated with. In another operation, input signals are received from the portable interactive device. The receiving operation is performed using a connection between the computing device and the portable interactive device. The method also comprises an operation to execute functions corresponding to the received input signals and the identified points.

Each included detailed virtual object is a virtual object occupying the shared virtual space that is characterized by having density of geometric features per one virtual space volume unit substantially higher than 10000. The one virtual space volume unit is a conceptual measurement unit that is superimposed on and effectively corresponds to one cubic foot of physical space. The geometric features of virtual objects are points that define the spatial form of the virtual objects.

In another embodiment, a non-transitory computer-readable storage medium storing one or more programs is provided. The one or more programs comprise instructions, which when executed by a computing device connected to one unique portable interactive device with a tracker cause the computing device to perform operations for enabling multi-user interaction with detailed virtual objects of a shared virtual space superimposed for all users identically on a shared physical space. One operation caused by the instructions comprises accessing a multi-user virtual reality session. The multi-user virtual reality session is managing a shared virtual space. In another operation caused by the instructions, at least one virtual camera object is placed into the shared virtual space. Each included virtual camera object is configured to comprise at least one virtual camera.

In another operation caused by the instructions, a view of the shared virtual space is generated for each virtual camera of each included virtual camera object. Each view of the shared virtual space is defined by the field of view of a corresponding virtual camera. In another operation caused by the instructions, a graphical user interface overlay is generated. The graphical user interface overlay is configured to comprise a virtual cursor that is encompassing points in the shared virtual space. In another operation caused by the instructions, each view of the shared virtual space along with the graphical user interface overlay is transmitted to the portable interactive device to be displayed. The transmitting operation is performed using a connection between the computing device and the portable interactive device.

In another operation caused by the instructions, the shared virtual space is populated with at least one detailed virtual object. In another operation caused by the instructions, tracking data is acquired from a tracking server. The tracking data is used to determine the position and rotation of the portable interactive device in the shared physical space. In another operation caused by the instructions, transformation is applied to each included virtual camera object in the shared virtual space. This transformation is based on the acquired tracking data and a superimposing transformation. The operation of applying the transformation allows control of the view of the shared virtual space and the points encompassed by the virtual cursor with manual movement of the portable interactive device within the shared physical space.

In another operation caused by the instructions, the shared virtual space is superimposed on the shared physical space, by setting the superimposing transformation, which is being applied to each included virtual camera object. In another operation caused by the instructions, points in the shared virtual space encompassed by the virtual cursor are identified. The identified points are located on one or more detailed virtual objects that the virtual space is populated with. In another operation caused by the instructions, input signals are received from the portable interactive device. The receiving operation is performed using a connection between the computing device and the portable interactive device. The one or more programs also comprise instructions for causing an operation to execute functions corresponding to the received input signals and the identified points.

Each included detailed virtual object is a virtual object occupying the shared virtual space that is characterized by having density of geometric features per one virtual space volume unit substantially higher than 10000. The one virtual space volume unit is a conceptual measurement unit that is superimposed on and effectively corresponds to one cubic foot of physical space. The geometric features of virtual objects are points that define the spatial form of the virtual objects.

In another embodiment, a system for enabling multi-user interaction with detailed virtual objects of a shared virtual space superimposed for all users identically on a shared physical space is provided.

The system comprises at least one portable interactive device. Each included portable interactive device comprises a tracker, a display device module, an input device module, and a connection to one unique computing device. The display device module is configured to display a view of the shared virtual space and a graphical user interface overlay, which comprises a virtual cursor. The input device module is configured to register input signals.

The system also comprises a tracking server. The tracking server is tracking the position and rotation of each included portable interactive device with a tracker in the shared physical space. Each tracked portable interactive device is connected to one unique computing device. The tracking server is connected to each included computing device.

The system also comprises at least one computing device with a connection to one unique portable interactive device with a tracker and a connection to the tracking server. Each included computing device comprises one or more processors, memory and one or more programs. The one or more programs are stored in the memory and are configured to be executed by the one or more processors. The one or more programs comprise instructions causing each included computing device to perform operations for enabling multi-user interaction with detailed virtual objects of a shared virtual space superimposed for all users identically on a shared physical space.

One operation caused by the instructions comprises accessing a multi-user virtual reality session. The multi-user virtual reality session is managing a shared virtual space. In another operation caused by the instructions, at least one virtual camera object is placed into the shared virtual space. Each included virtual camera object is configured to comprise at least one virtual camera.

In another operation caused by the instructions, a view of the shared virtual space is generated for each virtual camera of each included virtual camera object. Each view of the shared virtual space is defined by the field of view of a corresponding virtual camera. In another operation caused by the instructions, a graphical user interface overlay is generated. The graphical user interface overlay is configured to comprise a virtual cursor that is encompassing points in the shared virtual space. In another operation caused by the instructions, each view of the shared virtual space along with the graphical user interface overlay is transmitted to the portable interactive device to be displayed. The transmitting operation is performed using a connection between the computing device and the portable interactive device.

In another operation caused by the instructions, the shared virtual space is populated with at least one detailed virtual object. In another operation caused by the instructions, tracking data is acquired from a tracking server. The tracking data is used to determine the position and rotation of the portable interactive device in the shared physical space. In another operation caused by the instructions, transformation is applied to each included virtual camera object in the shared virtual space. This transformation is based on the acquired tracking data and a superimposing transformation. The operation of applying the transformation allows control of the view of the shared virtual space and the points encompassed by the virtual cursor with manual movement of the portable interactive device within the shared physical space.

In another operation caused by the instructions, the shared virtual space is superimposed on the shared physical space, by setting the superimposing transformation, which is being applied to each included virtual camera object. In another operation caused by the instructions, points in the shared virtual space encompassed by the virtual cursor are identified. The identified points are located on one or more detailed virtual objects that the virtual space is populated with. In another operation caused by the instructions, input signals are received from the portable interactive device. The receiving operation is performed using a connection between the computing device and the portable interactive device. The one or more programs also comprise instructions for causing an operation to execute functions corresponding to the received input signals and the identified points.

Each included detailed virtual object is a virtual object occupying the shared virtual space that is characterized by having density of geometric features per one virtual space volume unit substantially higher than 10000. The one virtual space volume unit is a conceptual measurement unit that is superimposed on and effectively corresponds to one cubic foot of physical space. The geometric features of virtual objects are points that define the spatial form of the virtual objects.

In yet another embodiment, a portable interactive device is provided. The portable interactive device comprises a tracker, a display device module, an input device module and a connection to one unique computing device. The display device module is configured to display a view of a shared virtual space and a graphical user interface overlay comprising a virtual cursor. The input device module is configured to register input signals. The connected computing device comprises one or more processors, memory and one or more programs. The one or more programs are stored in the memory and are configured to be executed by the one or more processors. The one or more programs comprise instructions causing the computing device to perform operations for enabling multi-user interaction with detailed virtual objects of a shared virtual space superimposed for all users identically on a shared physical space.

One operation caused by the instructions comprises accessing a multi-user virtual reality session. The multi-user virtual reality session is managing a shared virtual space. In another operation caused by the instructions, at least one virtual camera object is placed into the shared virtual space. Each included virtual camera object is configured to comprise at least one virtual camera.

In another operation caused by the instructions, a view of the shared virtual space is generated for each virtual camera of each included virtual camera object. Each view of the shared virtual space is defined by the field of view of a corresponding virtual camera. In another operation caused by the instructions, a graphical user interface overlay is generated. The graphical user interface overlay is configured to comprise a virtual cursor that is encompassing points in the shared virtual space. In another operation caused by the instructions, each view of the shared virtual space along with the graphical user interface overlay is transmitted to the portable interactive device to be displayed. The transmitting operation is performed using a connection between the computing device and the portable interactive device.

In another operation caused by the instructions, the shared virtual space is populated with at least one detailed virtual object. In another operation caused by the instructions, tracking data is acquired from a tracking server. The tracking data is used to determine the position and rotation of the portable interactive device in the shared physical space. In another operation caused by the instructions, transformation is applied to each included virtual camera object in the shared virtual space. This transformation is based on the acquired tracking data and a superimposing transformation. The operation of applying the transformation allows control of the view of the shared virtual space and the points encompassed by the virtual cursor with manual movement of the portable interactive device within the shared physical space.

In another operation caused by the instructions, the shared virtual space is superimposed on the shared physical space, by setting the superimposing transformation, which is being applied to each included virtual camera object. In another operation caused by the instructions, points in the shared virtual space encompassed by the virtual cursor are identified. The identified points are located on one or more detailed virtual objects that the virtual space is populated with. In another operation caused by the instructions, input signals are received from the portable interactive device. The receiving operation is performed using a connection between the computing device and the portable interactive device. The one or more programs also comprise instructions for causing an operation to execute functions corresponding to the received input signals and the identified points.

Each included detailed virtual object is a virtual object occupying the shared virtual space that is characterized by having density of geometric features per one virtual space volume unit substantially higher than 10000. The one virtual space volume unit is a conceptual measurement unit that is superimposed on and effectively corresponds to one cubic foot of physical space. The geometric features of virtual objects are points that define the spatial form of the virtual objects.

In some embodiments, a portable interactive device with a tracker can comprise an input device module configured to register input signals such as pressing physical buttons, moving physical joysticks, touching touch sensitive surfaces, moving virtual joysticks on touch sensitive surfaces, tapping virtual buttons on touch sensitive surfaces, performing hand gestures on touch sensitive surfaces, performing hand gestures in-air, performing eye movement, or performing sounds.

In some embodiments, a portable interactive device with a tracker can comprise a device module enabling the connection of the portable interactive device to one unique computing device. The device module can for example be a thin client, an ultra-thin client, or a zero client.

In some embodiments, a portable interactive device with a tracker can comprise a complementary display module. The complementary display module can be used to display the view of the shared virtual space, the graphical user interface overlay comprising the virtual cursor, or both the view of the shared virtual space and the graphical user interface overlay comprising the virtual cursor.

In some embodiments, the connection between a computing device and one unique portable interactive device with a tracker can for example be an internet connection, a wide area network connection, a metropolitan area network connection, a wired local area network connection, a wireless local area network connection, a radio wave connection, or a computer bus connection.

In some embodiments, the accessing a multi-user virtual reality session operation can include joining the session using a network connection established between a computing device and another computing device.

In some embodiments, the accessing a multi-user virtual reality session operation can include hosting the session. The hosted session is made accessible to other computing devices using a network connection.

In some embodiments, the acquiring tracking data from a tracking server operation can include using a connection between a computing device and the tracking server. The connection can for example be an internet connection, a wide area network connection, a metropolitan area network connection, a wired local area network connection, a wireless local area network connection, a radio wave connection, or a computer bus connection.

In some embodiments, the applying transformation to each included virtual camera object operation can include applying smoothing to the transformation applied to each included virtual camera object.

In some embodiments, the computing device can for example be a computer, a portable computer, a wearable computer, a tablet, a mobile phone, a gaming console or a portable gaming console.

In some embodiments, the tracker can for example be an electromagnetic tracking sensor, a set of passive tracking markers bearing a retro-reflective material acting as a single rigid object, a set of active tracking markers emitting light acting as a single rigid object, or or a set of infrared tracking sensors.

In some embodiments, a tracker can be mechanically attached to a portable interactive device.

In some embodiments, a computing device and a portable interactive device with a tracker can be combined into one composite device.

In some embodiments, a computing device and the tracking server can be combined into one composite device.

In some embodiments, a computing device can be a virtual machine running on a physical server.

In some embodiments, the tracking server can comprise a computing device, which is a virtual machine running on a physical server.

In some embodiments, the placing at least one virtual camera object into the shared virtual space operation can include placing multiple virtual cameras, and the generating a view of the shared virtual space operation can include generating multiple views of the shared virtual space. The virtual cameras are placed as hierarchy children of one of the included virtual camera objects. The virtual cameras are variously positioned in the shared virtual space in relation to the one of the included virtual camera objects. The virtual cameras also inherit changes in position and rotation of the one of the included virtual camera objects. Each generated view of the shared virtual space is defined by the field of view of a different virtual camera of the included virtual camera objects.

In some embodiments, the generating a graphical user interface overlay operation can include applying a configuration to the virtual cursor. The configuration can for example set the virtual cursor to be opaque, transparent, semi-transparent, to not change its position within the graphical user interface overlay, or to occupy a rectangle of such size in pixels, that it is equivalent to the size of the display of the portable interactive device, that is used to display the graphical user interface overlay.

In some embodiments, the superimposing the shared virtual space on the shared physical space operation can include setting the superimposing transformation applied to each included virtual camera object. The superimposing transformation is set either by loading and applying a stored superimposing transformation configuration or by first creating and storing, and then loading and applying a new superimposing transformation configuration. The new superimposing transformation configuration is created by receiving input signals from a portable interactive device and by executing functions corresponding to the input signals, which modify components of the superimposing transformation. The components of the superimposing transformation can include a translation component, a rotation component and a scale component.

In some embodiments, the tracking server comprises a tracking device module, one or more processors, memory and one or more programs. The tracking device module is configured to track the position and rotation of each included portable interactive device with a tracker in the shared physical space. The tracking device module comprises a tracking device, which is used for tracking and can for example be a set of tracking cameras, a set of electromagnetic receptors, or a set of infrared projectors. The one or more programs are stored in the memory and are configured to be executed by the one or more processors. The one or more programs comprise instructions causing the tracking server to perform operations for allowing computing devices to acquire tracking data.

One operation caused by the instructions comprises acquiring raw tracking data from the tracking device module. In another operation caused by the instructions, the raw tracking data is stored in the memory. In another operation caused by the instructions, tracking data that comprises tracker position and rotation data relative to an origin of the shared physical space is generated from the stored raw tracking data. The one or more programs also comprise instructions for causing an operation to run a network server. The network server is configured to share the tracking data with other computing devices.

In some embodiments, a portable interactive device with a tracker can comprise an adjustable mount. The adjustable mount is configured to hold the position and rotation of the portable interactive device within the shared physical space. The adjustable mount is attached to a wheeled chassis, which enables movement of the portable interactive device in the shared physical space, without performing adjustments to the adjustable mount.

Thus, according to embodiments of the present invention it is possible to provide a multi-user interaction with detailed virtual objects of a shared virtual space that is at the same time superimposed for all users identically on a shared physical space, and thereby create a multi-user virtual reality interaction environment experience with simultaneous virtual and physical collaboration and communication of users.

Further, according to embodiments of the present invention it is possible to provide multi-user interaction with detailed virtual objects of a shared virtual space superimposed on a shared physical space, using portable interactive devices movement of which is tracked in the shared physical space, enabling navigation within the shared virtual space and interaction with detailed virtual objects, acting as virtual space view controlling devices and virtual cursor pointing devices, capable of registering input signals and at the same time displaying views of the shared virtual space.

Other aspects, features and advantages of various embodiments of the present invention will become more apparent from the following detailed description, taken in conjunction with the accompanying drawings, illustrating by way of example the principles of the invention.

### BRIEF DESCRIPTION OF THE DRAWINGS

The foregoing and other aspects, features and advantages of embodiments of the present invention can be best understood by reference to the following description taken in conjunction with the accompanying drawings in which:

FIG. 1 shows an exemplary schematic diagram of a multi-user virtual reality interaction environment experience with simultaneous virtual and physical collaboration and communication of users, according to one embodiment of the present invention.

FIGS. 2-8 depict exemplary schematic diagrams of systems capable of enabling multi-user interaction with detailed virtual objects of a shared virtual space superimposed for all users identically on a shared physical space, according to some embodiments of the present invention.

FIGS. 9-17 depict exemplary schematic diagrams of portable interactive devices with trackers, connected to computing devices capable of performing operations for enabling multi-user interaction with detailed virtual objects of a shared virtual space superimposed for all users identically on a shared physical space, according to some embodiments of the present invention.

FIGS. 18-21 depict exemplary block diagrams of computing devices capable of performing operations for enabling multi-user interaction with detailed virtual objects of a shared virtual space superimposed for all users identically on a shared physical space, according to some embodiments of the present invention.

FIGS. 22-24 depict exemplary block diagrams of tracking servers capable of performing operations for allowing computing devices to acquire tracking data, according to some embodiments of the present invention.

FIG. 25 shows an exemplary flow diagram illustrating operations, performed by a tracking server, for allowing computing devices to acquire tracking data, according to one embodiment of the present invention.

FIG. 26 depicts an exemplary schematic diagram of a system capable of enabling multi-user interaction with detailed virtual objects of a shared virtual space superimposed for all users identically on a shared physical space, according to one embodiment of the present invention.

FIG. 27 depicts an exemplary schematic diagram of a portable interactive device with a tracker, connected to a computing device capable of performing operations for enabling multi-user interaction with detailed virtual objects of a shared virtual space superimposed for all users identically on a shared physical space, according to one embodiment of the present invention.

FIG. 28 shows an exemplary flow diagram illustrating a method for enabling multi-user interaction with detailed virtual objects of a shared virtual space superimposed for all users identically on a shared physical space, according to one embodiment of the present invention.

FIG. 29 shows an exemplary schematic diagram illustrating the accessing a virtual reality session operation of the method illustrated in FIG. 28, according to one embodiment of the present invention.

FIG. 30 shows an exemplary schematic diagram illustrating the placing at least one virtual camera object into the shared virtual space operation of the method illustrated in FIG. 28, according to one embodiment of the present invention.

FIG. 31 shows an exemplary schematic diagram illustrating the generating a view of the shared virtual space operation and the generating a graphical user interface overlay operation of the method illustrated in FIG. 28, according to one embodiment of the present invention.

FIG. 32 shows an exemplary schematic diagram illustrating the applying a configuration to the virtual cursor operation of the method illustrated in FIG. 28, according to one embodiment of the present invention.

FIG. 33 shows an exemplary schematic diagram illustrating the transmitting the view of the shared virtual space and the graphical user interface overlay to the portable interactive device operation of the method illustrated in FIG. 28, according to one embodiment of the present invention.

FIG. 34 shows an exemplary schematic diagram illustrating the populating the shared virtual space with at least one detailed virtual object operation of the method illustrated in FIG. 28, according to one embodiment of the present invention.

FIG. 35 shows an exemplary schematic diagram illustrating the acquiring tracking data from a tracking server operation of the method illustrated in FIG. 28, according to one embodiment of the present invention.

FIG. 36 shows an exemplary schematic diagram illustrating the applying transformation to the at least one virtual camera object operation of the method illustrated in FIG. 28, according to one embodiment of the present invention.

FIG. 37 shows an exemplary schematic diagram illustrating how allowing control of the view of the shared virtual space and the points encompassed by the virtual cursor is performed during the applying transformation to the at least one virtual camera object operation of the method illustrated in FIG. 28, according to one embodiment of the present invention.

FIGS. 38-40 show exemplary schematic diagrams illustrating the superimposing the shared virtual space on the shared physical space operation of the method illustrated in FIG. 28, according to one embodiment of the present invention.

FIG. 41 shows an exemplary schematic diagram illustrating the identifying points in the shared virtual space encompassed by the virtual cursor operation, the receiving input signals from the portable interactive device operation, and the executing functions corresponding to the input signals and the identified points operation of the method illustrated in FIG. 28, according to one embodiment of the present invention.

FIG. 42 shows an exemplary schematic diagram illustrating the placing multiple virtual cameras as hierarchy children of the at least one virtual camera object operation and the generating multiple views of the shared virtual space operation of the method illustrated in FIG. 28, according to one embodiment of the present invention.

FIG. 43 shows an exemplary schematic diagram illustrating the placing at least one virtual camera object into the shared virtual space operation and the generating a view of the shared virtual space operation of the method illustrated in FIG. 28, wherein more than one virtual camera objects are placed into the shared virtual space, according to one embodiment of the present invention.

FIG. 44 shows an exemplary schematic diagram of multi-user interaction with detailed virtual objects of a shared virtual space that is at the same time superimposed for all users identically on a shared physical space, creating a multi-user virtual reality interaction environment experience with simultaneous virtual and physical collaboration and communication of users, according to one embodiment of the present invention.

FIG. 45 shows an exemplary schematic diagram illustrating manual movement of a portable interactive device within a shared physical space and a sequence of views of a shared virtual space resulting from the manual movement of the portable interactive device within the shared physical space, according to one embodiment of the present invention.

FIG. 46 shows an exemplary schematic diagram illustrating measurement of density of geometric features of virtual objects per one virtual space volume unit, wherein the virtual space volume unit is a conceptual measurement unit being superimposed on and effectively corresponding to one cubic foot of physical space, according to one embodiment of the present invention.

FIG. 47 shows an exemplary schematic diagram illustrating usage of a complementary display module of a portable interactive device with a tracker to generate a secondary view of a shared virtual space, according to one embodiment of the present invention.

### DETAILED DESCRIPTION

Embodiments of the present invention describe methods, systems, devices and non-transitory computer readable storage mediums storing one or more programs for enabling multi-user interaction with detailed virtual objects of a shared virtual space at the same time superimposed for all users identically on a shared physical space. Embodiments of the invention will be described with reference to the accompanying drawing figures wherein like numbers represent like elements throughout. Before embodiments of the invention are described in detail, it should be understood that the invention is not limited in its application to the details of the examples set forth in the following description or illustrated in the figures.

It will be obvious, however, to one skilled in the art, that the present invention may be practiced without some or all of these specific details. In other instances, well-known methods, operations, techniques, procedures, systems, storage mediums, circuitry, networks, and components have not been described in detail in order not to unnecessarily obscure the present invention.

The terminology used in the description of the invention herein is for the purpose of describing particular embodiments only and is not intended to be limiting of the present invention. As used in the description of the present invention and the appended claims, the singular forms “a”, an and the are intended to include the plural forms as well, unless the context clearly indicates otherwise.

It will be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that the term “exemplary” as used throughout this description is defined as an example, illustration or an instance of an object, device, system, entity, composition, method, operation, technique, procedure, step or process, and should not necessarily be interpreted as preferred or advantageous over other examples.

It will further be understood that references in the specification to “one embodiment,” “an embodiment,” “another embodiment,” “some embodiments”, or the like, indicate that the embodiment and/or embodiments described may include a particular feature, structure, or characteristic, but every embodiment and/or embodiments may not necessarily include the particular feature, structure, or characteristic. Moreover, such phrases are not necessarily referring to the same embodiment and/or embodiments. Furthermore, when a particular feature, structure, or characteristic is described in connection with an embodiment and/or embodiments, it is submitted that it is within the knowledge of one skilled in the art to implement such feature, structure, or characteristic in connection with other embodiments whether or not explicitly described.

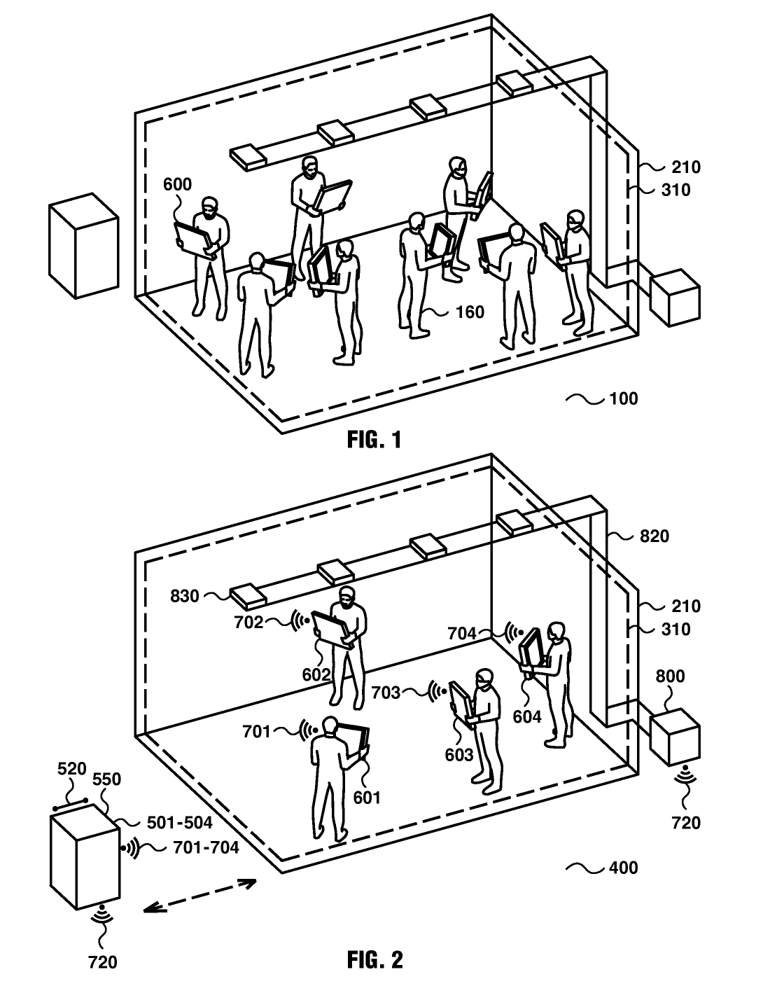

FIG. 1 shows an exemplary schematic diagram of a multi-user virtual reality interaction environment experience 100, according to one embodiment of the present invention. Multi-user virtual reality interaction environment experience 100 is a term collectively naming resulting virtual reality experiences, which can be achieved using the various embodiments of the present invention. The most noticeable characteristic of the resulting virtual reality experiences is that a group of multiple users, rather called a multi-user group 160 can collaborate and communicate simultaneously within a shared virtual space 310 and a shared physical space 210. This is achieved by the various embodiments of the present invention generally by enabling the multi-user group 160 to interact simultaneously with a shared virtual space 310 and a shared physical space 210, with the shared virtual space 310 being superimposed on the shared physical space 210 for all users identically. This results in both spaces being interrelated and intuitive to navigate and creates a virtual reality experience combined with physical reality, which is shared by all users of a multi-user group 160.

Furthermore, the ability of a multi-user group 160 to collaborate and communicate simultaneously within a shared virtual space 310 and a shared physical space 210, and to interact simultaneously with a shared virtual space 310 superimposed for all users identically on a shared physical space 210, is achieved by the various embodiments of the present invention particularly by utilizing portable hand-operated devices. The portable hand-operated devices, rather called portable interactive devices 600, do not restrict users of a multi-user group 160 from maintaining physical face-to-face communication and from being aware of their surrounding shared physical space 210, and thus are not hindering their physical collaboration and communication capabilities. Such communication is often paramount in collaborative interaction with virtual spaces, such as during creative group work, group training and education, or even group entertainment, and can only be achieved with users of a multi-user group 160 sharing the same physical space 210.

Portable interactive devices 600 are further utilized for all interaction of a multi-user group 160 with a shared virtual space 310. Interaction with a shared virtual space 310 is essentially performed by changing views of a shared virtual space 310 and by causing execution of functions that modify virtual objects of a shared virtual space 310. Portable interactive devices 600 enable such interaction by being configured to display views of a shared virtual space 310, and also register input signals that cause execution of functions that modify virtual objects of a shared virtual space 310. Most importantly, movement of portable interactive devices 600 is tracked in a shared physical space 210, allowing direct control of views of a shared virtual space 310 with manual movement of portable interactive devices 600 within a shared physical space 210. This results in both spaces being even more interrelated and intuitive to navigate, as positioning of portable interactive devices 600 in a shared physical space 210 directly indicate areas of interaction in a shared virtual space 310. Users of a multi-user group 160 can simply look around the shared physical space 210 to get precise information about distribution of areas of interaction of individual users around the shared virtual space 310.

The various embodiments of the present invention further reinforce the ability of users to communicate, as the shared physical space 210 becomes a canvas for physical interaction, communication, collaboration and movement of users of a multi-user group 160, for the purpose of interacting with a shared virtual space 310 and virtual objects contained in it. It is important to note, that due to the intuitiveness of navigation, and the precision, familiarity and freedom of manual movement, which is used to control views of a shared virtual space 310, various embodiments of the present invention are particularly advantageous, when utilized to enable interaction with detailed virtual objects, which are generally known to be difficult to navigate using conventional techniques. Although the various embodiments of the present invention are capable of enabling interaction with simple virtual objects, they provide such methods, systems, devices and non-transitory computer-readable storage mediums storing one or more programs, which are best suited for enabling interaction with detailed virtual objects of a shared virtual space 310 superimposed for all users identically on a shared physical space 210. Therefore, throughout this detailed description all virtual objects can be regarded as detailed virtual objects.

In one embodiment, a system 400 capable of enabling multi-user interaction with detailed virtual objects of a shared virtual space 310 superimposed for all users identically on a shared physical space 210 is provided. The system 400 comprises at least one portable interactive device 600. Each included portable interactive device 600 is configured at least to display a view of the shared virtual space and a graphical user interface overlay and also to register input signals. The system 400 also comprises a tracking server 800. The tracking server 800 is configured at least to track the position and rotation of each included portable interactive device 600 in the shared physical space 210. Each included and tracked portable interactive device 600 is connected to one unique computing device 500. The tracking server 800 is connected to each included computing device 500. Thus, the system 400 also comprises at least one computing device 500 with a connection 700 to one unique portable interactive device 600 and a connection 720 to the tracking server 800. Each included computing device 500 is configured at least to perform operations for enabling multi-user interaction with detailed virtual objects of a shared virtual space 310 superimposed for all users identically on a shared physical space 210. The system 400 can be configured in various ways into many different configurations that all achieve the desired resulting effect of enabling multi-user interaction with detailed virtual objects of a shared virtual space 310 superimposed for all users identically on a shared physical space 210, each of which is suitable for a different usage scenario and exhibits different advantages.

FIG. 2 through 8 depict exemplary schematic diagrams of variously configured systems 400 capable of enabling multi-user groups 160 to simultaneously interact with a shared virtual space 310 superimposed for all users identically on a shared physical space 210, according to some embodiments of the present invention. These variously configured systems 400 describe some of the various ways individual elements can be configured and connected.

FIG. 2 depicts an exemplary schematic diagram of a system for enabling multi-user interaction with detailed virtual objects of a shared virtual space 310 superimposed for all users identically on a shared physical space 210, according to one embodiment of the present invention. The depicted system 400 comprises several portable interactive devices 601, 602, 603, 604, one tracking server 800, and several computing devices 501, 502, 503, 504. The included computing devices 501, 502, 503, 504 are connected to the several portable interactive devices 601, 602, 603, 604 using several connections 701, 702, 703, 704. The tracking server 800 is connected to the included computing devices 501, 502, 503, 504 also using multiple connections 720. Computing devices 501, 502, 503, 504 included in the system 400 are virtual machines running on a physical server 550 that is located in a remote location, away from the shared physical space 210. Computing devices 501, 502, 503, 504 are connected with each other using wired local area network connections 520 that are part of the remote physical server 550. The connections 701, 702, 703, 704, between the computing devices 501, 502, 503, 504 and the portable interactive devices 601, 602, 603, 604 are implemented as internet connections 711, wide area network connections 712 or metropolitan area network connections 713. The connections 701, 702, 703, 704 are wireless in parts of the connections that lead through the shared physical space 210, but can be wired, wireless, or a combination thereof in other parts. The tracking server 800 is connected to the computing devices 501, 502, 503, 504 also using internet connections 721, wide area network connections 722 or metropolitan area network connections 723. The connections 720 can be wired or wireless, or a combination thereof. The system 400 utilizes the computing devices 501, 502, 503, 504 running on a remote physical server 550 for computations that relate to performing operations for enabling multi-user interaction with detailed virtual objects of a shared virtual space 310 superimposed for all users identically on a shared physical space 210.

Such system 400 exhibits an advantage of lowering weight of the portable interactive devices 601, 602, 603, 604, so that they are easier to manually position in the shared physical space 210, as the computing devices 501, 502, 503, 504 are not carried around with the portable interactive devices 601, 602, 603, 604 and also clears room for movement of users. Furthermore, the configuration of the computing devices 501, 502, 503, 504 into virtual machines running on the remote physical server 550 advantageously allows the system 400 to scale up or down depending on the quantity of participating users, without manipulating hardware configuration of any computing devices, by simply running more or less virtual machines. Also, maintenance of the physical server 550 can be performed without interrupting operation of the system 400, by configuring the computing devices 501, 502, 503, 504 as virtual machines to run on a different part of the same physical server, on a different physical server in the same location or in another remote location, than the part of the physical server 550 on which the maintenance is performed.

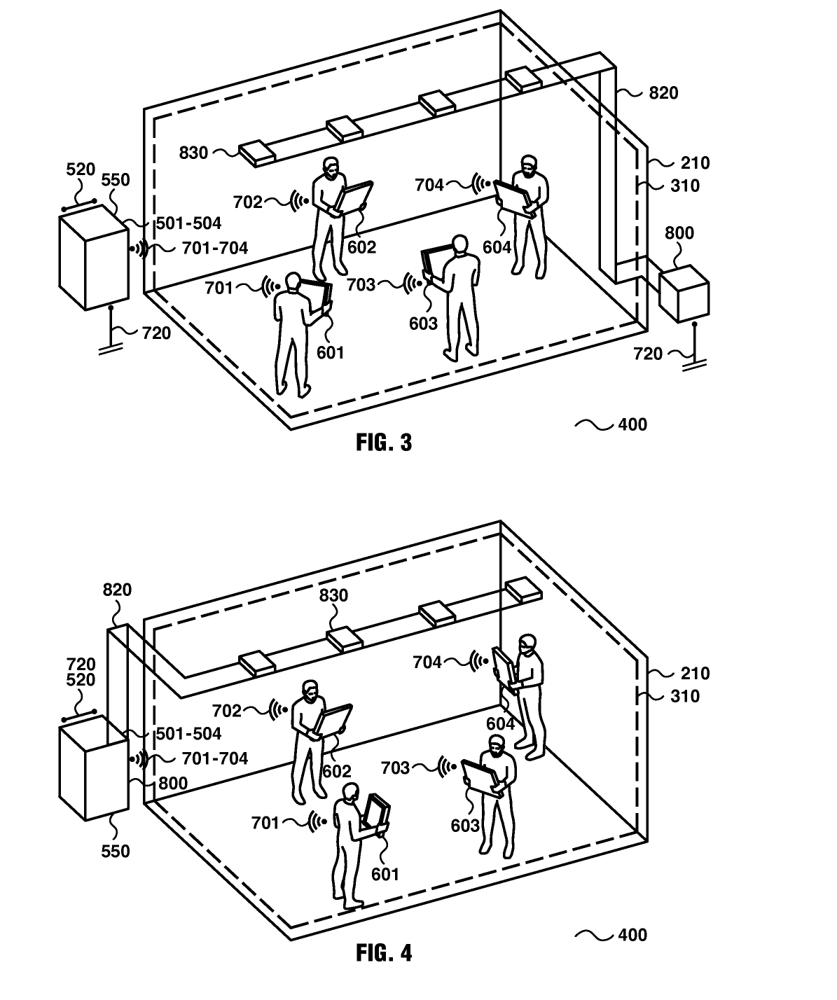

FIG. 3 depicts an exemplary schematic diagram of a system for enabling multi-user interaction with detailed virtual objects of a shared virtual space 310 superimposed for all users identically on a shared physical space 210, according to one embodiment of the present invention. The depicted system 400 comprises several portable interactive devices 601, 602, 603, 604, one tracking server 800, and several computing devices 501, 502, 503, 504. The included computing devices 501, 502, 503, 504 are connected to the several portable interactive devices 601, 602, 603, 604 using several connections 701, 702, 703, 704. The tracking server 800 is connected to the included computing devices 501, 502, 503, 504 also using multiple connections 720. Computing devices 501, 502, 503, 504 included in the system 400 are virtual machines running on a physical server 550 that is located in a local location, in proximity to the shared physical space 210. Computing devices 501, 502, 503, 504 are connected with each other using wired local area network connections 520 that are part of the local physical server 550. The connections 701, 702, 703, 704, between the computing devices 501, 502, 503, 504 and the portable interactive devices 601, 602, 603, 604 are implemented as wireless local area network connections 715. The connections 701, 702, 703, 704 are wireless in parts of the connections that lead through the shared physical space 210, but can be wired, wireless, or a combination thereof in other parts. The tracking server 800 is connected to the computing devices 501, 502, 503, 504 using wired local area network connections 724, but can also be connected using wireless local area network connections 725, or a combination of wired 724 and wireless local area network connections 725. The system 400 utilizes the computing devices 501, 502, 503, 504 running on the local physical server 550 for computations that relate to performing operations for enabling multi-user interaction with detailed virtual objects of a shared virtual space 310 superimposed for all users identically on a shared physical space 210.

Such system 400 in addition to other advantages of the aforementioned systems, which utilize computing devices that are virtual machines running on physical servers, also exhibits an advantage of allowing connections 701, 702, 703, 704 between the computing devices 501, 202, 503, 504 and the portable interactive devices 601, 602, 603, 604 to be local and therefore more reliable, less prone to interruptions, due to the fact that the physical server 550 is in proximity to the shared physical space 210.

FIG. 4 depicts an exemplary schematic diagram of a system for enabling multi-user interaction with detailed virtual objects of a shared virtual space 310 superimposed for all users identically on a shared physical space 210, according to one embodiment of the present invention. The depicted system 400 comprises several portable interactive devices 601, 602, 603, 604, one tracking server 800, and several computing devices 501, 502, 503, 504. The included computing devices 501, 502, 503, 504 are connected to the several portable interactive devices 601, 602, 603, 604 using several connections 701, 702, 703, 704. The tracking server 800 is connected to the included computing devices 501, 502, 503, 504 also using multiple connections 720. Computing devices 501, 502, 503, 504 included in the system 400 are virtual machines running on a physical server 550 that is located in a local location, in proximity to the shared physical space 210. The tracking server 800 comprises a computing device, which is a virtual machine running on the local physical server 550. Computing devices 501, 502, 503, 504 are connected with each other using wired local area network connections 520 that are part of the local physical server 550. The connections 701, 702, 703, 704, between the computing devices 501, 502, 503, 504 and the portable interactive devices 601, 602, 603, 604 are implemented as wireless local area network connections 715. The connections 701, 702, 703, 704 are wireless in parts of the connections that lead through the shared physical space 210, but can be wired, wireless, or a combination thereof in other parts. The tracking server 800 is connected to the computing devices 501, 502, 503, 504 using wired local area network connections 724 that are part of the local physical server 550. The system 400 utilizes the computing devices 501, 502, 503, 504 running on the local physical server 550 for computations that relate to performing operations for enabling multi-user interaction with detailed virtual objects of a shared virtual space 310 superimposed for all users identically on a shared physical space 210.

Such system 400 in addition to other advantages of the aforementioned systems, which utilize computing devices that are virtual machines running on physical servers, exhibits an advantage of allowing maintenance of all computing devices included in the system 400 without interrupting operation of the system 400, as also the computing device included in the tracking server 800 is a virtual machine running on the physical server 550, and thus during maintenance can be configured to run on different parts of the physical server, than the parts the maintenance is performed on.

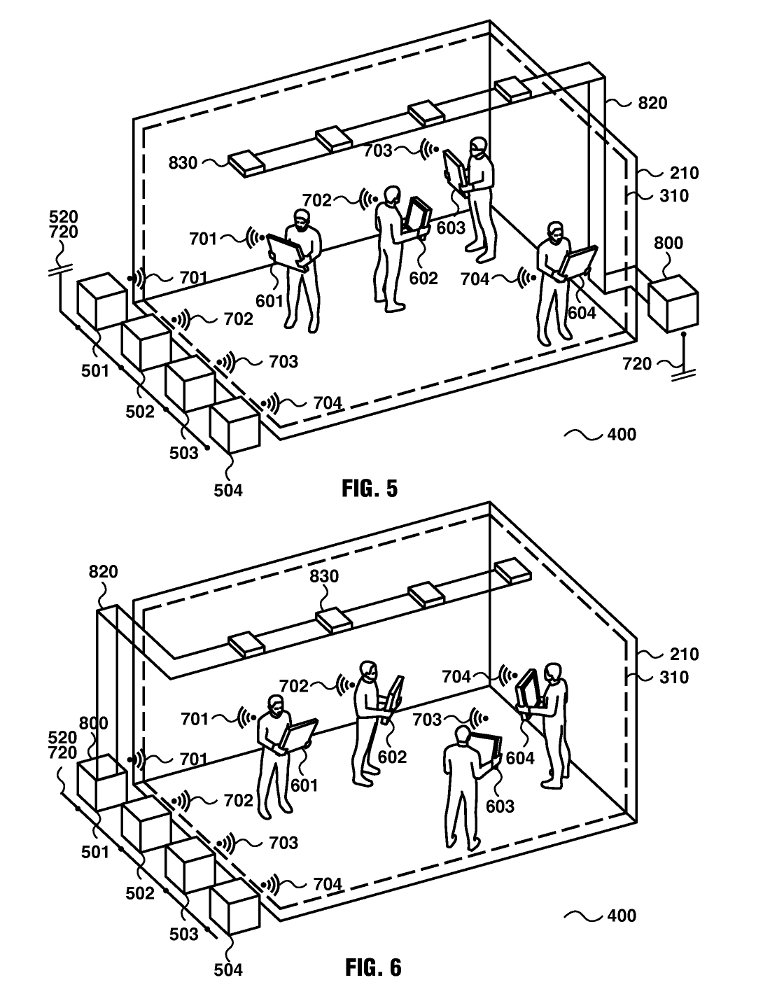

FIG. 5 depicts an exemplary schematic diagram of a system for enabling multi-user interaction with detailed virtual objects of a shared virtual space 310 superimposed for all users identically on a shared physical space 210, according to one embodiment of the present invention. The depicted system 400 comprises several portable interactive devices 601, 602, 603, 604, one tracking server 800, and several computing devices 501, 502, 503, 504. The included computing devices 501, 502, 503, 504 are connected to the several portable interactive devices 601, 602, 603, 604 using several connections 701, 702, 703, 704. The tracking server 800 is connected to the included computing devices 501, 502, 503, 504 also using multiple connections 720. Computing devices 501, 502, 503, 504 included in the system 400 are self-contained computing devices located in a local location, in proximity to the shared physical space 210. Computing devices 501, 502, 503, 504 are connected with each other using wired local area network connections 520. The connections 701, 702, 703, 704, between the computing devices 501, 502, 503, 504 and the portable interactive devices 601, 602, 603, 604 are implemented as wireless local area network connections 715. The connections 701, 702, 703, 704 are wireless in parts of the connections that lead through the shared physical space 210, but can be wired, wireless, or a combination thereof in other parts. The tracking server 800 is connected to the computing devices 501, 502, 503, 504 using wired local area network connections 724, but can also be connected using wireless local area network connections 725, or a combination of wired 724 and wireless local area network connections 725. The system 400 utilizes the individual computing devices 501, 502, 503, 504 for computations that relate to performing operations for enabling multi-user interaction with detailed virtual objects of a shared virtual space 310 superimposed for all users identically on a shared physical space 210.

Such system 400 in addition to some advantages of aforementioned systems, such as allowing local and therefore more reliable connections 701, 702, 703, 704 between the computing devices 501, 502, 503, 504 and the portable interactive devices 601, 602, 603, 604, also exhibits an advantage of being simple to set up by using self-contained computing devices, such as personal computers, each connected to one unique portable interactive device.

FIG. 6 depicts an exemplary schematic diagram of a system for enabling multi-user interaction with detailed virtual objects of a shared virtual space 310 superimposed for all users identically on a shared physical space 210, according to one embodiment of the present invention. The depicted system 400 comprises several portable interactive devices 601, 602, 603, 604, one tracking server 800, and several computing devices 501, 502, 503, 504. The included computing devices 501, 502, 503, 504 are connected to the several portable interactive devices 601, 602, 603, 604 using several connections 701, 702, 703, 704. The tracking server 800 is connected to the included computing devices 501, 502, 503, 504 also using multiple connections 720. The tracking server 800 comprises a computing device, which is combined with one of the included computing devices 501. Computing devices 501, 502, 503, 504 included in the system 400 are self-contained computing devices located in a local location, in proximity to the shared physical space 210. Computing devices 501, 502, 503, 504 are connected with each other using wired local area network connections 520. The connections 701, 702, 703, 704, between the computing devices 501, 502, 503, 504 and the portable interactive devices 601, 602, 603, 604 are implemented as wireless local area network connections 715. The connections 701, 702, 703, 704 are wireless in parts of the connections that lead through the shared physical space 210, but can be wired, wireless, or a combination thereof in other parts. The tracking server 800 is connected to the computing devices 502, 503, 504 using wired local area network connections 724, but can also be connected using wireless local area network connections 725, or a combination of wired 724 and wireless local area network connections 725. The system 400 utilizes the individual computing devices 501, 502, 503, 504 for computations that relate to performing operations for enabling multi-user interaction with detailed virtual objects of a shared virtual space 310 superimposed for all users identically on a shared physical space 210.

Such system 400 exhibits the same advantages as the previously described system, but simplifies setting up the system 400 as the computing device comprised by the tracking server 800 is integrated into one of the included computing devices 501 that is connected to one of the included portable interactive devices 701, which is otherwise utilized by the system 400 for computations that relate to performing operations for enabling multi-user interaction with detailed virtual objects of a shared virtual space 310 superimposed for all users identically on a shared physical space 210. By combining the computing device comprised by the tracking server 800 with one of the included computing devices 501, the computing device 501 is also utilized by the system 400 for computations that relate to tracking the position and rotation of each included portable interactive device 600 in the shared physical space 210 and allowing computing devices 501, 502, 503, 504 to acquire tracking data.

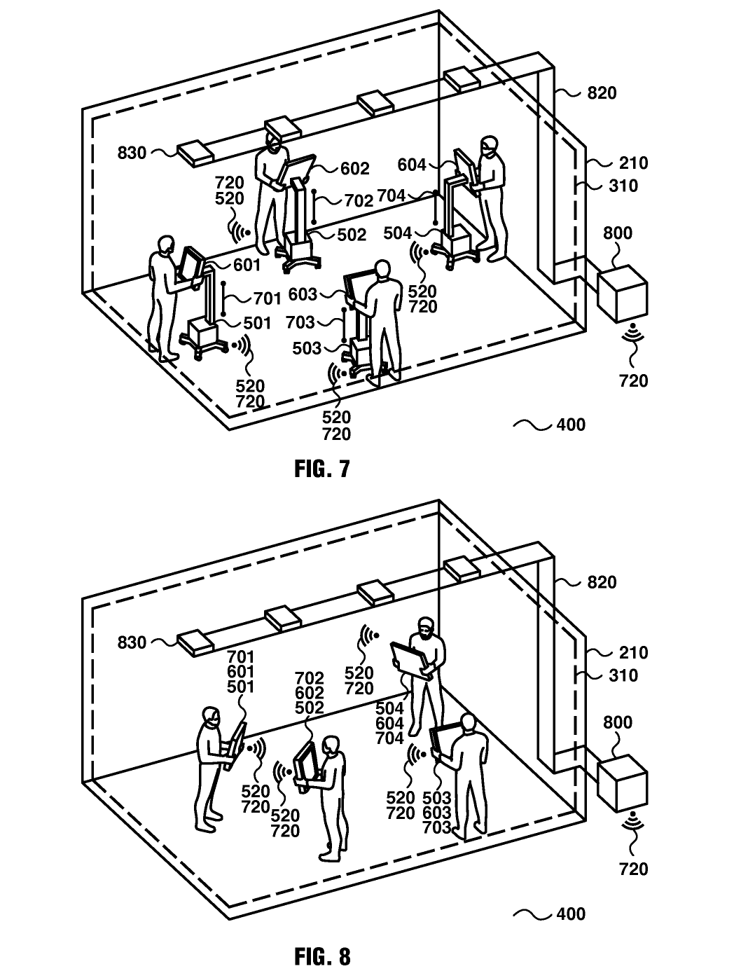

FIG. 7 depicts an exemplary schematic diagram of a system for enabling multi-user interaction with detailed virtual objects of a shared virtual space 310 superimposed for all users identically on a shared physical space 210, according to one embodiment of the present invention. The depicted system 400 comprises several portable interactive devices 601, 602, 603, 604, one tracking server 800, and several computing devices 501, 502, 503, 504. The included computing devices 501, 502, 503, 504 are connected to the several portable interactive devices 601, 602, 603, 604 using several connections 701, 702, 703, 704. The portable interactive devices 601, 602, 603, 604 comprise adjustable mounts attached to wheeled chassis. The tracking server 800 is connected to the included computing devices 501, 502, 503, 504 also using multiple connections 720. Computing devices 501, 502, 503, 504 included in the system 400 are self-contained computing devices, which are moving within the shared physical space 210. Computing devices 501, 502, 503, 504 are connected with each other using wireless local area network connections 520. The connections 701, 702, 703, 704, between the computing devices 501, 502, 503, 504 and the portable interactive devices 601, 602, 603, 604 are implemented as external computer bus connections 717, such as USB or Thunderbolt connections. The tracking server 800 is connected to the computing devices 501, 502, 503, 504 using wireless local area network connections 725, but can also be connected using wired local area network connections 724, or a combination of wired 724 and wireless local area network connections 725. The system 400 utilizes the individual computing devices 501, 502, 503, 504 for computations that relate to performing operations for enabling multi-user interaction with detailed virtual objects of a shared virtual space 310 superimposed for all users identically on a shared physical space 210.

Such system 400 in addition to some advantages of aforementioned systems, such as allowing local and therefore more reliable connections 701, 702, 703, 704 between the computing devices 501, 502, 503, 504 and the portable interactive devices 601, 602, 603, 604, and being simple to set up by using self-contained computing devices, such as personal computers, each connected to one unique portable interactive device, also exhibit an advantage of removing the weight carried on the hands of users during manual positioning of the portable interactive devices 601, 602, 603, 604 in the shared physical space 210, by utilizing adjustable mounts, which are attached to wheeled chassis for holding and moving the portable interactive devices 601, 602, 603, 604 in the shared physical space 210.

FIG. 8 depicts an exemplary schematic diagram of a system for enabling multi-user interaction with detailed virtual objects of a shared virtual space 310 superimposed for all users identically on a shared physical space 210, according to one embodiment of the present invention. The depicted system 400 comprises several portable interactive devices 601, 602, 603, 604, one tracking server 800, and several computing devices 501, 502, 503, 504. The included computing devices 501, 502, 503, 504 are connected to the several portable interactive devices 601, 602, 603, 604 using several connections 701, 702, 703, 704. The tracking server 800 is connected to the included computing devices 501, 502, 503, 504 also using multiple connections 720. Computing devices 501, 502, 503, 504 included in the system 400 are moving within the shared physical space 210. Computing devices 501, 502, 503, 504 are connected with each other using wireless local area network connections 520. The connections 701, 702, 703, 704, between the computing devices 501, 502, 503, 504 and the portable interactive devices 601, 602, 603, 604 are implemented as internal computer bus connections 717, such as SATA or PCIe connections. Each one computing device 501, 502, 503, 504 and the portable interactive device 601, 602, 603, 604 that is connected to it, along with the used connection 701, 702, 703, 704 are combined into composite devices. The tracking server 800 is connected to the computing devices 501, 502, 503, 504 using wireless local area network connections 725, but can also be connected using wired local area network connections 724, or a combination of wired 724 and wireless local area network connections 725. The system 400 utilizes the individual computing devices 501, 502, 503, 504 for computations that relate to performing operations for enabling multi-user interaction with detailed virtual objects of a shared virtual space 310 superimposed for all users identically on a shared physical space 210.

Such system 400 exhibits the same advantages as the previously described system, but further simplifies setting up as the system 400 utilizes self-contained composite devices, such as tablets, which combine computing device functionality with portable interactive device functionality.

All of these variously configured systems 400 capable of enabling multi-user groups 160 to simultaneously interact with a shared virtual space 310 superimposed for all users identically on a shared physical space 210 are only examples that show various ways the individual elements of the systems 400, which embody the present invention, can be configured. Each configuration is suitable for a different usage scenario and exhibits different advantages. Many elements are required to allow any of the systems 400 to achieve the desired resulting effect of enabling multi-user groups 160 to simultaneously interact with a shared virtual space 310 superimposed for all users identically on a shared physical space 210, and the elements need to be described in further detail in order to bring about full understanding of how to implement the various embodiments of the present invention.

The most important element of the aforementioned systems 400, which is being hand operated by users in order to perform the actual interaction with the shared virtual space 310 superimposed for all users identically on a shared physical space 210, is the portable interactive device 600. As was briefly noted, the system 400 comprises at least one portable interactive device 600, and each included portable interactive device 600 is configured at least to display a view of the shared virtual space and a graphical user interface overlay and also to register input signals. It was also noted, that the position and rotation in the shared physical space 210 of each included portable interactive device 600 is tracked by the tracking server 800. The portable interactive devices 600 achieve such functionality generally by including several device modules each responsible for one of the functions, which can be configured in various ways and which need to be described in further detail in order to expand understanding of how the various embodiments of the present invention can be implemented.

In one embodiment, a portable interactive device 600 is provided. The portable interactive device 600 comprises a tracker 620. The tracker 620 is configured to allow a tracking server 800 to track the position and rotation of the portable interactive device 600 in a shared physical space 210. The portable interactive device 600 also comprises a display device module 650. The display device module 650 is configured at least to display a view 370 of the shared virtual space 210 and a graphical user interface overlay 380, which comprises a virtual cursor 390. Also, the portable interactive device 600 comprises an input device module 630, which is configured at least to register input signals at least in one form. The portable interactive device 600 comprises a connection 700 to one computing device 500. The connected computing device 500 is configured to at least perform operations for enabling multi-user interaction with detailed virtual objects of a shared virtual space 310 superimposed for all users identically on a shared physical space. The portable interactive device 600 can be configured in various ways into many different configurations, each of which allows users to use the portable interactive device 600 to perform the actual interaction with the shared virtual space 310 superimposed for all users identically on a shared physical space 210, and each of which is suitable for a different usage scenario and exhibits different advantages.

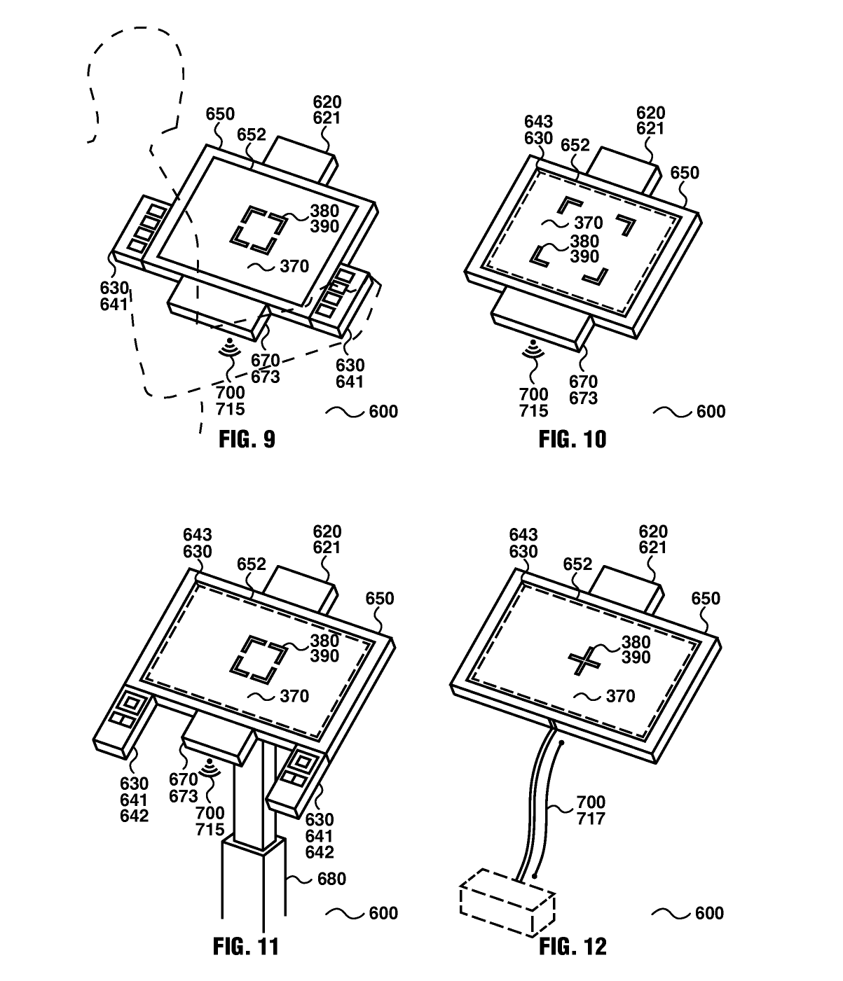

FIG. 9 through 17 depict exemplary schematic diagrams of variously configured portable interactive devices with trackers 600, connected to computing devices 500 capable of performing operations for enabling multi-user groups 160 to simultaneously interact with a shared virtual space 310 superimposed for all users identically on a shared physical space 210, according to some embodiments of the present invention. These variously configured portable interactive devices 600 describe some of the various ways individual device modules can be configured.

FIG. 9 depicts an exemplary schematic diagram of a portable interactive device with a tracker 600, connected to one computing device capable of performing operations for enabling multi-user interaction with detailed virtual objects of a shared virtual space 310 superimposed for all users identically on a shared physical space 210, according to one embodiment of the present invention. The depicted portable interactive device 600 comprises a tracker 620, a display device module 650, an input device module 630, and a connection 700 to one computing device 500. The tracker is an electromagnetic sensor 621. The sole function of the tracker 620 is to allow a tracking server 800 to track movement of the portable interactive device 600 within a shared physical space 210. The tracker 620 is attached to the display device module 650, so it does not move in relation to the portable interactive device 600 during operation of the device. The display device module 650 comprises a display 652 primary function of which is to display a view 370 of a shared virtual space 310 and a graphical user interface overlay 380 comprising a virtual cursor 390. The input device module 630 is configured to register input signals in the form of pressing physical buttons 641. The input device module 630 therefore comprises one or more physical buttons, and is attached to the display device module 650, so that it does not move in relation to the portable interactive device 600 during operation of the device. The connection 700 to one computing device 500 is a wireless local area network connection 715, therefore the portable interactive device 600 also needs to comprise a device module 670 enabling the connection of the portable interactive device 600 to the computing device 500. The connection-enabling device module 670 is a zero client 673, which is a thin client with a significantly simplified operating system with a sole purpose of initiating and managing a network connection, and communication of devices that utilize the connection. The connection-enabling device module 670 is attached to the display device module 650, so that it does not move in relation to the portable interactive device 600 during operation of the device.

Such portable interactive device 600 exhibits advantages of being lightweight and easy to manually manipulate, as it is not physically connected to a computing device 500. Also, the portable interactive device 600 is advantageously being simple to produce, as the input device module 630, which comprises physical buttons is the most common out of all input device types.

FIG. 10 depicts an exemplary schematic diagram of a portable interactive device with a tracker 600, connected to one computing device capable of performing operations for enabling multi-user interaction with detailed virtual objects of a shared virtual space 310 superimposed for all users identically on a shared physical space 210, according to one embodiment of the present invention. The depicted portable interactive device 600 comprises a tracker 620, a display device module 650, an input device module 630, and a connection 700 to one computing device 500. The tracker is an electromagnetic sensor 621. The sole function of the tracker 620 is to allow a tracking server 800 to track movement of the portable interactive device 600 within a shared physical space 210. The tracker 620 is attached to the display device module 650, so it does not move in relation to the portable interactive device 600 during operation of the device. The display device module 650 comprises a display 652 primary function of which is to display a view 370 of a shared virtual space 310 and a graphical user interface overlay 380 comprising a virtual cursor 390. The input device module 630 is configured to register input signals in the form of touching touch sensitive surfaces 643. The input device module 630 therefore comprises a touch sensitive surface, and is attached to the display device module 650, so that it is placed over the display surface of the display 652 and so that it does not move in relation to the portable interactive device 600 during operation of the device. The connection 700 to one computing device 500 is a wireless local area network connection 715, therefore the portable interactive device 600 also needs to comprise a device module 670 enabling the connection of the portable interactive device 600 to the computing device 500. The connection-enabling device module 670 is a zero client 673, which is a thin client with a significantly simplified operating system with a sole purpose of initiating and managing a network connection, and communication of devices that utilize the connection. The connection-enabling device module 670 is attached to the display device module 650, so that it does not move in relation to the portable interactive device 600 during operation of the device.

Such portable interactive device 600 exhibits some advantages of the previous portable interactive device such as being lightweight and easy to manually manipulate, as it is not physically attached to a computing device 500. Additionally, it is advantageously allowing for varied input signals to be performed, as touching touch sensitive surfaces 643 may include moving of virtual joysticks on touch sensitive surfaces 644, tapping virtual buttons on touch sensitive surfaces 645, or performing hand gestures on touch sensitive surfaces 646.

FIG. 11 depicts an exemplary schematic diagram of a portable interactive device with a tracker 600, connected to one computing device capable of performing operations for enabling multi-user interaction with detailed virtual objects of a shared virtual space 310 superimposed for all users identically on a shared physical space 210, according to one embodiment of the present invention. The depicted portable interactive device 600 comprises a tracker 620, a display device module 650, an input device module 630, and a connection 700 to one computing device 500, and is attached to an adjustable mount 680. The tracker is an electromagnetic sensor 621. The sole function of the tracker 620 is to allow a tracking server 800 to track movement of the portable interactive device 600 within a shared physical space 210. The tracker 620 is attached to the display device module 650, so it does not move in relation to the portable interactive device 600 during operation of the device. The display device module 650 comprises a display 652 primary function of which is to display a view 370 of a shared virtual space 310 and a graphical user interface overlay 380 comprising a virtual cursor 390. The input device module 630 is configured to register input signals in the form of pressing physical buttons 641, in the form of moving physical joysticks 642 and in the form of touching touch sensitive surfaces 643. The input device module 630 therefore comprises a part that comprises one or more physical buttons and one or more physical joysticks, and a part that comprises a touch sensitive surface. The part of the input device module 630 that comprises one or more physical buttons and one or more physical joysticks is attached to the display device module 650, so that it does not move in relation to the portable interactive device 600 during operation of the device. The part of the input device module 630 that comprises a touch sensitive surface is attached to the display device module 650, so that it is placed over the display surface of the display 652, and so that it does not move in relation to the portable interactive device 600 during operation of the device. The connection 700 to one computing device 500 is a wireless local area network connection 715, therefore the portable interactive device 600 also needs to comprise a device module 670 enabling the connection of the portable interactive device 600 to the computing device 500. The connection-enabling device module 670 is a zero client 673, which is a thin client with a significantly simplified operating system with a sole purpose of initiating and managing a network connection, and communication of devices that utilize the connection. The connection-enabling device module 670 is attached to the display device module 650, so that it does not move in relation to the portable interactive device 600 during operation of the device. The adjustable mount 680 the portable interactive device 600 is attached to is also attached to a wheeled chassis 683. The adjustable mount 680 is holding the position and rotation of the portable interactive device 600 within a shared physical space 210. The adjustable mount 680 can be manually adjusted into various positions and rotations. The wheeled chassis 683 enables movement of the portable interactive device in the shared physical space 210, without performing adjustments to the adjustable mount.

Such portable interactive device 600 exhibits some advantages of the aforementioned portable interactive devices such as allowing for varied input signals to be performed, as touching touch sensitive surfaces 643 may include moving of virtual joysticks on touch sensitive surfaces 644, tapping virtual buttons on touch sensitive surfaces 645, or performing hand gestures on touch sensitive surfaces 646. Such portable interactive device 600 also exhibits an advantage of removing the weight carried on the hands of users during manual positioning of the portable interactive device 600 in the shared physical space 210, by being attached to an adjustable mount 680, which is also attached to a wheeled chassis 683. The adjustable mount 680 carries all the weight of the portable interactive device 600 and allows for the portable interactive device 600 to be moved and also held in a specific position and rotation while hands are lifted from it.

FIG. 12 depicts an exemplary schematic diagram of a portable interactive device with a tracker 600, connected to one computing device capable of performing operations for enabling multi-user interaction with detailed virtual objects of a shared virtual space 310 superimposed for all users identically on a shared physical space 210, according to one embodiment of the present invention. The depicted portable interactive device 600 comprises a tracker 620, a display device module 650, an input device module 630, and a connection 700 to one computing device 500. The tracker is an electromagnetic sensor 621. The sole function of the tracker 620 is to allow a tracking server 800 to track movement of the portable interactive device 600 within a shared physical space 210. The tracker 620 is attached to the display device module 650, so it does not move in relation to the portable interactive device 600 during operation of the device. The display device module 650 comprises a display 652 primary function of which is to display a view 370 of a shared virtual space 310 and a graphical user interface overlay 380 comprising a virtual cursor 390. The input device module 630 is configured to register input signals in the form of touching touch sensitive surfaces 643. The input device module 630 therefore comprises a touch sensitive surface, and is attached to the display device module 650, so that it is placed over the display surface of the display 652 and so that it does not move in relation to the portable interactive device 600 during operation of the device. The connection 700 to one computing device 500 is an external computer bus connection 717. The connection 700 is implemented as one or more cables that are attached to connectors, designated for connecting devices using an external computer bus connection 717, both on the portable interactive device 600 and on the computing device 500. The computing device 500 to which the portable interactive device 600 is connected to is a wearable computer carried around by a user.

Such portable interactive device 600 exhibits some advantages of the aforementioned portable interactive devices such as being lightweight and easy to manually manipulate, as apart from not being physically attached to a computing device 500, no further connection-enabling device module 670 is needed to connect the portable interactive device 600 with a computing device 500. Such portable interactive device 600 is also advantageously resistant to latency issues of any connection 700 to a computing device 500 that utilizes a network, which exhibits higher latency than a computer bus connection 717.

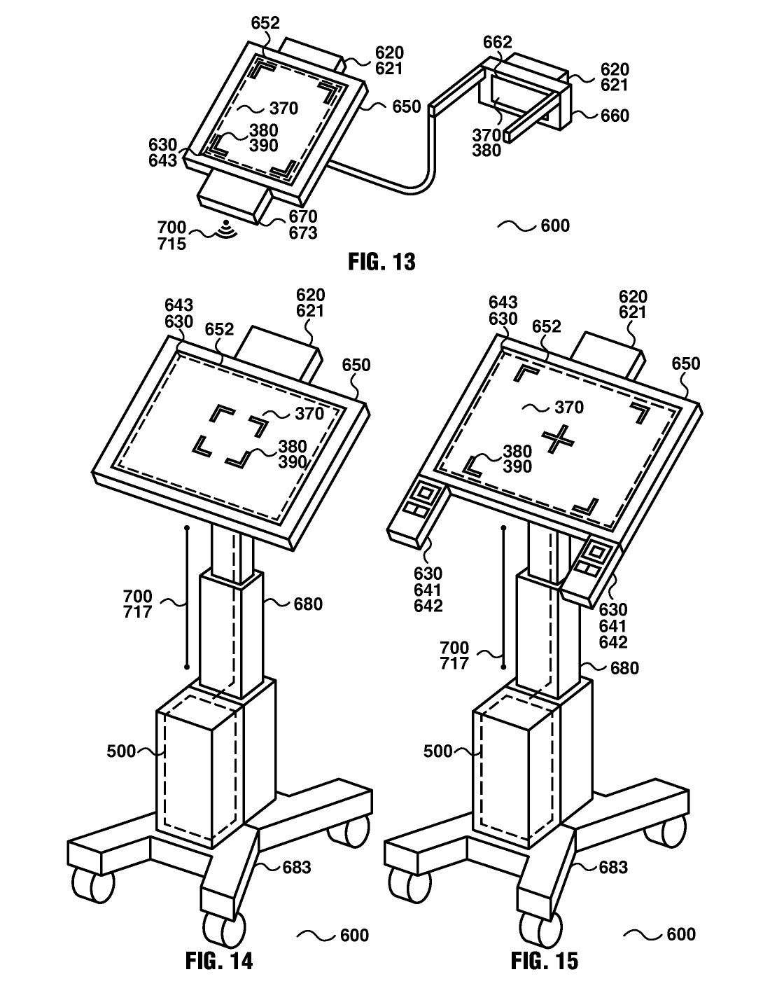

FIG. 13 depicts an exemplary schematic diagram of a portable interactive device with a tracker 600, connected to one computing device capable of performing operations for enabling multi-user interaction with detailed virtual objects of a shared virtual space 310 superimposed for all users identically on a shared physical space 210, according to one embodiment of the present invention. The depicted portable interactive device 600 comprises a tracker 620, a display device module 650, an input device module 630, a connection 700 to one computing device 500, and a complementary display module 660. The tracker is an electromagnetic sensor 621. The sole function of the tracker 620 is to allow a tracking server 800 to track movement of the portable interactive device 600 within a shared physical space 210. The tracker 620 is attached to the display device module 650, so it does not move in relation to the portable interactive device 600 during operation of the device. The display device module 650 comprises a display 652 primary function of which is to display a view 370 of a shared virtual space 310 and a graphical user interface overlay 380 comprising a virtual cursor 390. The input device module 630 is configured to register input signals in the form of touching touch sensitive surfaces 643. The input device module 630 therefore comprises a touch sensitive surface, and is attached to the display device module 650, so that it is placed over the display surface of the display 652 and so that it does not move in relation to the portable interactive device 600 during operation of the device. The connection 700 to one computing device 500 is a wireless local area network connection 715, therefore the portable interactive device 600 also needs to comprise a device module 670 enabling the connection of the portable interactive device 600 to the computing device 500. The connection-enabling device module 670 is a zero client 673, which is a thin client with a significantly simplified operating system with a sole purpose of initiating and managing a network connection, and communication of devices that utilize the connection. The connection-enabling device module 670 is attached to the display device module 650, so that it does not move in relation to the portable interactive device 600 during operation of the device. The complementary display module 660 is used for displaying a view 370 of the shared virtual space 310 and a graphical user interface overlay 380 comprising a virtual cursor 390. The complementary display module 660 comprises a head mounted display device, which comprises a display 662 suitable for being viewed by a user while mounted on the head of the user. The complementary display module 660 also comprises a tracker 620, which is an electromagnetic sensor 621, and which allows the tracking server 800 to also track the complementary display module 660 of the portable interactive device 600.

Such portable interactive device 600 exhibits some advantages of the aforementioned portable interactive devices such as being lightweight and easy to manually manipulate and also advantageously allowing for varied input signals to be performed, as touching touch sensitive surfaces 643 may include moving of virtual joysticks on touch sensitive surfaces 644, tapping virtual buttons on touch sensitive surfaces 645, or performing hand gestures on touch sensitive surfaces 646. Such portable interactive device 600 also exhibits an advantage of expanding view 370 of the shared virtual space 310 that is being displayed to a user, by displaying a semi-transparent view 370 of the surrounding shared virtual space 310 using the complementary display module 660 that also does not prevent the user from viewing the primary view 370 of the shared virtual space 310 that is displayed using the display device module 650 of the portable interactive device 600 and from interacting with the shared virtual space 310.

FIG. 14 depicts an exemplary schematic diagram of a portable interactive device with a tracker 600, connected to one computing device capable of performing operations for enabling multi-user interaction with detailed virtual objects of a shared virtual space 310 superimposed for all users identically on a shared physical space 210, according to one embodiment of the present invention. The depicted portable interactive device 600 comprises a tracker 620, a display device module 650, an input device module 630, and a connection 700 to one computing device 500, and is attached to an adjustable mount 680. The tracker is an electromagnetic sensor 621. The sole function of the tracker 620 is to allow a tracking server 800 to track movement of the portable interactive device 600 within a shared physical space 210. The tracker 620 is attached to the display device module 650, so it does not move in relation to the portable interactive device 600 during operation of the device. The display device module 650 comprises a display 652 primary function of which is to display a view 370 of a shared virtual space 310 and a graphical user interface overlay 380 comprising a virtual cursor 390. The input device module 630 is configured to register input signals in the form of touching touch sensitive surfaces 643. The input device module 630 therefore comprises a touch sensitive surface, which is attached to the display device module 650, so that it is placed over the display surface of the display 652, and so that it does not move in relation to the portable interactive device 600 during operation of the device. The connection 700 to one computing device 500 is an external computer bus connection 717. The connection 700 is implemented as one or more cables that are attached to connectors, designated for connecting devices using an external computer bus connection 717, both on the portable interactive device 600 and on the computing device 500. The computing device 500 is a self-contained computing device, such as personal computer. The adjustable mount 680 the portable interactive device 600 is attached to is also attached to a wheeled chassis 683. The adjustable mount 680 is holding the position and rotation of the portable interactive device 600 within a shared physical space 210. The adjustable mount 680 can be manually adjusted into various positions and rotations. The wheeled chassis 683 enables movement of the portable interactive device 600 in the shared physical space 210, without performing adjustments to the adjustable mount 680. The computing device 500 to which the portable interactive device 600 is connected to moves with the portable interactive device 600 in the shared physical space 210, as it is attached to the adjustable mount 680 of the portable interactive device 600.

Such portable interactive device 600 exhibits some advantages of the aforementioned portable interactive devices such as being resistant to latency issues of connections 700 which utilize a network and such as removing the weight carried on the hands of users during manual positioning of the portable interactive device 600 in the shared physical space 210, by being attached to an adjustable mount 680, which is also attached to a wheeled chassis 683. The adjustable mount 680 carries all the weight of the portable interactive device 600 and allows for the portable interactive device 600 to be moved and also held in a specific position and rotation while hands are lifted from it.

FIG. 15 depicts an exemplary schematic diagram of a portable interactive device with a tracker 600, connected to one computing device capable of performing operations for enabling multi-user interaction with detailed virtual objects of a shared virtual space 310 superimposed for all users identically on a shared physical space 210, according to one embodiment of the present invention. The depicted portable interactive device 600 comprises a tracker 620, a display device module 650, an input device module 630, and a connection 700 to one computing device 500, and is attached to an adjustable mount 680. The tracker is an electromagnetic sensor 621. The sole function of the tracker 620 is to allow a tracking server 800 to track movement of the portable interactive device 600 within a shared physical space 210. The tracker 620 is attached to the display device module 650, so it does not move in relation to the portable interactive device 600 during operation of the device. The display device module 650 comprises a display 652 primary function of which is to display a view 370 of a shared virtual space 310 and a graphical user interface overlay 380 comprising a virtual cursor 390. The input device module 630 is configured to register input signals in the form of pressing physical buttons 641, in the form of moving physical joysticks 642 and in the form of touching touch sensitive surfaces 643. The input device module 630 therefore comprises a part that comprises one or more physical buttons and one or more physical joysticks, and a part that comprises a touch sensitive surface. The part of the input device module 630 that comprises one or more physical buttons and one or more physical joysticks is attached to the display device module 650, so that it does not move in relation to the portable interactive device 600 during operation of the device. The part of the input device module 630 that comprises a touch sensitive surface is attached to the display device module 650, so that it is placed over the display surface of the display 652, and so that it does not move in relation to the portable interactive device 600 during operation of the device. The connection 700 to one computing device 500 is an external computer bus connection 717. The connection 700 is implemented as one or more cables that are attached to connectors, designated for connecting devices using an external computer bus connection 717, both on the portable interactive device 600 and on the computing device 500. The computing device 500 is a self-contained computing device, such as personal computer. The adjustable mount 680 the portable interactive device 600 is attached to is also attached to a wheeled chassis 683. The adjustable mount 680 is holding the position and rotation of the portable interactive device 600 within a shared physical space 210. The adjustable mount 680 can be manually adjusted into various positions and rotations. The wheeled chassis 683 enables movement of the portable interactive device 600 in the shared physical space 210, without performing adjustments to the adjustable mount 680. The computing device 500 to which the portable interactive device 600 is connected to moves with the portable interactive device 600 in the shared physical space 210, as it is attached to the adjustable mount 680 of the portable interactive device 600.

Such portable interactive device 600 exhibits the same advantages of the previously described portable interactive and additionally it is advantageously allowing for varied input signals to be performed, as apart from touching touch sensitive surfaces 643 it is configured to register input signals in the form of pressing physical buttons 641 and in the form of moving physical joysticks 642. This additional input signal registering capability allows for a more precise control of the view 370 of a shared virtual space 310 as the hands of a user do not need to be lifted from the portable interactive device 600 during interaction and can remain on the part of the input device module 630 that comprises physical buttons and physical joysticks.

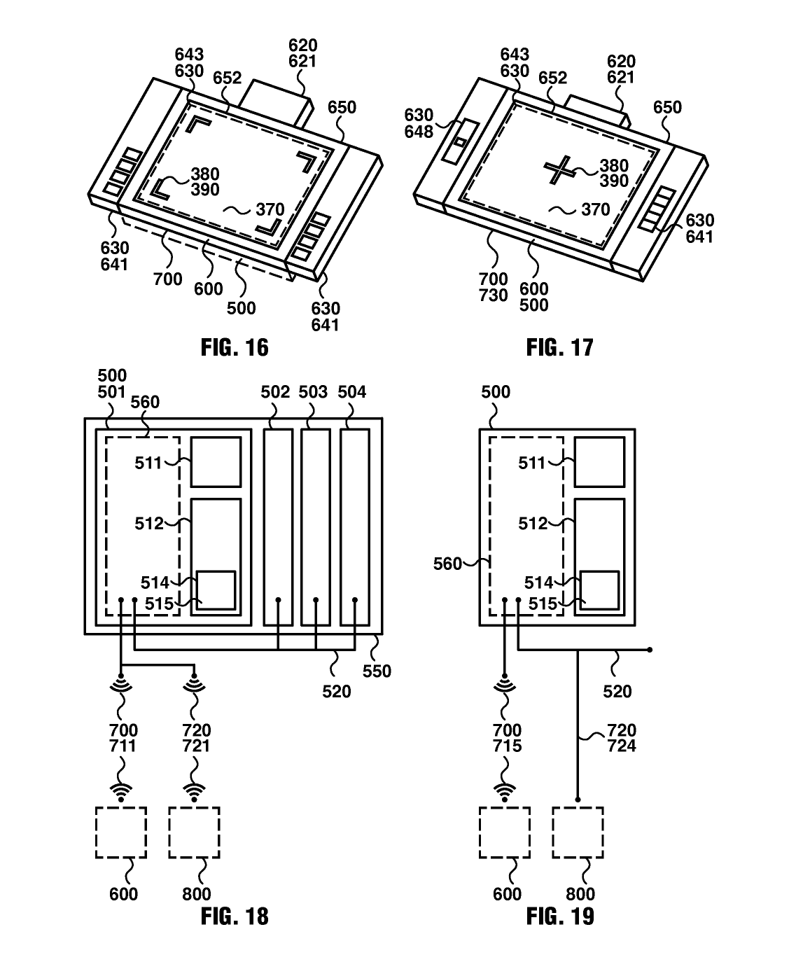

FIG. 16 depicts an exemplary schematic diagram of a portable interactive device with a tracker 600, connected to one computing device capable of performing operations for enabling multi-user interaction with detailed virtual objects of a shared virtual space 310 superimposed for all users identically on a shared physical space 210, according to one embodiment of the present invention. The depicted portable interactive device 600 comprises a tracker 620, a display device module 650, an input device module 630, and a connection 700 to one computing device 500. The tracker is an electromagnetic sensor 621. The sole function of the tracker 620 is to allow a tracking server 800 to track movement of the portable interactive device 600 within a shared physical space 210. The tracker 620 is attached to the display device module 650, so it does not move in relation to the portable interactive device 600 during operation of the device. The display device module 650 comprises a display 652 primary function of which is to display a view 370 of a shared virtual space 310 and a graphical user interface overlay 380 comprising a virtual cursor 390. The input device module 630 is configured to register input signals in the form of pressing physical buttons 641 and in the form of touching touch sensitive surfaces 643. The input device module 630 therefore comprises a part that comprises one or more physical buttons and a part that comprises a touch sensitive surface. The part of the input device module 630 that comprises one or more physical buttons is attached to the display device module 650, so that it does not move in relation to the portable interactive device 600 during operation of the device. The part of the input device module 630 that comprises a touch sensitive surface is attached to the display device module 650, so that it is placed over the display surface of the display 652, and so that it does not move in relation to the portable interactive device 600 during operation of the device. The connection 700 to one computing device 500 is an internal computer bus connection 717. The connection 700 is implemented as one or more cables that are attached to connectors, designated for connecting devices using an internal computer bus connection 717, both on the portable interactive device 600 and on the computing device 500. The computing device 500 is attached to the display device module 650 so that it does not move in relation to the portable interactive device 600 during operation of the device, and is therefore carried around with the portable interactive device 600 by a user.

Such portable interactive device 600 exhibits some advantages of the aforementioned portable interactive devices such as being resistant to latency issues of any connection 700 to a computing device 500 that utilizes a network, which exhibits higher latency than a computer bus connection 717. Such portable interactive device 600 is also advantageously being easy to maintain, as the attached computing device 500 can be upgraded without having to modify any device module of the portable interactive device 600, by simply detaching the computing device 500 from the display device module 650 and attaching another computing device 500 with upgraded components.

FIG. 17 depicts an exemplary schematic diagram of a portable interactive device with a tracker 600, connected to one computing device capable of performing operations for enabling multi-user interaction with detailed virtual objects of a shared virtual space 310 superimposed for all users identically on a shared physical space 210, according to one embodiment of the present invention. The depicted portable interactive device 600 comprises a tracker 620, a display device module 650, an input device module 630, and a connection 700 to one computing device 500. The tracker is an electromagnetic sensor 621. The sole function of the tracker 620 is to allow a tracking server 800 to track movement of the portable interactive device 600 within a shared physical space 210. The tracker 620 is attached to the display device module 650, so it does not move in relation to the portable interactive device 600 during operation of the device. The display device module 650 comprises a display 652 primary function of which is to display a view 370 of a shared virtual space 310 and a graphical user interface overlay 380 comprising a virtual cursor 390. The input device module 630 is configured to register input signals in the form of pressing physical buttons 641, in the form of performing eye movement 648 and in the form of touching touch sensitive surfaces 643. The input device module 630 therefore comprises a part that comprises one or more physical buttons, a part that comprises one or more cameras, and a part that comprises a touch sensitive surface. The part of the input device module 630 that comprises one or more physical buttons is attached to the display device module 650, so that it does not move in relation to the portable interactive device 600 during operation of the device. The part of the input device module 630 that comprises one or more cameras is attached to the display device module 650, so that the one or more cameras can scan user eye movement and so that it does not move in relation to the portable interactive device 600 during operation of the device. The part of the input device module 630 that comprises a touch sensitive surface is attached to the display device module 650, so that it is placed over the display surface of the display 652, and so that it does not move in relation to the portable interactive device 600 during operation of the device. The connection 700 to one computing device 500 is an internal computer bus connection 717. The connection 700 is implemented by combining the portable interactive device 600 and the computing device 500 into one composite device 730, and therefore both devices are carried around and manipulated by a user at once.

Such portable interactive device 600 exhibits the same advantages of the previously described portable interactive device and additionally it is advantageously allowing for more varied input signals to be performed as it comprises an input device module 630 capable of registering input signals in the form of performing eye movement 648. Furthermore, such portable interactive device 600 also exhibits an advantage of being easier to set up as part of a system 400, as it is a self-contained composite device 730 combining functionality of a portable interactive device 600 and of a computing device 500.

All of these variously configured portable interactive devices with trackers 600, which allow users to perform the actual interaction with a shared virtual space 310 superimposed for all users identically on a shared physical space 210, and which are connected to computing devices 500 capable of performing operations for enabling multi-user groups 160 to simultaneously interact with a shared virtual space 310 superimposed for all users identically on a shared physical space 210, are only examples that show various ways the individual device modules of the portable interactive devices 600, which embody the present invention, can be configured. Each configuration is suitable for a different usage scenario and exhibits different advantages.

Another important element of the aforementioned systems 400, which performs operations for enabling multi-user interaction with a shared virtual space 310 superimposed for all users identically on a shared physical space 210, is the computing device 500. Thus, each of the aforementioned systems 400 also comprises at least one computing device 500 with a connection 700 to one unique portable interactive device 600 and a connection 720 to a tracking server 800. As was previously noted, each included computing device 500 is configured at least to perform operations for enabling multi-user interaction with detailed virtual objects of a shared virtual space 310 superimposed for all users identically on a shared physical space 210. The computing device 500 therefore needs to comprise components, which allow the device to perform operations basing on instructions that are part of one or more programs. These components and the actual computing devices 500 can be configured in various ways and such configurations need to be described to further expand understanding of how the various embodiments of the present invention can be implemented.

FIG. 18 through 21 depict exemplary block diagrams of variously configured computing devices 500, capable of performing operations for enabling multi-user groups 160 to simultaneously interact with a shared virtual space 310 superimposed for all users identically on a shared physical space 210, according to some embodiments of the present invention. These variously configured computing devices 500 describe some of the various ways individual components and the actual computing device 500 can be configured.

FIG. 18 depicts an exemplary block diagram of a computing device 500, capable of performing operations for enabling multi-user interaction with detailed virtual objects of a shared virtual space 310 superimposed for all users identically on a shared physical space 210, according to one embodiment of the present invention. The depicted computing device 500, 501 is a virtual machine running on a physical server 550, together with other computing devices 502, 503, 504. The depicted computing device 500, 501 comprises one or more processors 511, memory 512, and one or more programs 514. The one or more programs 514 are stored in the memory 512 and are configured to be executed by the one or more processors 511. The one or more programs 514 comprise instructions 515 that cause the computing device 500, 501 to perform operations for enabling multi-user interaction with detailed virtual objects of a shared virtual space 310 superimposed for all users identically on a shared physical space 210. The computing device 500, 501 can also comprise other components 560, which can for example enable communication of individual components of the computing device 500, 501 or communication of the computing device 500, 501 with other computing devices 502, 503, 504, one unique portable interactive device 600 or a tracking server 800. Such communication with other devices is performed using connections, which are created by these communication-enabling components. The computing device 500, 501 is connected to other computing devices 502, 503, 504 using wired local area network connections 520 which are part of the physical server 550. The computing device 500, 501 is connected to one unique portable interactive device 600 using a connection 700 established between the devices, which is an internet connection 711. The connection 700 is wireless in parts of the connections that lead through the shared physical space 210, but can be wired, wireless, or a combination thereof in other parts. The computing device 500, 501 is connected to a tracking server 800 using a connection 720 between the devices, which is also an internet connection 721. The connection 720 is wireless in parts of the connections that lead through the shared physical space 210, but can be wired, wireless, or a combination thereof in other parts. The computing device 500, 501 is used for performing operations caused by the instructions 515, which collectively enable multi-user interaction with detailed virtual objects of a shared virtual space 310 superimposed for all users identically on a shared physical space 210.

Such computing device 500, which is using internet connections 711, 721 to connect to devices located in a shared physical space 210 is therefore located in a remote location, away from the shared physical space 210 in which a multi-user group 160 interacts with the shared virtual space 310 using portable interactive devices 600 tracked in the shared physical space 210. This computing device 500 configuration exhibits an advantage of allowing scaling the quantity of computing devices 500 up or down depending on the quantity of participating users, without manipulating hardware configuration of any computing device, by simply running more or less virtual machines. Such computing device 500 also exhibits an advantage of allowing maintenance to be performed without interrupting multi-user interaction with the shared virtual space 310 superimposed for all users identically on the shared physical space 210, by configuring the computing device 500 as a virtual machine to run on a different part of the same physical server 550, or on a different physical than the part of the physical server 550 on which the maintenance is performed, prior to the beginning of the multi-user interaction.

FIG. 19 depicts an exemplary block diagram of a computing device 500, capable of performing operations for enabling multi-user interaction with detailed virtual objects of a shared virtual space 310 superimposed for all users identically on a shared physical space 210, according to one embodiment of the present invention. The depicted computing device 500 is a self-contained computing device, such as a personal computer. The depicted computing device 500 comprises one or more processors 511, memory 512, and one or more programs 514. The one or more programs 514 are stored in the memory 512 and are configured to be executed by the one or more processors 511. The one or more programs 514 comprise instructions 515 that cause the computing device 500 to perform operations for enabling multi-user interaction with detailed virtual objects of a shared virtual space 310 superimposed for all users identically on a shared physical space 210. The computing device 500 can also comprise other components 560, which can for example enable communication of individual components of the computing device 500 or communication of the computing device 500 with other computing devices, one unique portable interactive device 600 or a tracking server 800. Such communication with other devices is performed using connections, which are created by these communication-enabling components. The computing device 500 is connected to other computing devices using wired local area network connections 520. The computing device 500 is connected to one unique portable interactive device 600 using a connection 700 established between the devices, which is a wireless local area network connection 715. The connection 700 is wireless in parts of the connections that lead through the shared physical space 210, but can be wired, wireless, or a combination thereof in other parts. The computing device 500 is connected to a tracking server 800 using a connection 720 between the devices, which is a wired local area network connection 724, but can also be a wireless local area network connection 725, or a combination of wired 724 and wireless local area network connections 725. The computing device 500 is used for performing operations caused by the instructions 515, which collectively enable multi-user interaction with detailed virtual objects of a shared virtual space 310 superimposed for all users identically on a shared physical space 210.

Such computing device 500, which is using wireless or wired local area network connections 715, 724 is located in proximity to the shared physical space 210 in which a multi-user group 160 interacts with the shared virtual space 310 using portable interactive devices 600 tracked in the shared physical space 210. Such configuration of a computing device 500 therefore exhibits an advantage of allowing more reliable connections 700, 720 between computing devices 500 and portable interactive devices 600 or tracking servers 800, due to the connections being local, less prone to interruptions. Also, such computing devices 500 configured this way, are advantageously simpler to set up as only self-contained computing devices, such as personal computers are used.

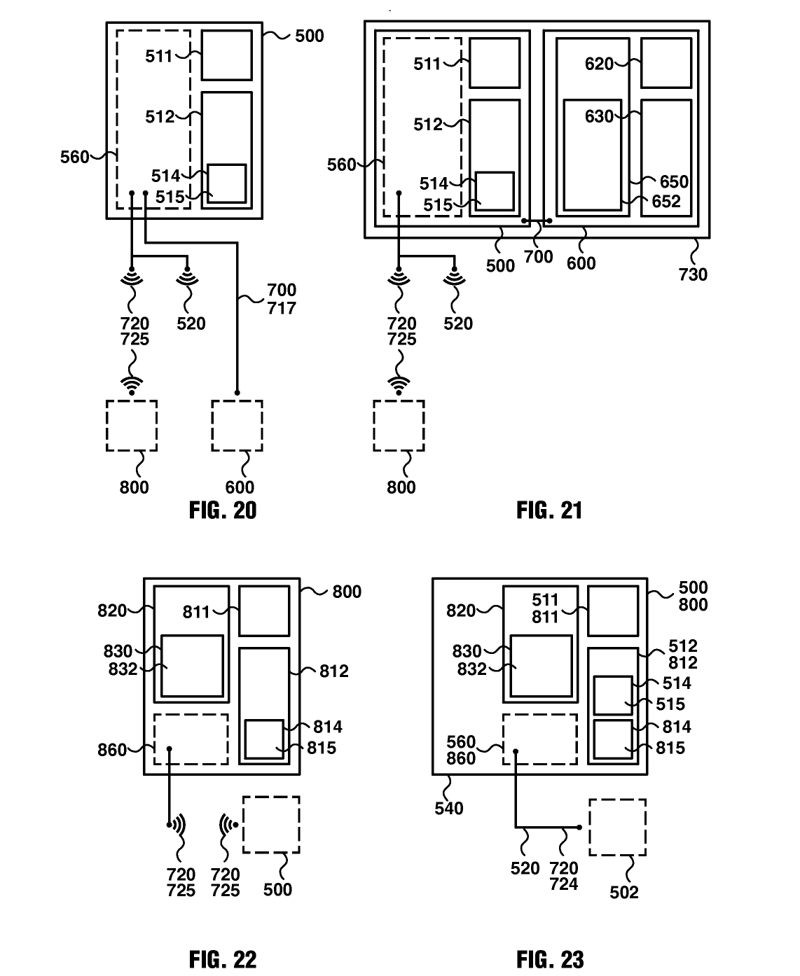

FIG. 20 depicts an exemplary block diagram of a computing device 500, capable of performing operations for enabling multi-user interaction with detailed virtual objects of a shared virtual space 310 superimposed for all users identically on a shared physical space 210, according to one embodiment of the present invention. The depicted computing device 500 is a self-contained computing device, such as a personal computer. The depicted computing device 500 comprises one or more processors 511, memory 512, and one or more programs 514. The one or more programs 514 are stored in the memory 512 and are configured to be executed by the one or more processors 511. The one or more programs 514 comprise instructions 515 that cause the computing device 500 to perform operations for enabling multi-user interaction with detailed virtual objects of a shared virtual space 310 superimposed for all users identically on a shared physical space 210. The computing device 500 can also comprise other components 560, which can for example enable communication of individual components of the computing device 500 or communication of the computing device 500 with other computing devices, one unique portable interactive device 600 or a tracking server 800. Such communication with other devices is performed using connections, which are created by these communication-enabling components. The computing device 500 is connected to other computing devices using wireless local area network connections 520. The computing device 500 is connected to one unique portable interactive device 600 using a connection 700 established between the devices, which is an external computer bus connection 717, such as a USB or a Thunderbolt connection. The computing device 500 is connected to a tracking server 800 using a connection 720 between the devices, which is a wireless local area network connection 725, but can also be a wired local area network connection 724, or a combination of wired 724 and wireless local area network connections 725. The computing device 500 is used for performing operations caused by the instructions 515, which collectively enable multi-user interaction with detailed virtual objects of a shared virtual space 310 superimposed for all users identically on a shared physical space 210.

Such computing device 500 moves in the shared physical space 210 together with the portable interactive device 600. A computing device 500 configured in such way exhibits the same advantages of the previously described computing device, as it is also connected to other devices using more reliable local connections 700, 720 and uses a self-contained computing device 500, such as personal computer. Moreover, such computing device 500 is advantageously resistant to latency issues of network based connections as any communication between the portable interactive device 600 and the computing device 500 is performed using an external computer bus connection 717, which has lower latency than a network based connection.

FIG. 21 depicts an exemplary block diagram of a computing device 500, capable of performing operations for enabling multi-user interaction with detailed virtual objects of a shared virtual space 310 superimposed for all users identically on a shared physical space 210, according to one embodiment of the present invention. The depicted computing device 500 is a self-contained composite device 730, such as a tablet, which combines computing device functionality with portable interactive device functionality. The depicted computing device 500 comprises one or more processors 511, memory 512, and one or more programs 514. The one or more programs 514 are stored in the memory 512 and are configured to be executed by the one or more processors 511. The one or more programs 514 comprise instructions 515 that cause the computing device 500 to perform operations for enabling multi-user interaction with detailed virtual objects of a shared virtual space 310 superimposed for all users identically on a shared physical space 210. The computing device 500 can also comprise other components 560, which can for example enable communication of individual components of the computing device 500 or communication of the computing device 500 with other computing devices, one unique portable interactive device 600 or a tracking server 800. Such communication with other devices is performed using connections, which are created by these communication-enabling components. The computing device 500 is connected to other computing devices using wireless local area network connections 520. The computing device 500 is connected to one unique portable interactive device 600 using a connection 700 established between the devices, which is an internal computer bus connection 717, such as a SATA or a PCIe connection. The computing device 500 and the portable interactive device 600 are combined into one self-contained composite device 730, which causes the devices to be carried around and manipulated by a user at once. The computing device 500 is connected to a tracking server 800 using a connection 720 between the devices, which is a wireless local area network connection 725, but can also be a wired local area network connection 724, or a combination of wired 724 and wireless local area network connections 725. The computing device 500 is used for performing operations caused by the instructions 515, which collectively enable multi-user interaction with detailed virtual objects of a shared virtual space 310 superimposed for all users identically on a shared physical space 210.

Such computing device 500 is carried and manipulated together with the portable interactive device 600, as the devices are combined into one composite device 630. A computing device 500 configured such way exhibits the same advantages of the previously described computing device, and exhibits an advantage of being even simpler to setup, as the computing device is a self-contained composite device 630, such as a tablet, which combines functionality of a computing device 500 and of a portable interactive device 600.

All of these variously configured computing devices 500, which perform operations for enabling multi-user interaction with a shared virtual space 310 superimposed for all users identically on a shared physical space 210, and which are connected to portable interactive devices with trackers 600 and a tracking server 800, are only examples that show various ways components of the computing devices 500, which are included in all embodiments of the present invention, can be configured. Each configuration is suitable for a different usage scenario and exhibits different advantages. Each configuration of the computing device 500 utilizes a connection 720 of the computing device 500 to a tracking server 800 in order to be able to acquire tracking data that stores information from the process of tracking of positions and rotations of portable interactive devices 600 in the shared physical space 210.

The tracking server 800 is therefore yet another important element of the aforementioned systems 400, which tracks positions and rotations of portable interactive devices with trackers 600 in a shared physical space 210 and performs operations for allowing computing devices 500 to acquire tracking data. The tracking server 800 therefore needs to comprise components, which allow the tracking server 800 to track the portable interactive devices with trackers 600 in the shared physical space 210 and to perform operations for allowing computing devices 500 to acquire tracking data. The comprised components and the actual tracking server 800 can be configured in various ways and such configurations need to be described to further expand understanding of how the various embodiments of the present invention can be implemented.

In some embodiments, the tracking server 800 comprises a tracking device module 820, one or more processors 811, memory 812, and one or more programs 814. The tracking device module 820 is configured to track position and rotation of portable interactive devices with trackers 600 in a shared physical space 210. The tracking device module 820 comprises a tracking device 830, which is used for tracking and can for example be a set of tracking cameras 831, a set of electromagnetic receptors 832, or a set of infrared projectors 833. The one or more programs 814 are stored in the memory 812 and are configured to be executed by the one or more processors 811. The one or more programs 814 comprise instructions 815 causing the tracking server 800 to perform operations for allowing computing devices 500 to acquire tracking data. The tracking server 800 can also comprise other components 860, which can for example enable communication of individual components of the tracking server 800 or communication of the tracking server 800 with computing devices 500.

FIG. 22 through 24 depict exemplary block diagrams of variously configured tracking servers 800, capable of tracking portable interactive devices with trackers 600 in a shared physical space 210 and of performing operations for allowing computing devices 500 to acquire tracking data, according to some embodiments of the present invention. These variously configured tracking servers 800 describe some of the various ways individual components and the actual tracking server 800 can be configured.

FIG. 22 depicts an exemplary block diagram of a tracking server 800, capable of tracking portable interactive devices 600 in a shared physical space 210 and of performing operations for allowing computing devices 500 to acquire tracking data, according to one embodiment of the present invention. The depicted tracking server 800 comprises a tracking device module 820, one or more processors 811, memory 812, and one or more programs 814. The tracking device module 820 is configured to track position and rotation of portable interactive devices with trackers 600 in a shared physical space 210. The tracking device module 820 comprises a tracking device 830, which is used for tracking and which is a set of electromagnetic receptors 832. The one or more programs 814 are stored in the memory 812 and are configured to be executed by the one or more processors 811. The one or more programs 814 comprise instructions 815 causing the tracking server 800 to perform operations for allowing computing devices 500 to acquire tracking data. The tracking server 800 can also comprise other components 860, which can for example enable communication of individual components of the tracking server 800 or communication of the tracking server 800 with computing devices 500. The tracking server is connected to computing devices 500 using connections 720 which are implemented as wireless local area network connections 715. The connections 720 are wireless in parts of the connections that lead through the shared physical space 210, but can be wired, wireless, or a combination thereof in other parts. The tracking server 800 is used for tracking positions and rotations of portable interactive devices with trackers 600 in a shared physical space 210 and to perform operations caused by the instructions 815, which collectively enable computing devices 500 to acquire tracking data and in effect enable multi-user interaction with detailed virtual objects of a shared virtual space 310 superimposed for all users identically on a shared physical space 210.

FIG. 23 depicts an exemplary block diagram of a tracking server 800, capable of tracking portable interactive devices 600 in a shared physical space 210 and of performing operations for allowing computing devices 500 to acquire tracking data, according to one embodiment of the present invention. The depicted tracking server 800 is a composite device 540 comprising a self-contained computing device, such as a personal computer and a tracking device module 820. The composite device 540 combines functionality of a computing device 500 with functionality of a tracking server 800. Therefore, some components of the self-contained computing device are used by the composite device 540 to perform functions both of the computing device 500 and of the tracking server 800. The composite device 540 comprises a tracking device module 820, one or more processors 511, 811, memory 512, 812, and one or more programs 814. The composite device 540 also comprises one or more programs 514, which are utilized when performing functions of the computing device 500. The tracking device module 820 is configured to track position and rotation of portable interactive devices with trackers 600 in a shared physical space 210. The tracking device module 820 comprises a tracking device 830, which is used for tracking and which is a set of electromagnetic receptors 832. The one or more programs 814 are stored in the memory 812 and are configured to be executed by the one or more processors 811. The one or more programs 814 comprise instructions 815 causing the tracking server 800, in the form of a composite device 540, to perform operations for allowing computing devices 500 to acquire tracking data. The composite device 540 used to perform functions of the tracking server 800 can also comprise other components 560, 860, which can for example enable communication of individual components of the tracking server 800 or communication of the tracking server 800 with computing devices 500, other than the computing device 501 it is combined with. The computing device 501 the tracking server 800 is combined with can also use the same optional components 560,860 to connect to other computing devices 500, or portable interactive devices 600. The tracking server is connected to computing devices 500, other than the computing device 501 it is combined with using connections 720 which are implemented as wired local area network connections 724. The connections 720 can also be wireless local area network connections 725, or a combination of wired 724 and wireless local area network connections 725. The tracking server 800 is used for tracking positions and rotations of portable interactive devices with trackers 600 in a shared physical space 210 and to perform operations caused by the instructions 815, which collectively enable computing devices 500 to acquire tracking data and in effect enable multi-user interaction with detailed virtual objects of a shared virtual space 310 superimposed for all users identically on a shared physical space 210.

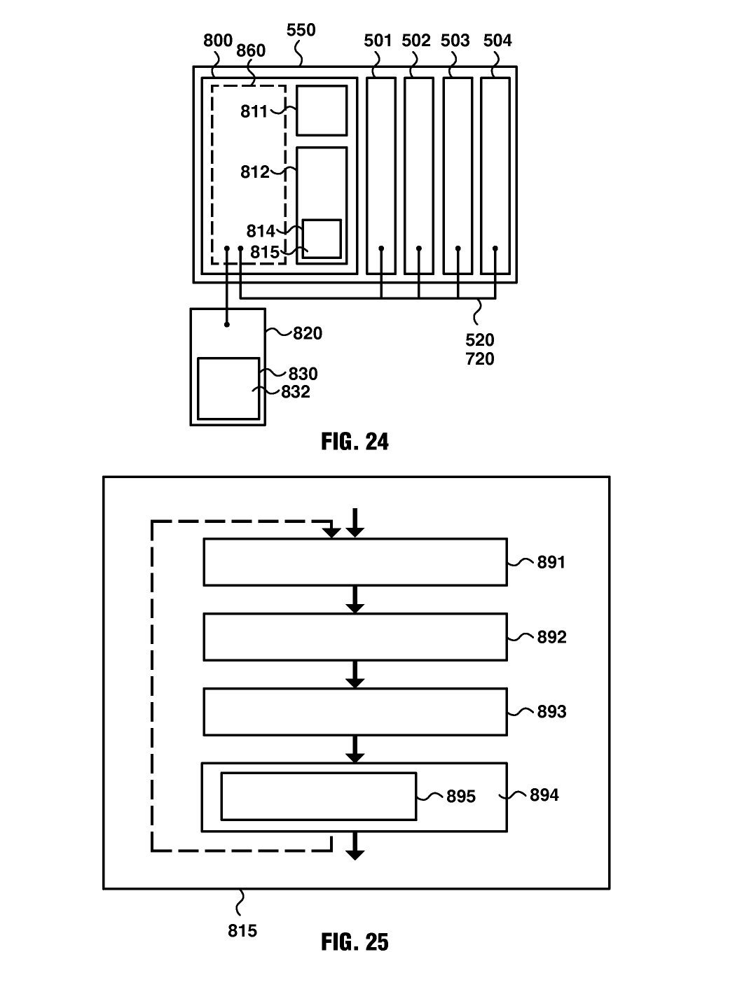

FIG. 24 depicts an exemplary block diagram of a tracking server 800, capable of tracking portable interactive devices 600 in a shared physical space 210 and of performing operations for allowing computing devices 500 to acquire tracking data, according to one embodiment of the present invention. The depicted tracking server 800 is a virtual machine running on a physical server 550, together with other computing devices 501, 502, 503, 504. The depicted tracking server 800 comprises a tracking device module 820, one or more processors 811, memory 812, and one or more programs 814. The tracking device module 820 is configured to track position and rotation of portable interactive devices with trackers 600 in a shared physical space 210. The tracking device module 820 comprises a tracking device 830, which is used for tracking and which is a set of electromagnetic receptors 832. The one or more programs 814 are stored in the memory 812 and are configured to be executed by the one or more processors 811. The one or more programs 814 comprise instructions 815 causing the tracking server 800 to perform operations for allowing computing devices 501, 502, 503, 504 to acquire tracking data. The tracking server 800 can also comprise other components 860, which can for example enable communication of individual components of the tracking server 800 or communication of the tracking server 800 with computing devices 501, 502, 503, 504. The tracking server is connected to computing devices 501, 502, 503, 504 using connections 720 which are implemented as wired local area network connections 715 which are part of the physical server 550. The connections 520 which connect individual computing devices 501, 502, 503, 504 are the same as the connections 720 which connect the tracking server 800 with the computing devices 501, 502, 503, 504. The tracking server 800 is used for tracking positions and rotations of portable interactive devices with trackers 600 in a shared physical space 210 and to perform operations caused by the instructions 815, which collectively enable computing devices 501, 502, 503, 504 to acquire tracking data and in effect enable multi-user interaction with detailed virtual objects of a shared virtual space 310 superimposed for all users identically on a shared physical space 210.

All of these variously configured tracking servers 800, which track positions and rotations of portable interactive devices with trackers 600 in a shared physical space 210 and perform operations which collectively allow computing devices 500 to acquire tracking data and in effect enable computing devices 500 to perform operations for enabling multi-user interaction with a shared virtual space 310 superimposed for all users identically on a shared physical space 210, are only examples that show various ways components of the tracking server 800, which are included in the various embodiments of the present invention, can be configured. Each configuration is suitable for a different usage scenario and exhibits different advantages, which are characterized by the overall configuration of the system 400 as a part of which the tracking server 800 is utilized.

Many different configurations of systems 400 for enabling multi-user interaction with a shared virtual space 310 superimposed for all users identically on a shared physical space 210, portable interactive devices 600, computing devices 500 and tracking servers 800 are possible, all of which have not been described in the descriptions of the various embodiments of the present invention. It will be understood to those skilled in the art, that despite this, many different configurations are possible and that such configurations can be made to the systems 400, portable interactive devices 600, computing devices 500 and tracking servers 800 that are included in various embodiments of the present invention, without departing from the principles and spirit of the present invention.

In some embodiments, a portable interactive device with a tracker 600 can comprise an input device module 630 configured to register input signals 632 such as pressing physical buttons 641, moving physical joysticks 642, touching touch sensitive surfaces 643, moving virtual joysticks on touch sensitive surfaces 644, tapping virtual buttons on touch sensitive surfaces 645, performing hand gestures on touch sensitive surfaces 646, performing hand gestures in-air 647, performing eye movement 648, or performing sounds 649. The input device module 630 can be configured in various ways to enable the function of registering one or more of all possible input signal types. The input device module 630 can for example be comprised of a single part capable of registering certain input signal type, or of a single part capable of registering multiple input signal types. The input device module 630 can also for example be divided into multiple parts, each capable of registering certain input signal type or multiple input signal types. Several portable interactive device 600 configurations have been described, some of which show single part or multiple part configurations of input device modules 630.

FIG. 9 depicts an exemplary schematic diagram of a portable interactive device with a tracker 600, according to one embodiment of the present invention, which comprises an input device module 630 divided into two separate parts, each registering the same type of input signals 632, namely pressing physical buttons 641. The parts therefore comprise physical buttons, which can be pressed, and this function can be achieved by utilizing an existing physical controller, such as a game controller, a gamepad, a keyboard, a mouse, a remote control, or by constructing a physical controller from parts that are comprised in such existing physical controllers. The input device module 630 is divided into two parts solely to allow each hand of a user to be positioned on opposite parts of a display device module 650 of the portable interactive device 600.

FIG. 10 depicts an exemplary schematic diagram of a portable interactive device with a tracker 600, according to one embodiment of the present invention, which comprises an input device module 630 consisting of a single part, which is registering one type of input signals 632, namely touching touch sensitive surfaces 643. As was previously noted, this input signal type may include other more specific input signal types, such as moving of virtual joysticks on touch sensitive surfaces 644, tapping virtual buttons on touch sensitive surfaces 645, or performing hand gestures on touch sensitive surfaces 646. The input device module 630 therefore comprises a touch sensitive surface, which can register touch events performed on it. This function is achieved for example by utilizing a transparent touch sensitive panel placed over a display 652 of a display device module 650 or by utilizing a touch sensitive panel that can be non-transparent and can be placed on any other surface. The transparent touch sensitive panel allows for input signals 632 to be performed by a user with precise knowledge of what points in the view 370 of the shared virtual space 310 displayed on the display 652 the input signals 632 are positioned on. The non-transparent touch sensitive panel on the other hand, can provide varied input for controllers, which are otherwise registering mostly only the pressing physical buttons 641 input signal type, and does not require a user to cover parts of the display 652 with his hands during interaction, keeping the view 370 of the shared virtual space 310 clear.

FIG. 11 depicts an exemplary schematic diagram of a portable interactive device with a tracker 600, according to one embodiment of the present invention, which comprises an input device module 630 consisting of three parts. One part of the input device module 630 is a touch sensitive surface, capable of registering touching touch sensitive surfaces 643 input signal type. This part exhibits the same advantages as the previously described input device module 630 part. The other two parts are configured to both register two types of input signals 632 at the same time, namely pressing physical buttons 641 and moving physical joysticks 642. In addition to physical buttons, which can be pressed, these parts comprise physical joysticks, which can be moved. Such joysticks are intended to be controlled by thumbs, and are sometimes called thumbsticks. Since these two parts, that comprise physical buttons and physical joysticks are divided solely to allow each hand of a user to be positioned on opposite parts of a display device module 650 of the portable interactive device 600, each of these parts of the input device module 630 comprises one joystick. Thus, such configuration allows each thumb of a user to control one joystick. Joysticks are capable of producing more fluid input signals, than the discrete button presses, as they are moved in one or more axes providing continuous input values. The parts of the input device module 630 that comprise both physical buttons and physical joysticks can utilize existing physical controllers, such as game controllers, gamepads, mice, joysticks, or can utilize a physical controller constructed from parts that are comprised in such existing physical controllers.

FIG. 17 depicts an exemplary schematic diagram of a portable interactive device with a tracker 600, according to one embodiment of the present invention, which comprises an input device module 630 consisting of three parts. One part of the input device module 630 is a touch sensitive surface, capable of registering touching touch sensitive surfaces 643 input signal type. Another part of the input device module 630 is a controller, capable of registering pressing physical buttons 641 input signal type. These two parts exhibit the same advantages as the aforementioned input device module 630 parts. Another part is configured to register performing eye movement 648 input signal type. Therefore, this part comprises a camera, which can capture an image stream in which eyes of a user are present and transmit the captured image stream to a computing device 500 to be analyzed, in order to determine what type of eye movement 648 has been performed and in effect determine the input signal 632 that has been performed. Eye movement 648 can be used as a passive input signal 632 that does not require a user to perform any specific action, as the input device module 630 that comprises a part capable of registering eye movement 648 can simply capture where a user is looking on the display 652 of the display device module 650 and unobtrusively use such information to perform a certain function.

In some embodiments, a portable interactive device 600 can comprise an input device module 630 capable of registering in-air hand gestures 647. Such input device module 630 therefore comprises a device capable of registering movement of objects in physical space, such as LEAP motion device, Kinect device, or any other infrared camera device or depth camera device. Input signals using such input device module 630 is performed by first capturing a data stream by the included device capable of registering movement of objects in physical space, and especially movement of hands of a user, and transmitting the data stream to a computing device 500 to be analyzed, in order to determine what type of in-air hand gesture 647 has been performed. If an in-air hand gesture 647 is recognized, it can be considered an input signal 632. Input device module 630 that comprises a device capable of registering movement of objects in physical space, and therefore registering in-air hand gestures 647 provide a user with even more varied input signal 632 options, as input signals 632 are performed using three dimensions instead of one or two dimensions, provided by such input device modules 630 that comprise physical buttons, joysticks, touch sensitive surfaces, or cameras.

In some embodiments, a portable interactive device 600 can comprise an input device module 630 capable of registering sounds 649. Such input device module 630 therefore comprises a microphone capable of capturing sounds performed by a user and transmitting the captured audio stream to a computing device 500 to be analyzed, in order to determine what type of sound 649 has been performed and in effect determine the input signal 632 that has been performed in form of the sound 649. An input device module 630, which utilizes a microphone for capturing sound 649 for input signals 632 provides further variety to the various options that a user has when performing input signals 632 using the portable interactive device 600.

Moreover, in order for any of the aforementioned input device modules 630 of the portable interactive devices 600 to function properly, driver software needs to be installed on computing devices 500 that are connected to the portable interactive devices 600. The purpose of any driver software is to allow a computing device 500 to cooperate with an additional device that is connected to the computing device 500 and driver software is used for the same purpose throughout the various embodiments of the present invention.

In some embodiments, a portable interactive device with a tracker 600 can comprise a device module 670 enabling the connection 700 of the portable interactive device 600 to one unique computing device 500. The connection-enabling device module 670 can for example be implemented as a thin client 671, an ultra-thin client 672, or a zero client 673. All of these devices, which can be configured to enable the connection 700 of the portable interactive device 600 to one unique computing device 500, comprise computing devices with operating system software simplified to various degree, when compared to a standard operating system. A sole purpose of a thin client 671, an ultra-thin client 672, or a zero client 673 when used as a part of a connection-enabling device module 670 of a portable interactive device 600 is to manage a network connection 700 with a computing device 500 and allow transmission of input signals 632 to the computing device 500 and transmission of views 370 of a shared virtual space 310 to the portable interactive device 600. Additional data can be transmitted between the computing device 500 and the portable interactive device 600 using the connection 700 managed by the connection-enabling device module 670, such as audio. A computing device that is the main part of any connection-enabling device module 670 running a simplified operating system can therefore also contain significantly less hardware components, than have to be present in a computing device such as a personal computer, as a computing device of any connection-enabling device module 670 does not need to perform all computations by itself.

In some embodiments, a portable interactive device with a tracker 600 can comprise a complementary display module 660. The complementary display module 660 can be used to display a view 370 of a shared virtual space 310, a graphical user interface overlay 380 comprising a virtual cursor 390, or both the view 370 of the shared virtual space 310 and the graphical user interface overlay 380 comprising the virtual cursor 390.

FIG. 13 depicts an exemplary schematic diagram of a portable interactive device with a tracker 600, according to one embodiment of the present invention, which comprises such complementary display module 660. This complementary display module 660 can for example be head-mounted. Such head-mounted display device can be implemented by using any existing head-mounted display device, or be constructed from parts that are comprised in any existing head-mounted display device. The complementary display module 660 comprises a display 662, which is used to display the view 370 of a shared virtual space 310, so that a larger portion of the shared virtual space 310 can be viewed by a user, than by only using the main display 652 of the portable interactive device 600. The complementary display module 660 is connected to the portable interactive device 600 using a computer bus connection, such as a USB or a Thunderbolt connection, or using a cable capable of transmitting at least video signal. The main purpose of using a complementary display module 660 is to create a surrounding video effect that creates an impression to a user, that he is surrounded by a shared virtual space 310, while also keeping the functionality of the portable interactive device 600, and the ability to interact with detailed virtual objects of the shared virtual space 310 superimposed on the shared physical space 210.

In some embodiments, a portable interactive device with a tracker 600 can comprise an adjustable mount 680. The adjustable mount 680 is configured to hold the position and rotation of the portable interactive device 600 within the shared physical space 210. The adjustable mount 680 is attached to a wheeled chassis 683, which enables movement of the portable interactive device 600 in the shared physical space 210, without performing adjustments to the adjustable mount 680. The wheeled chassis 683 can move around the shared physical space 210 independently of the adjustable mount 680, by being moved by a user.

FIG. 14 and FIG. 15 depict exemplary schematic diagrams of portable interactive devices with trackers 600, according to some embodiment of the present invention, which comprise an adjustable mount 680. The adjustable mount is attached to the portable interactive device 600 using a connection for example to the display device module 650 of the portable interactive device 600, but can also be attached to other parts of the portable interactive device 600. The connection between the adjustable mount 680 and the portable interactive device 600 can be implemented for example using one or more brackets, mounts, adaptors, or screws, as long as the function of a firm connection is achieved. The adjustable mount 680 primarily serves the function of bearing all the weight of the portable interactive device 600, to ease manual positioning of the portable interactive device 600 in the shared physical space 210 that is being performed by a user. Additionally, the adjustable mount 680 can also be used to carry a computing device 500, when such device is connected to a portable interactive device 600 using a computer bus connection 717. In order to keep the same positioning capabilities of the portable interactive device 600 that it has when being held in hands of a user, an adjustable mount 680 can allow rotation of the portable interactive device 600 around two axes, with rotation around the remaining third axis being allowed by the wheeled chassis 683, since it can be rotated in the shared physical space 210 without adjusting the adjustable mount 680. Also, in order to keep the same positioning capabilities of the portable interactive device 600 that it has when being held in hands of a user, an adjustable mount 680 can allow positioning of the portable interactive device 600 on a vertical axis, which is perpendicular to the floor, with positioning on the other two axes being allowed by the wheeled chassis 683, since it can be positioned around the floor plane, which is identical to the plane formed by the two remaining axes, without adjusting the adjustable mount 680.

In some embodiments, a connection 700 between a computing device 500 and one unique portable interactive device with a tracker 600 can for example be an internet connection 711, a wide area network connection 712, a metropolitan area network connection 713, a wired local area network connection 714, a wireless local area network connection 715, a radio wave connection 716, a computer bus connection 717, a connection of circuit boards 718 or a connection of circuits 719.

All of these connections are well known among those skilled in the art, and are not described in detail in order to not unnecessarily obscure the present invention. It should be noted however, that each connection type is suitable for a different configuration of a system 400 for enabling multi-user interaction with a shared virtual space 310 superimposed for all users identically on a shared physical space 210, part of which both the computing device 500 and the portable interactive device 600 are utilized. An internet connection 711, a wide area network connection 712, or a metropolitan area network connection 713 between the devices can be used when the computing device 500 is located in a remote location, away from the shared physical space 210 in which the portable interactive device 600 is operated. A wired local area network connection 714 or a wireless local area network connection 715 can be used when both the computing device 500 and the portable interactive device 600 are located in proximity or inside of the shared physical space 210. A radio wave connection 716 can be implemented to transmit audio signal, video signal and input signals between the computing device 500 and the portable interactive device 600 as well, when both of the devices are located in proximity or inside of the shared physical space 210. Such connection can be implemented by using radio wave transceivers on both of the devices to enable exchange of signals. A computer bus connection 717 can be used when the computing device 500 and the portable interactive device 600 move around the shared physical space 210 together.

In some embodiments, a computing device 500 can be implemented by using an existing self-contained computing device such as a computer, a portable computer, a wearable computer, a tablet, a mobile phone, a gaming console or a portable gaming console. All of these general-purpose devices as well as other special-purpose computing devices can be used as a computing device 500, as long as they are utilized to perform operations for enabling multi-user interaction with a shared virtual space 310 superimposed for all users identically on a shared physical space 210. A computing device 500 can also be implemented by constructing a self-contained general-purpose or special-purpose computing device from components that are comprised in such existing self-contained computing devices or other complementary components.

In some embodiments, the portable interactive device 600 comprises a tracker 620 which can be implemented for example as an electromagnetic tracking sensor 621, a set of passive tracking markers bearing a retro-reflective material acting as a single rigid object 622, a set of active tracking markers emitting light acting as a single rigid object 623, or a set of infrared tracking sensors 624. All of these various tracker 620 types also require the tracking server 800 to comprise a tracking device 830 of the tracking device module 820 configured to be capable of registering movement of the corresponding tracker 620 type within the shared physical space 210.

An electromagnetic tracking sensor 621 can be used in conjunction with a tracking device 830 that comprises an electromagnetic transmitter. A set of passive tracking markers bearing a retro-reflective material acting as a single rigid object 622 can be used in conjunction with a tracking device 830 that comprises a set of motion capture cameras capturing infrared light reflected from the markers. A set of active tracking markers emitting light acting as a single rigid object 623 can be used in conjunction with a tracking device 830 that comprises a set of motion capture cameras capturing light emitted by the markers in special patterns, that make them identifiable. A set of infrared tracking sensors 624 can be used in conjunction with a tracking device 830 that comprises one or more infrared illuminators.

Each tracker 620 type also needs to be attached to a portable interactive device 600 in a specific way to ensure optimal functionality. An electromagnetic tracking sensor 621 does not need to keep a line of sight with a tracking device 830, therefore can be attached to any surface area of a portable interactive device 600. Both mentioned tracking marker sets 622, 623 need to be attached to a portable interactive device 600, so that markers of the marker sets 622, 623 can be visually tracked by a tracking device 830. A set of infrared tracking sensors 624 also need to be attached to a portable interactive device 600, so that sensors keep a line of sight with a tracking device 830. Also, a minimum of three markers per a marker set 622, 623 are required to keep a line of sight to the tracking device 830 in order to ensure proper tracking functionality. Therefore, it is optimal to include three or more markers as part of each marker set of either the passive 622 or the active 623 types, that do not form a straight line in the shared physical space 210 and that do not move in relation to the portable interactive device 600. The same requirement applies to a set of infrared tracking sensors 624 as well.

In some embodiments, the portable interactive device 600 comprises a tracker 620 that is mechanically attached to the portable interactive device 600. Such tracker 620 can be attached to the device using various forms of mechanical attachment such as using mounts, screws, bolts, fixings, adaptors, holding devices, brackets, or velcro fasteners. The tracker 620 can also be attached to the portable interactive device using glue. It is important to ensure, that the tracker 620 attached such way does not move in relation to the portable interactive device 600, so that view 370 of the shared virtual space 310 that is displayed by a display device module 650 of the portable interactive device 600 is only affected by the actual movement of the portable interactive device 600 in the shared physical space 210, that is performed by a user.

In some embodiments, a computing device 500 and a portable interactive device with a tracker 600 can be combined into one composite device 730. Such configuration of the two devices requires them to be moved around the shared physical space 210 together.

In some embodiments, a computing device 500 and the tracking server 800 can be combined into one composite device 540. Such configuration of the two devices requires one composite device 540 to perform both the functions of the computing device 500 and of the tracking server 800.

In some embodiments, a computing device 500 can be a virtual machine running on a physical server 550. A virtual machine is a software implementation of a computing device, which emulates its hardware architecture and runs software the same way as a physical computing device. Therefore, such computing device 500 can be used throughout the various embodiments of the present invention without any restrictions posed on its capability to perform operations for enabling multi-user interaction with a shared virtual space 310 superimposed on a shared physical space 210.

In some embodiments, a tracking server 800 can comprise a computing device, which is a virtual machine running on a physical server 850. Such computing device that is comprised by the tracking server 800 can be used throughout the various embodiments of the present invention similarly as the previously mentioned computing device 500.

In some embodiments, a computing device 500 comprises one or more processors 511. Processors suitable for execution of instructions 515 comprised by one or more programs 514, that cause the computing device 500 to perform operations for enabling multi-user interaction with a shared virtual space 310 superimposed for all users identically on a shared physical space 210, can be for example general-purpose microprocessors, special-purpose microprocessors, or any one or more processors of any digital computing device.

In some embodiments, a computing device 500 comprises memory 512. Memory 512 can be any form of non-volatile memory, medium, memory device, or one or more mass storage devices for storing data. These can for example be semiconductor memory devices such as EPROM, EEPROM, flash memory devices, SSD disks, magnetic disks such as internal hard disks or removable disks, magneto-optical disks, or optical disks such as CD-ROM and DVD-ROM disks. The computing device 500 can be configured to allow transmission of data to and from the memory 512. Generally, the computing device 500 needs to be configured to allow transmission of data from the memory 512 in the form of instructions 514 to the one or more processors 511, which can be executed, generating certain output data that can be used to perform operations for enabling multi-user interaction with a shared virtual space 310 superimposed for all users identically on a shared physical space 210.

In some embodiments, a computing device 500 comprises one or more programs 514 stored in the memory 512 and configured to be executed by the one or more processors 511. The one or more programs 514 comprise instructions which when executed by the one or more processors 511 cause the computing device 500 to perform operations for enabling multi-user interaction with a shared virtual space 310 superimposed for all users identically on a shared physical space 210. The one or more programs 514 can be stored on a non-transitory computer-readable storage medium 513 that is comprised in a computer program product, which is an article of manufacture. Such computer program product can be a distributed separately, or can be distributed as a part of the computing device 500.

In some embodiments, a computing device 500 comprises other components 560. These other components 560 can for example be components that enable communication of individual components of the computing device 500 such as various computer buses, or communication of the computing device 500 with other computing devices, one unique portable interactive device 600 to which the computing device 500 is connected to, or with a tracking server 800, such as various network cards. Other components 560 can also be input devices, output devices, storage devices, and expansion cards such as graphics cards, network cards or sound cards. Such expansion cards can be configured in various ways to be integrated on one or more expansion circuit boards or on a motherboard.

In some embodiments, the portable interactive device 600 comprises a display device module 650. The display device module 650 comprises a display 652. The display 652 can be any type of display device such as an LCD (liquid crystal display), an EPD (electronic paper display), a 3D display, or a touch sensitive display, which can be used to display a view 370 of a shared virtual space 310.

In some embodiments, a portable interactive device 600 can comprise additional output devices, in addition to the display device module 650. These additional output devices can for example be sound reproduction devices, such as speakers or headphones, or force feedback devices such as vibrating devices.

In some embodiments, a tracking server 800 comprises one or more processors 811, memory 812, one or more programs 814 which are stored in the memory 812 and which are configured to be executed by the one or more processors 811. The one or more programs 814 comprise instructions 815 which when executed by the one or more processors 811 cause the tracking server 800 to perform operations for allowing computing devices to acquire tracking data. The tracking server 800 additionally also comprises a tracking device module 820 in order to be able to track positions and rotations of portable interactive devices 600 in a shared physical space 210. However, most of the components of the tracking server 800 can be formed into a self-contained computing device such as the computing device 500, which is used to perform operations for enabling multi-user interaction with a shared virtual space 310 superimposed for all users identically on a shared physical space 210. The computing device of the tracking server 800 can therefore be configurable in all the various ways as the computing device 500 was previously described to be configurable.

In some embodiments, a tracking server 800 can comprise one or more programs 814 which comprise instructions 815 causing the tracking server 800 to perform several operations. The one or more programs 814 or the instructions 815 comprised by the one or more programs 814 can be stored on various types of memory 812. The memory 812 can be any form of computer-readable storage medium 813 that can store instructions and data. The operations caused by the instructions 815 when executed by the one or more processors 811 of the tracking server 800 collectively enable the tracking server 800 to perform the function of allowing computing devices 500 to acquire tracking data 840 and in effect allow computing devices 500 to enable multi-user interaction with a shared virtual space 310 superimposed for all users identically on a shared physical space 210.

FIG. 25 shows an exemplary flow diagram illustrating operations, performed by a tracking server 800, for allowing computing devices 500 to acquire tracking data 840 and in effect for allowing computing devices 500 to enable multi-user interaction with a shared virtual space 310 superimposed for all users identically on a shared physical space 210, according to one embodiment of the present invention.

The depicted operations 891, 892, 893, 894, 895 are performed by the tracking server 800 once every unit of time. The unit of time can be any quantity of time and can be stored as a variable that determines how often the depicted operations 891, 892, 893, 894, 895 are performed by the tracking server. The more often the said operations are performed, the more recent tracking data 840 the computing devices 500 will be able to acquire, each time they attempt to do so. It is therefore best to set the unit of time, which defines how often said operations are being performed by the tracking server 800 below one tenth of a second, in order to allow computing devices 500 to acquire frequently updated information about positions and rotations of portable interactive devices 600 in the shared physical space 210. Thus, once every unit of time all said operations are performed by the tracking server 800.

First, an operation of acquiring 891 raw tracking data 841 from the tracking device module 820 is performed by the tracking server 800. The acquiring 891 is performed by a connection established between the tracking device module 820 and other components of the tracking server 800, which can be substituted by a computing device. The tracking device module 820 comprises a tracking device 830, which is a set of electromagnetic receptors 832 in this example. The tracking device 830 of the tracking device module 820 captures positions and rotations of trackers 620 in the form of electromagnetic tracking sensors 621 within the shared physical space 210. During this operation 891, the data that contains the positions and rotations of the trackers 620 is transmitted to the computing device 500 in the form of raw tracking data 841 in computer-readable form. Next, an operation of storing 892 the raw tracking data 841 in the memory 812 is performed by the tracking server 800. The data acquired 891 by the computing device 500 is simply written to any memory 812 the tracking server 800 has access to, so that it can be further read from the memory 812 and used in other operations.

Next, an operation of generating 893 tracking data 840 from the stored raw tracking data 841 is performed by the tracking server 800. The raw tracking data 841, which already contains information about precise position and rotation of trackers 620 is modified during this operation 893, so the values are relative to a selected origin 209 of the shared physical space 210. The origin 209 can be any point in the shared physical space 210. The tracking data 840, which results from such operation 893 therefore comprises tracker position and rotation data relative to an origin 209 of the shared physical space 210. Then, an operation of running a network server 894, which manages the process of sharing 895 the tracking data 840 with other computing devices 500, is performed by the tracking server 800. The network server 894 is one or more software processes running on a computing device that is comprised in the tracking server 800. The process of sharing 895 the tracking data 840 comprises configuring the tracking data 840, that is stored in memory 812 the tracking server 800 has access to, to be accessible by other computing devices 500 using connections 720 established between the tracking server 800 and the computing devices 500 over a network or other type of connection, such as computer bus connection. Other computing devices 500 can acquire the tracking data 840 after these operations have been performed at least once, and can repeat the operation of acquiring the tracking data 840 as many times as they are required to do so, while the tracking server 800 is operational, using connections 720 established between the tracking server 800 and the computing devices 500.

In some embodiments, a system 400 for enabling multi-user interaction with detailed virtual objects of a shared virtual space 310 superimposed for all users identically on a shared physical space 210 is provided. The system 400 comprises at least one portable interactive device 600. Each included portable interactive device 600 is configured at least to display a view 370 of the shared virtual space 310 and a graphical user interface overlay 380, which comprises a virtual cursor 390 and also to register input signals 632. The system 400 also comprises a tracking server 800. The tracking server 800 is configured at least to track the position and rotation of each included portable interactive device 600 in the shared physical space 210, and to perform operations for allowing computing devices 500 to acquire tracking data 840. Each included and tracked portable interactive device 600 is connected to one unique computing device 500. The tracking server 800 is connected to each included computing device 500. Thus, the system 400 also comprises at least one computing device 500 with a connection 700 to one unique portable interactive device 600 and a connection 720 to the tracking server 800. Each included computing device 500 is configured at least to perform operations for enabling multi-user interaction with detailed virtual objects of a shared virtual space 310 superimposed for all users identically on a shared physical space 210. Such operations collectively constitute a method 900 for enabling multi-user interaction with detailed virtual objects of a shared virtual space 310 superimposed for all users identically on a shared physical space 210.

In some embodiments, operations of the method 900 can be performed by a computing device 500 connected to one portable interactive device with a tracker 600 by executing instructions 515 comprised in one or more programs 514 stored on a non-transitory computer-readable storage medium 513. The instructions 515, when executed, cause the computing device 500 to perform operations of the method 900 for enabling multi-user interaction with a shared virtual space 310 superimposed for all users identically on a shared physical space 210.

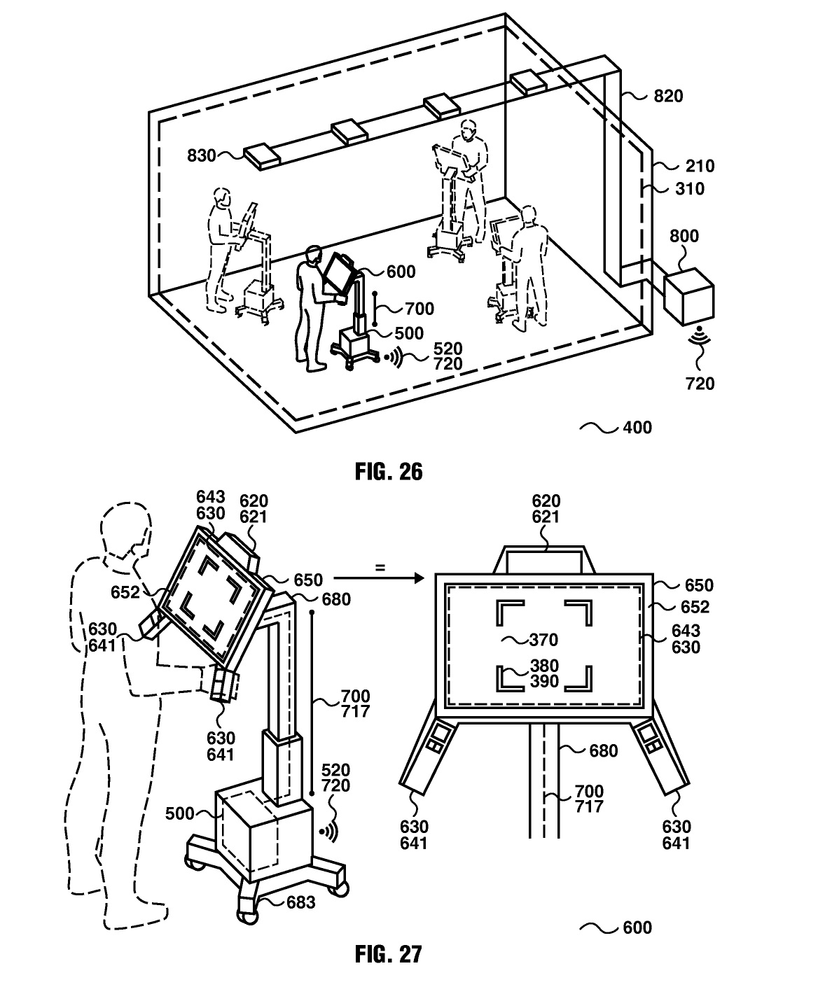

FIG. 26 depicts an exemplary schematic diagram of a system 400 capable of enabling multi-user interaction with detailed virtual objects of a shared virtual space 310 superimposed for all users identically on a shared physical space 210, according to one embodiment of the present invention. Such system 400 can be considered the most practical and therefore the best mode of implementing the present invention.

The depicted system 400 comprises several computing devices and also a computing device 500, which is used to perform operations of the method 900 for enabling multi-user interaction with a shared virtual space 310 superimposed for all users identically on a shared physical space 210. The system 400 further comprises several portable interactive devices. The computing device 500 used to perform operations of the method 900 is connected to one portable interactive device with a tracker 600 using a connection 700. The connection 700 is implemented as an external computer bus connection 717. The computing device 500 used to perform operations of the method 900 is connected to other computing devices using connections 520 implemented as wireless local area network connections. The system 400 also comprises a tracking server 800, which is connected to each included computing device and also the computing device 500 used to perform operations of the method 900, using connections 720. The connections 720 between the tracking server 800 and each included computing device are implemented as wireless local area network connections 725. The tracking server 800 is configured at least to track the position and rotation of each included portable interactive device in the shared physical space 210, and to perform operations for allowing computing devices to acquire tracking data 840. The computing device 500 is configured at least to perform operations of the method 900 for enabling multi-user interaction with a shared virtual space 310 superimposed for all users identically on a shared physical space 210. The computing device 500 used to perform operations of the method 900 is a self-contained computing device, such as personal computer. The computing device 500 comprises one or more processors 511, memory 512 and one or more programs 514. The one or more programs 514 are stored in the memory 512 and are configured to be executed by the one or more processors 511. The one or more programs 514 comprise instructions 515, which when executed by the one or more processors 511, cause the computing device 500 to perform operations of the method 900 for enabling multi-user interaction with a shared virtual space 310 superimposed for all users identically on a shared physical space 210. The computing device 500 can also comprise other components 560, which can for example enable communication of individual components of the computing device 500 or communication of the computing device 500 with other computing, the portable interactive device 600 it is connected to, or the tracking server 800.

FIG. 27 depicts an exemplary schematic diagram of the portable interactive device with a tracker 600, connected to the computing device 500 used to perform operations of the method 900 for enabling multi-user interaction with detailed virtual objects of a shared virtual space 310 superimposed for all users identically on a shared physical space 210, according to one embodiment of the present invention. The portable interactive device with a tracker 600, in this exemplary embodiment of the present invention, is comprised in the system 400 depicted in FIG. 26, which has been described in foregoing paragraphs.

The depicted portable interactive device 600 comprises a tracker 620, a display device module 650, an input device module 630, and a connection 700 to the computing device 500 used to perform operations of the method 900. The portable interactive device 600 is attached to an adjustable mount 680. The tracker is an electromagnetic sensor 621. The sole function of the tracker 620 is to allow the tracking server 800 to track movement of the portable interactive device 600 within a shared physical space 210. The tracker 620 is attached to the display device module 650, so it does not move in relation to the portable interactive device 600 during operation of the device. The display device module 650 comprises a display 652 primary function of which is to display a view 370 of a shared virtual space 310 and a graphical user interface overlay 380 comprising a virtual cursor 390. The input device module 630 is configured to register input signals in the form of pressing physical buttons 641 and in the form of touching touch sensitive surfaces 643. The input device module 630 therefore comprises a part that comprises one or more physical buttons, and a part that comprises a touch sensitive surface. The part of the input device module 630 that comprises one or more physical is attached to the display device module 650, so that it does not move in relation to the portable interactive device 600 during operation of the device. The part of the input device module 630 that comprises a touch sensitive surface is attached to the display device module 650, so that it is placed over the display surface of the display 652, and so that it does not move in relation to the portable interactive device 600 during operation of the device. The connection 700 to the computing device 500 used to perform operations of the method 900 is an external computer bus connection 717. The connection 700 is implemented as one or more cables that are attached to connectors, designated for connecting devices using an external computer bus connection 717, both on the portable interactive device 600 and on the computing device 500. The adjustable mount 680 the portable interactive device 600 is attached to is also attached to a wheeled chassis 683. The adjustable mount 680 is holding the position and rotation of the portable interactive device 600 within a shared physical space 210. The adjustable mount 680 can be manually adjusted into various positions and rotations. The wheeled chassis 683 enables movement of the portable interactive device 600 in the shared physical space 210, without performing adjustments to the adjustable mount 680. The computing device 500 used to perform operations of the method 900, to which the portable interactive device 600 is connected to moves with the portable interactive device 600 in the shared physical space 210, as it is attached to the adjustable mount 680 of the portable interactive device 600.

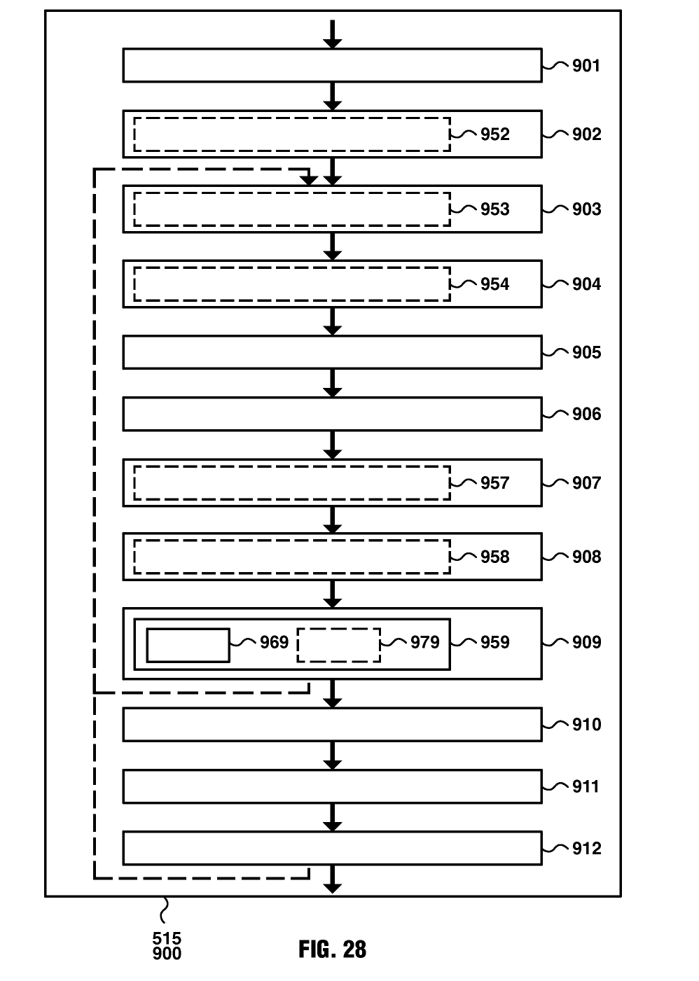

FIG. 28 shows an exemplary flow diagram illustrating a method 900 for enabling multi-user interaction with detailed virtual objects of a shared virtual space 310 superimposed for all users identically on a shared physical space 210, according to one embodiment of the present invention. The method 900 comprises operations, which can be performed by any computing device 500 connected to one portable interactive device with a tracker 600. The operations of the method 900 are caused by instructions 515, which can be divided into separate instructions for each individual operation. The computing device 500 used to perform operations of the method 900 in this exemplary embodiment of the present invention, is comprised in the system 400 depicted in FIG. 26, which has been described in foregoing paragraphs. As part of the system 400, each included computing device performs the operations of the method 900 individually, so that each user is able to perform individual interaction with detailed virtual objects of the shared virtual space 310 superimposed for all users identically on a shared physical space 210.

One or more of the depicted operations 901, 902, 952, 903, 953, 904, 954, 905, 906, 907, 957, 908, 958, 909, 959, 969, 979, 910, 911, 912 are performed by the computing device 500 once every unit of time. A unit of time can be any quantity of time and can be stored as a variable that determines how often one or more of the depicted operations of the method 900 are performed by the computing device 500. Several different units of time can define several different intervals for different sets of one or more of the depicted operations of the method 900. One set of operations can be performed more often than another set of operations of the method 900 and vice versa. The more often one or more of the depicted operations are performed, the more fluid is the interaction with a shared virtual space 310 of a user. For example in some software applications, a view 370 of the shared virtual space 310 can be refreshed more often, to give a user a fluid viewing experience with a high frame rate, but the shared virtual space 310 itself can be refreshed less often, as long as a user can continue viewing the shared virtual space 310 fluidly. Each software application that utilizes the method 900 for enabling multi-user interaction with detailed virtual objects of a shared virtual space 310 superimposed for all users identically on a shared physical space 210, needs to be individually configured to use such units of time for such sets of one or more operations of the method 900, that suit the specific purpose of such software application. In this exemplary embodiment of the present invention, each operation of the method 900 is performed only so many times, that each step can be described in detail in order to bring about complete understanding of how individual elements of the various embodiments of the present invention interoperate, and how multi-user interaction with detailed virtual objects of a shared virtual space 310 superimposed for all users identically on a shared physical space 210 can be enabled by such interoperation of said elements and by performing the operations of the method 900 by the computing device 500 connected to the portable interactive device with a tracker 600.

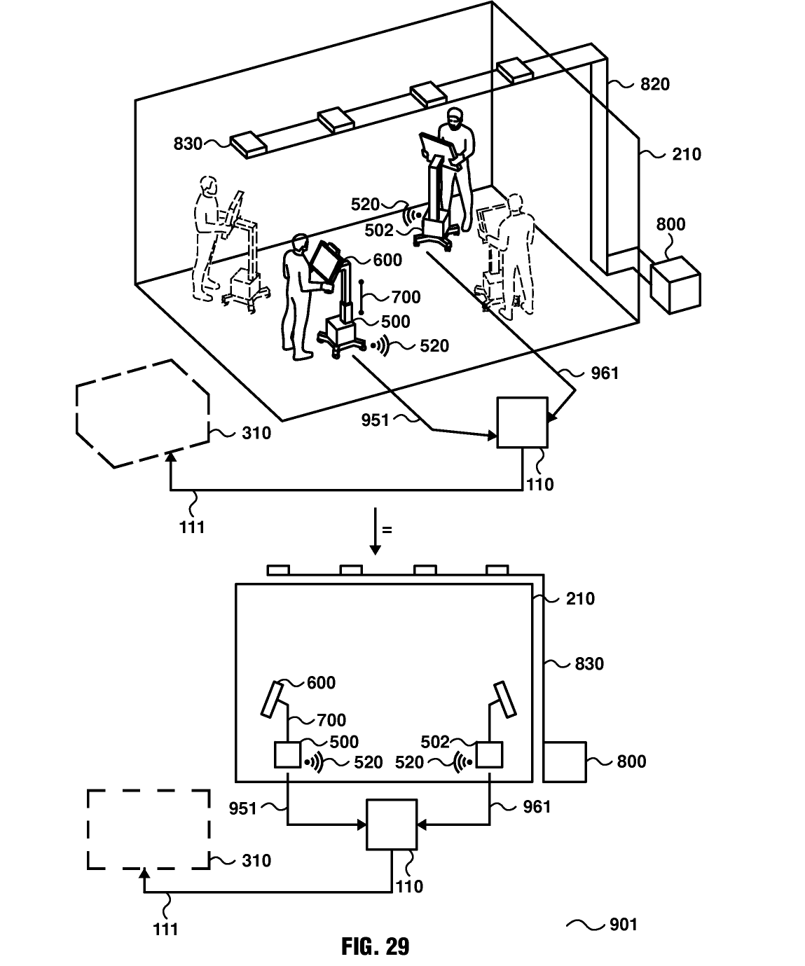

First, an operation of accessing 901 a multi-user virtual reality session 110 is performed by the computing device 500. FIG. 29 shows an exemplary schematic diagram illustrating one operation of the method 900, the operation of accessing 901 a multi-user virtual reality session 110, according to one embodiment of the present invention. The virtual reality session 110 is a software process performing the function of managing 111 a shared virtual space 310. It therefore allows multiple users to share a virtual space by placing objects in the shared virtual space 310, each of which represent presence of a user in the shared virtual space 310. As part of the system 400, multiple other users are also able to perform the operation of accessing 901 the same virtual reality session 110. This operation 901 can be performed by creating or hosting 961 the virtual reality session 110 by one of the users. Once the virtual reality session 110 is created or hosted, other users are able to perform the operation 901 by joining the session 951. In either case, the operation 901 requires the computing device 500 to be connected to other computing devices using network connections 520. In this exemplary embodiment of the present invention, one computing device 502 hosts 961 a virtual reality session 110 and enables any other computing device of the system 400 to join 951 the virtual reality session 110 using the network connections 520. The computing device 500 then joins 951 the virtual reality session 110 using the network connection 520 that connect both computing devices 500, 502. Other computing devices of the system 400 can also join 951 the same virtual reality session 110. Such way, the operation of accessing 901 a multi-user virtual reality session 110 enables multiple users to gain access to a shared virtual space 310, that is managed 111 by the virtual reality session 110. When this operation 901 is performed by the computing device 500, the shared virtual space 310 exists without any spatial relationship to the shared physical space 210, in which the portable interactive device 600 is used to interact with the shared virtual space 310 by a user.

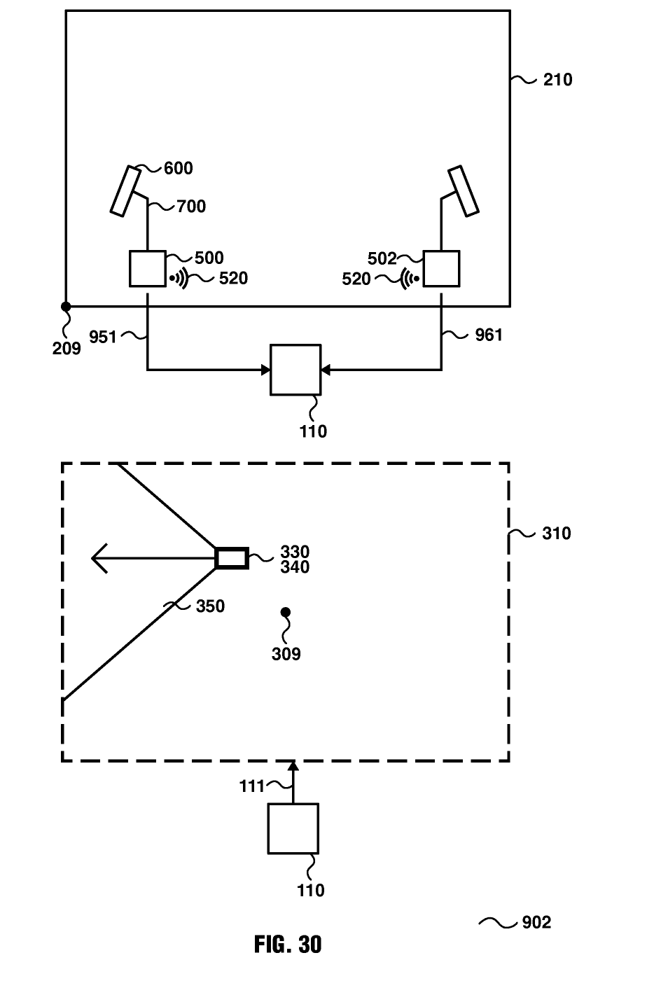

Next, an operation of placing 902 at least one virtual camera object 330 into the shared virtual space 310 is performed by the computing device 500. FIG. 30 shows an exemplary schematic diagram illustrating one operation of the method 900, the operation of placing 902 at least one virtual camera object 330 into the shared virtual space 310, according to one embodiment of the present invention. The virtual camera object 330 is a virtual object 320 that comprises at least one virtual camera 340. This virtual camera 340 is primarily characterized by its field of view 350. This field of view 350 defines a section of the shared virtual space 310 that can be made visible to a user, once a view based on the field of view 350 of the virtual camera 340 of the virtual camera object 330 is generated and displayed by the portable interactive device 600. During this operation 902, the shared physical space 210 is still unconnected spatially to the shared virtual space 310. Both spaces have an origin 209, 309 of their own coordinate systems, which are completely independent of each other. The origins 209, 309 are used throughout operations of the method 900 to determine positions of objects, physical or virtual, in their respective spaces. Positions of physical objects such as the tracker 620 of the portable interactive device 600 are calculated relative to the origin 209 of the shared physical space 210. The origin 209 of the shared physical space 210 can be any point in the shared physical space 210, which has been selected as the origin of the coordinate system of the shared physical space 210 and has been stored by the tracking server 800. Positions of virtual objects 320 such as the virtual camera object 330 are calculated from the origin 309 of the shared virtual space 310. The origin of the shared virtual space 310 is simply the origin of the coordinate system of the shared virtual space 310.

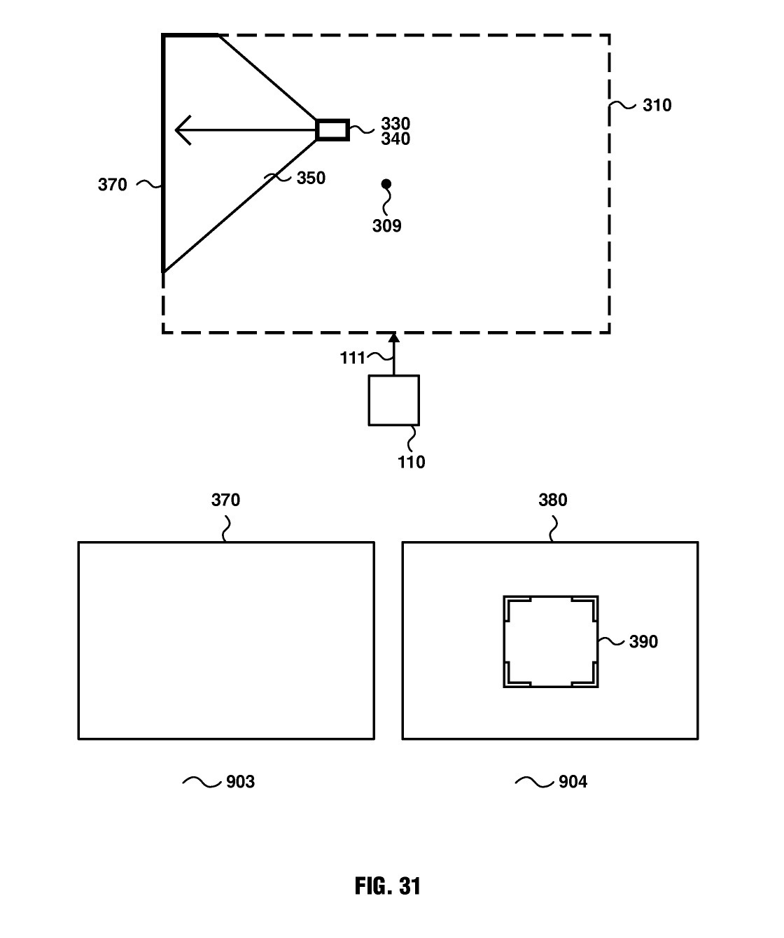

Next, an operation of generating 903 a view 370 of the shared virtual space 310 is performed by the computing device 500. FIG. 31 shows an exemplary schematic diagram illustrating two operations of the method 900, and one of the operations is the operation of generating 903 a view 370 of the shared virtual space 310, according to one embodiment of the present invention. The view 370 of the shared virtual space 310 is defined by the field of view 350 of the virtual camera 340 of the virtual camera object 330. The view 370 is a two-dimensional image, or a set of two-dimensional images, that can be displayed by a display 652 suitable for displaying two-dimensional images of the portable interactive device 600. The view 370 can be of any size in pixels in any of its dimensions.

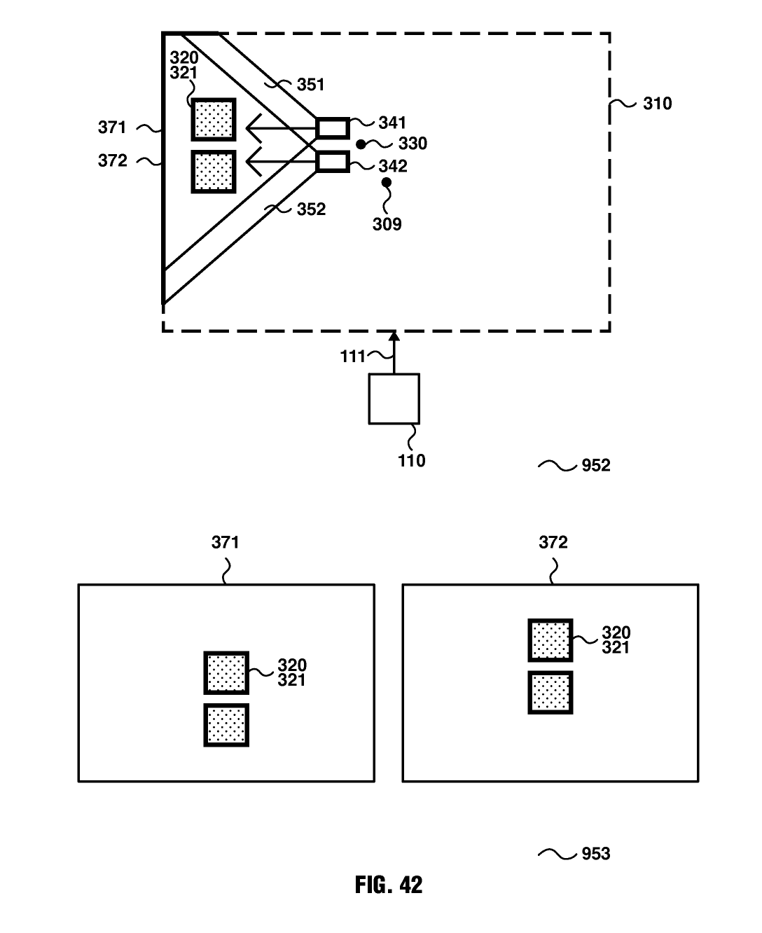

The operation of placing 902 at least one virtual camera object 330 into the shared virtual space 310 can include placing multiple virtual cameras 330 into the shared virtual space 310. The operation of generating 903 a view 370 of the shared virtual space 310 can include generating multiple views 371, 372 of the shared virtual space 310. FIG. 42 shows an exemplary schematic diagram illustrating such optional operations of the method 900, the operation of placing 952 multiple virtual cameras 341, 342 as hierarchy children of the virtual camera object 330 and the operation of generating 953 multiple views 371, 372 of the shared virtual space 310, according to one embodiment of the present invention. The virtual cameras 341, 342 are placed into the shared virtual space 310 as hierarchy children of the virtual camera object 330, which inherit its changes in position and rotation. This means, that any spatial transformation of the virtual camera object 330 also affects the virtual cameras 341, 342, but in such way, that their position and rotation in relation to their hierarchy parent, the virtual camera object 330, do not change. The virtual cameras 341, 342 can be variously positioned in the shared virtual space 310 in relation to the virtual camera object 330. Mostly, the purpose of such placement of multiple virtual cameras 341, 342 that do not change their positions in relation to their hierarchy parent, the virtual camera object 330, is to allow generation of stereoscopic views 371, 372 that can be displayed on such display 652 of a portable interactive device 600 that is capable of displaying stereoscopic two-dimensional images, such as a 3D display. The multiple views 371, 372 of the shared virtual space 310 incorporate any virtual objects 320, 321 that are present in the fields of view 351, 352 of the virtual cameras 341, 342. Each view 371, 372 is defined by the field of view 351, 352 of a different virtual camera 341, 342 of the virtual camera object 330.

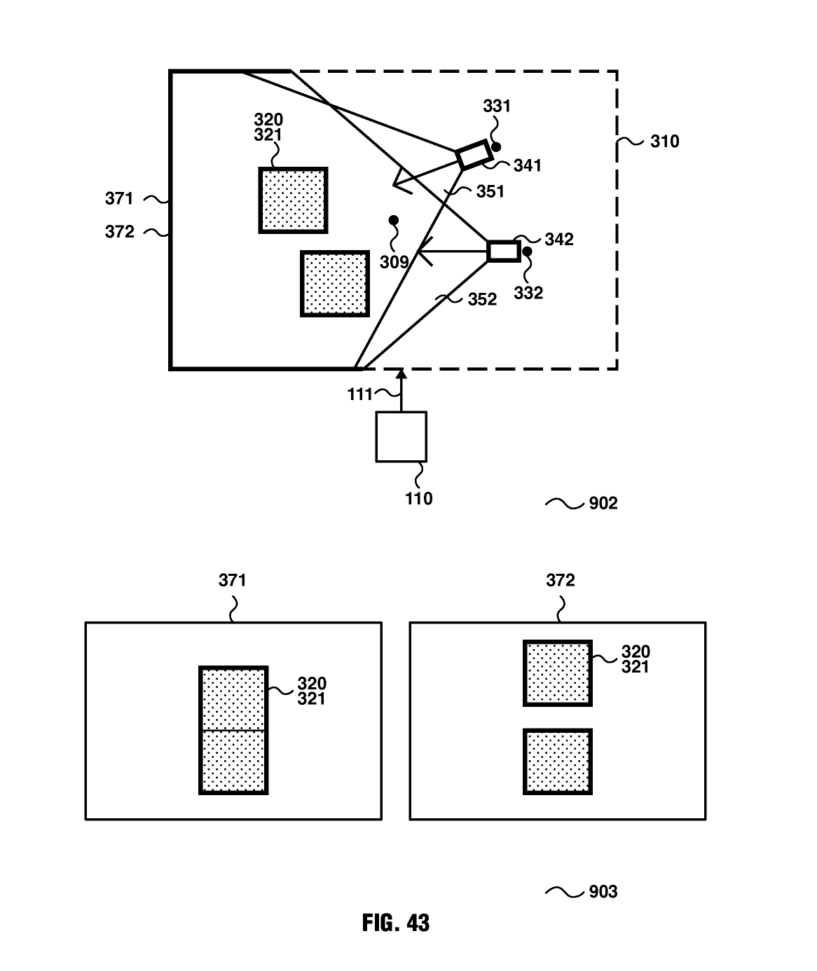

The operation of placing 902 at least one virtual camera object 330 into the shared virtual space 310 can include placing multiple virtual camera objects 330 into the shared virtual space 310. FIG. 43 shows an exemplary schematic diagram illustrating two operations of the method 900, the operation of placing 902 at least one virtual camera object 330 into the shared virtual space 310, and the operation of generating 903 a view 370 of the shared virtual space 310, wherein multiple virtual camera objects 331, 332 are placed and multiple views 371, 372 are generated, according to one embodiment of the present invention. The virtual camera objects 331, 332 are placed into the shared virtual space 310 independently, and spatial transformations of one virtual camera object 331 do not affect the other virtual camera object 332 in any way and vice versa. This is particularly useful, when a user operates a portable interactive device 600 that in addition to one display 652 comprises a complementary display module 660 with another display 662, which can move around the shared physical space 210 independently from the main display 652. Each virtual camera object 331, 332 comprises one virtual camera 341, 342, but can be configured to comprise one or more virtual cameras 340. Each virtual camera 341, 342 has its own corresponding field of view 351, 352. The views 371, 372 are generated basing on these two independent fields of view 351, 352 of the virtual cameras 341, 342 of the virtual camera objects 331, 332, with each view 371, 372 being based on a field of view 351, 352 of a different virtual camera 341, 342. This way, two completely independent views 371, 372 can be generated that can be displayed by two displays 652, 662 suitable for displaying two-dimensional images of the portable interactive device 600.

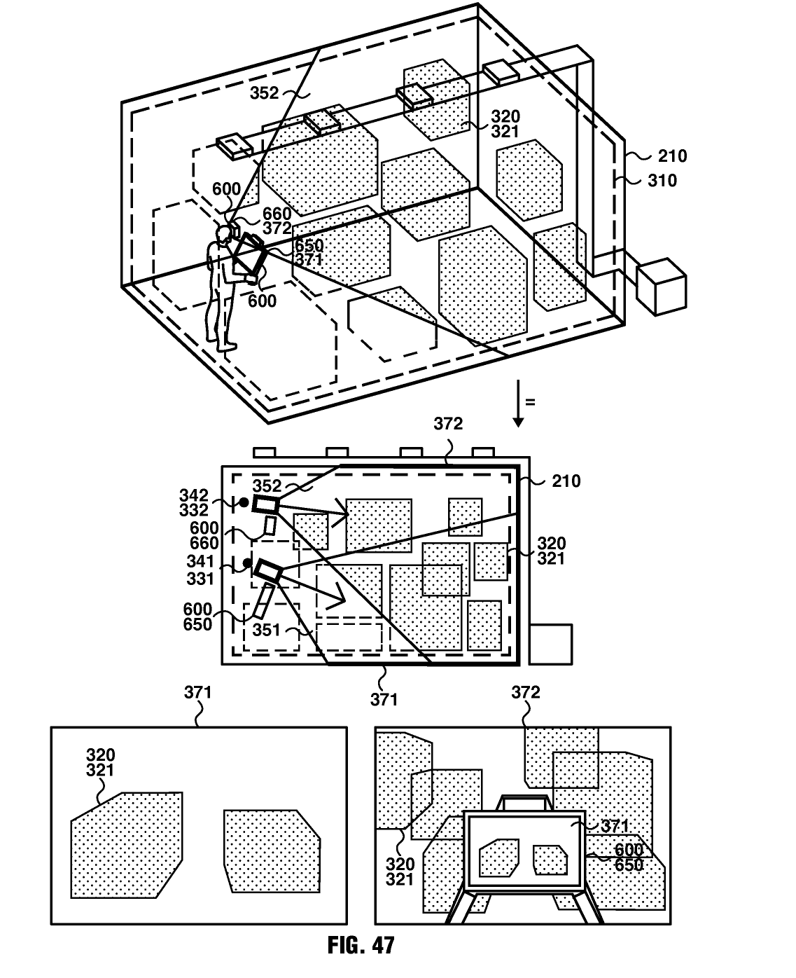

FIG. 47 shows an exemplary schematic diagram illustrating usage of a complementary display module 660 of a portable interactive device with a tracker 600 to generate a secondary view 372 of a shared virtual space 310, according to one embodiment of the present invention. The portable interactive device 600 comprises a head-mounted complementary display module 660, which is configured to display a semi-transparent view 372 of the shared virtual space 310. The complementary display module 660 is also configured to allow other physical objects present in the shared physical space 210, such as the portable interactive device 600 and the main view 371 displayed on the display 652 of the display device module 650 of the portable interactive device 600, to be completely visible. Both the display device module 650 and the complementary display module 660 comprise a display 652, 662 suitable for displaying two-dimensional images. When such complementary display module 660 is utilized, the view 371 of the shared virtual space 310, that is displayed using the display 652 of the display device module 650 of the portable interactive device 600, is complemented by another secondary view 372 that is displayed using the display 662 of the complementary display module 660 of the portable interactive device 600. Such two views 371, 372 can be provided when the operation of placing 902 at least one virtual camera object 330 into the shared virtual space 310 is performed by placing multiple virtual camera objects 331, 332 into the shared virtual space 310. Such two views 371, 372 can be provided also only when the operation of generating 903 a view 370 of the shared virtual space 310 is performed by generating multiple views 371, 372. Such way of performing the two operations 902, 903 has been described in the previous paragraph.

The result of generating the two independent views 371, 372 and their displaying using the two independent displays 652, 662 of the display device module 650 and the complementary display module 660 is that the main view 371 of the shared virtual space 310 is expanded by a secondary view 372. The manually positioned portable interactive device 600 is crucial for performing the interation with detailed virtual objects 320 of the shared virtual space 310 that is superimposed on the shared physical space 210, but usage of the complementary display device 660 that provides the expanded view 372 allows to preserve the advantages of the various embodiments of the present invention and configures the portable interactive device 600 to exhibit an advantage of expanding the field of view of a user in which the shared virtual space 310 is visible. This is useful for providing a secondary view 372, which is not utilizable to perform an interaction with detailed virtual objects 320, but which allows for a greater intuitiveness of interaction with detailed virtual objects 320 using the portable interactive device 600 as an overview of a greater part of the shared virtual space 310 is being displayed to a user as he is looking through the head-mounted complementary display module 660. Such view 372 creates an appearance to the user, of being surrounded by the virtual space 310, while also being able to effortlessly control a main view 371 that can reveal smaller parts of the detailed virtual objects 320 with manual movement of the portable interactive device 600.

Next, an operation of generating 904 a graphical user interface overlay 380 is performed by the computing device 500. FIG. 31 shows an exemplary schematic diagram illustrating two operations of the method 900, and one of the operations is the operation of generating 904 a graphical user interface overlay 380, according to one embodiment of the present invention. The graphical user interface overlay 380 is an image or a set of images that comprises one or more graphical objects that collectively constitute a graphical user interface. This graphical user interface overlay 380 is displayed overlaying the view 370 of the shared virtual space 310 by the portable interactive device 600 and is used to display any graphical object or text, that can provide complementary information to a user interacting with a shared virtual space 310, additionally to the displayed virtual objects 320, that are displayed as part of the shared virtual space 310. Most importantly, the graphical user interface overlay 380 comprises a graphical object in the form of a virtual cursor 390. The virtual cursor 390 is used to encompass points in the shared virtual space 310. The points in the shared virtual space 310 are encompassed, when the virtual cursor 390 of the graphical user interface overlay 380 is displayed overlaying the projection of the points in the view 370 of the shared virtual space 310. This can happen, when the graphical user interface overlay 380 is displayed overlaying the view 370 of the shared virtual space 310 by the portable interactive device 600. The virtual cursor 390 can be a two-dimensional or a three-dimensional graphical object, a vector graphics object or a pixel graphics object, a text object, or any combination of these objects, when such objects can be displayed by a display 652 suitable for displaying two-dimensional images of the portable interactive device 600. The virtual cursor 390 or its bounding rectangle can be of any size in pixels in any of its dimensions.

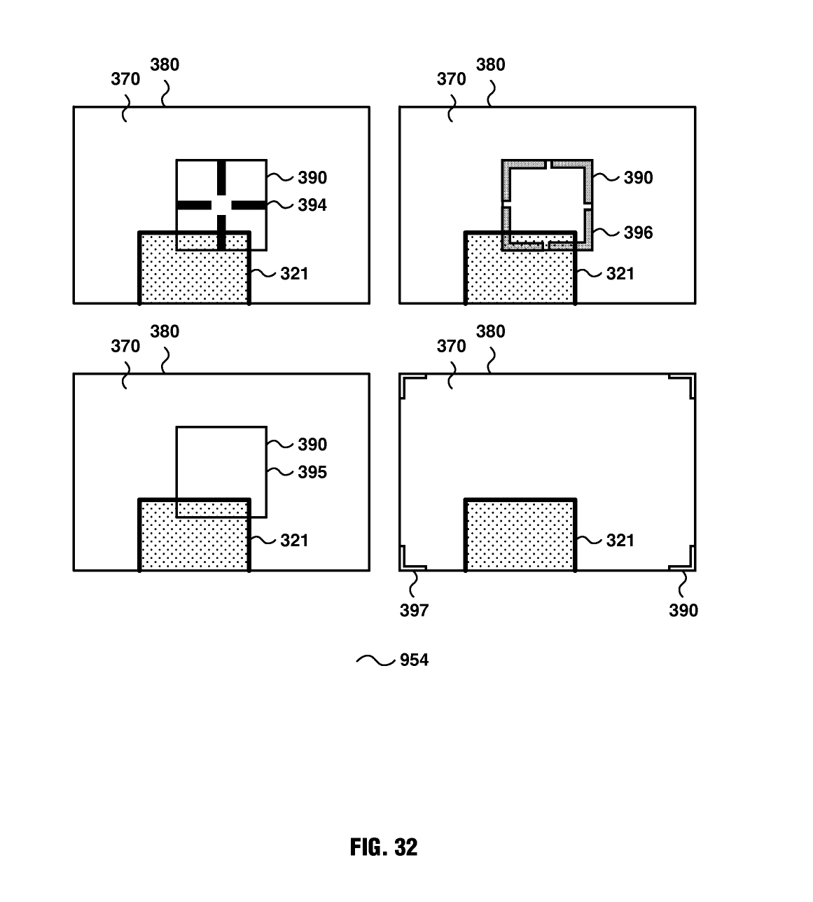

The operation of generating 904 a graphical user interface overlay 380 can include applying a configuration to the virtual cursor. FIG. 32 shows an exemplary schematic diagram illustrating such optional operation of the method 900, the operation of applying 954 a configuration to the virtual cursor 390, according to one embodiment of the present invention. Various configurations of the virtual cursor 390 can be applied during the operation 954. One of the configurations applied to the virtual cursor 390 can be a configuration that sets the virtual cursor 390 to be opaque 394. A virtual cursor 390 configured such way comprises graphical objects that are opaque 394 and parts of virtual objects 321 that appear in the view 370 of the shared virtual space 310 overlaid by the virtual cursor 390 of the graphical user interface overlay 380 are not visible, when displayed by the portable interactive device 600. Another configuration applied to the virtual cursor 390 can be a configuration that sets the virtual cursor 390 to be transparent 395. A virtual cursor 390 configured such way comprises graphical objects that are transparent 395 and parts of virtual objects 321 that appear in the view 370 of the shared virtual space 310 overlaid by the virtual cursor 390 of the graphical user interface overlay 380 are completely visible, when displayed by the portable interactive device 600. Another configuration applied to the virtual cursor 390 can be a configuration that sets the virtual cursor 390 to be semi-transparent 396. A virtual cursor 390 configured such way comprises graphical objects that are semi-transparent 396 and parts of virtual objects 321 that appear in the view 370 of the shared virtual space 310 overlaid by the virtual cursor 390 of the graphical user interface overlay 380 are partially visible, when displayed by the portable interactive device 600. Another configuration applied to the virtual cursor 390 can be a configuration that sets the virtual cursor 390 to occupy a rectangle of such size in pixels, so that it is equivalent in size 397 to the size of the display 652 of the portable interactive device 600 that is used to display the graphical user interface overlay 397. A virtual cursor 390 configured such way comprises graphical objects that their bounding rectangle is of such size, that the entire graphical user interface overlay 380 functions as a virtual cursor 390. This can be useful for enabling users to interact with virtual objects without requiring them to precisely move the portable interactive device, so that the virtual objects 321 that are comprised in the view 370 of the shared virtual space 310 appear overlaid by the virtual cursor 390, since they are constantly overlaid by the virtual cursor 390. Another configuration applied to the virtual cursor 390 can be a configuration that sets the virtual cursor 390 to not change its position 398 within the graphical user interface overlay 380. A virtual cursor 390 configured such way comprises graphical objects that can be animated, but their bounding rectangle is not changing its position 398 and remains static within the graphical user interface overlay 380.

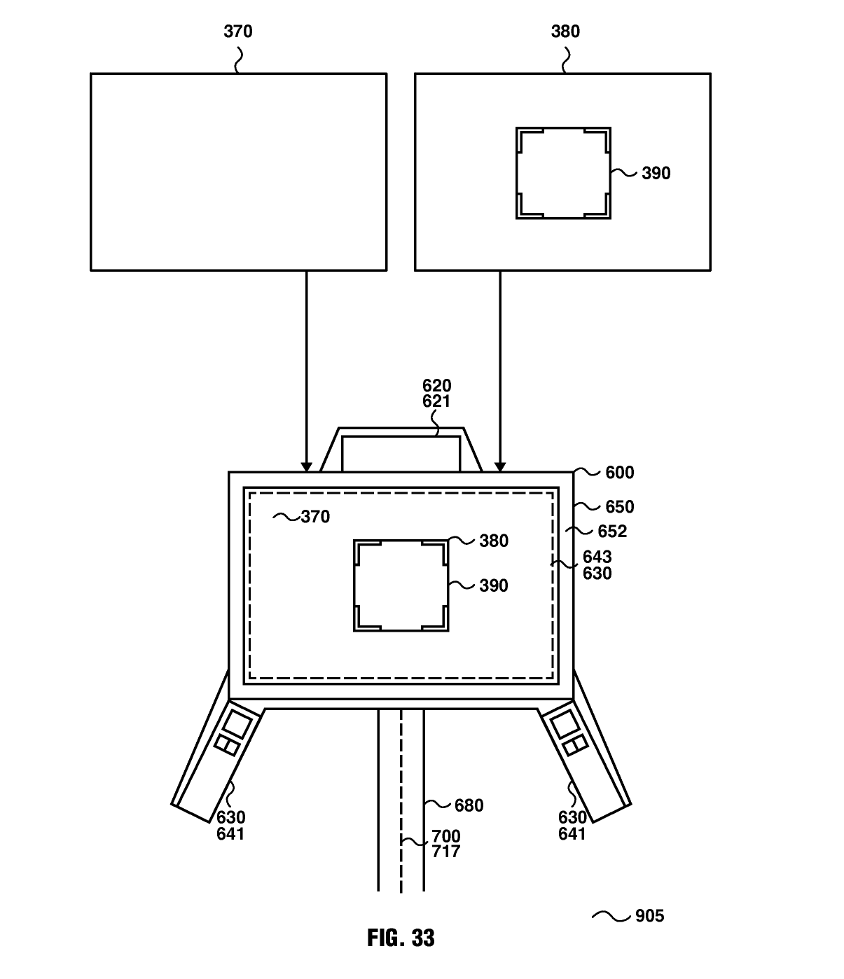

Next, an operation of transmitting 905 the view 370 of the shared virtual space 310 and the graphical user interface overlay 380 to the portable interactive device 600 is performed by the computing device 500. FIG. 33 shows an exemplary schematic diagram illustrating one operation of the method 900, the operation of transmitting 905 the view 370 of the shared virtual space 310 and the graphical user interface overlay 380 to the portable interactive device 600, according to one embodiment of the present invention. Both the view 370 and the graphical user interface overlay 380 are transmitted 905 in order to be displayed by the display 652 of the display device module 650 of the portable interactive device 600, which is connected to the computing device 500 used to perform operations of the method 900. Both the view 370 and the graphical user interface overlay 380 are displayed by the portable interactive device 600 at the same time, with the graphical user interface overlay 380 overlaying the view 370 of the shared virtual space 310. The virtual cursor 390 is displayed as part of the graphical user interface overlay 380. Both the view 370 and the graphical user interface overlay 380 are transmitted 905 to the portable interactive device 600 using a connection 700 between the portable interactive device 600 and the computing device 500. Both the view 370 and the graphical user interface overlay 380 can be transmitted 905 to the portable interactive device 600 to be displayed in the form of one composite two-dimensional image or a set of composite two-dimensional images, or in the form of one video signal.

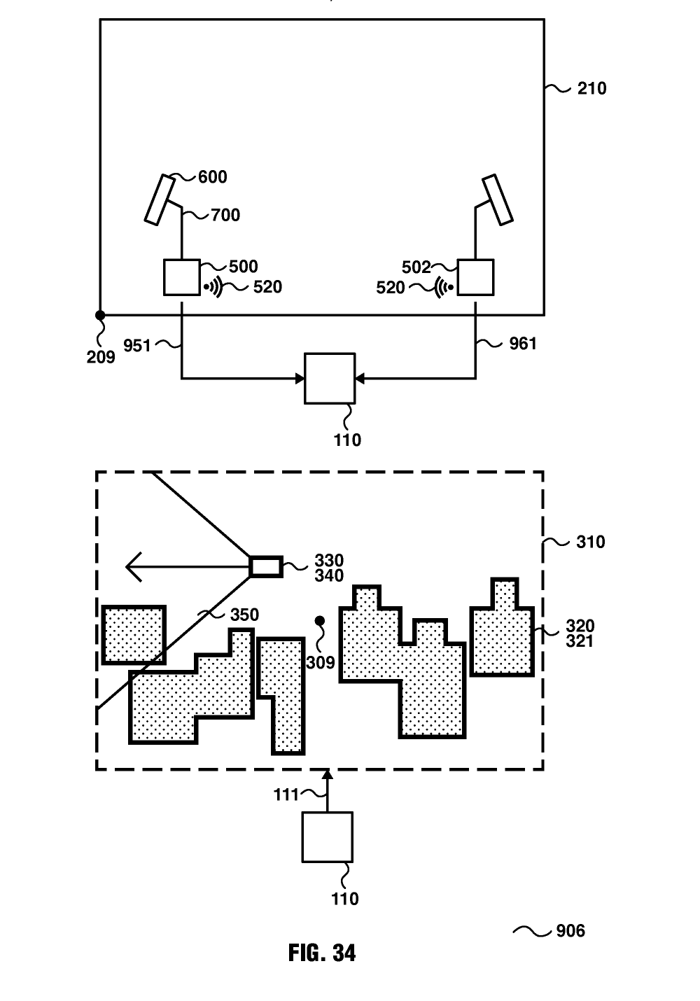

Next, an operation of populating 906 the shared virtual space 310 with at least one virtual object 320 is performed by the computing device 500. FIG. 34 shows an exemplary schematic diagram illustrating one operation of the method 900, the operation of populating 906 the shared virtual space 310 with at least one detailed virtual object 320, according to one embodiment of the present invention. Virtual objects 320 can be any virtual three-dimensional objects that can be placed anywhere in the shared virtual space 310. Virtual objects 320 are placed first by a computing device 502 that has hosted 961 the virtual reality session 110, which is managing 111 the shared virtual space 310. Virtual objects 320 are placed basing on a stored virtual space configuration data, which describes how the shared virtual space 310 should be populated with virtual objects 320, and how the virtual objects 320 should be configured. The virtual reality session 110 which is managing 111 the shared virtual space 310 enables other computing devices that have joined 951 the virtual reality session 110, such as the computing device 500 used to perform operations of the method 900, to acquire the virtual space configuration data during this operation 906. Then, using the virtual space configuration data the virtual objects 320 are placed into the shared virtual space 310 also by the computing device 500. During multi-user interaction with the shared virtual space 310 many more data is shared between the computing devices 500, 502 using the multi-user virtual reality session 110, including configuration of virtual objects 310 and their positioning information. This way the shared virtual space 310 is populated 906 with virtual objects 320 for all users identically.

Such virtual objects 320 can be any virtual three-dimensional object constructed out of points, vertices, edges, triangles, polygons, faces, surfaces, curves, volumes, point clouds, pixels, voxels or other structural components. Also, virtual objects 320 can comprise additional virtual components, which allow the virtual objects 320 to serve additional purposes than only being rendered, such as being included in physics simulations. Structural components of virtual objects 320 are used when a view 370 is being generated, to calculate projection of virtual objects 320 onto one or more two-dimensional planes, that form the view 370 of the shared virtual space 310 that is being displayed by the portable interactive device 600. Most important structural components, which are also geometric features, are points. Points define all other structural components. Points are primarily characterized by their position in the shared virtual space 310, but may also be defined by other values and properties, such as color. The overall spatial form of virtual objects 320 is defined by such geometric features or points.

As was previously noted, various embodiments of the present invention are particularly advantageous, when utilized to enable interaction with detailed 321 virtual objects 320, which are generally known to be difficult to navigate using conventional techniques. It was concluded earlier, that although the various embodiments of the present invention are capable of enabling interaction with simple virtual objects, they are best suited for enabling multi-user interaction with detailed 321 virtual objects 320 of a shared virtual space 310 superimposed for all users identically on a shared physical space 210. Throughout this detailed description, all virtual objects 320 can be regarded as detailed 321 virtual objects 320. It is therefore important to describe, what is the difference between a simple virtual object 320 and a detailed 321 virtual object 320.

Virtual objects 320 can be constructed out of points 327 which define the three-dimensional geometry and the overall spatial form 328 of the virtual objects 320. These structural components of virtual objects 320, the points 327, are therefore the primary geometric features 326 of the virtual objects 320. The shared virtual space 310, in which the virtual objects 320 are present, can be superimposed on the shared physical space 210 by performing operations of the method 900 by the computing device 500. When such interrelatedness of the two spaces exists, it can be stated, that one volume unit of one space corresponds to another volume unit of the other space. Therefore, one virtual space volume unit 324 can correspond to and be superimposed on one physical space volume unit. While the physical space volume unit can be any existing measurement unit that can quantify a volume of physical space, the virtual space volume unit 324 is only a conceptual measurement unit that can be selected to be of any size in the shared virtual space 310. Only when the shared virtual space 310 is superimposed on the shared physical space 210 can the virtual space volume unit 324 correspond to any physical unit. Under such conditions, the difference between a simple virtual object 320 and a detailed 321 virtual object 320 can be measured in density 323 of geometric features 326 of the virtual objects 320, the points 327, per one virtual space volume unit 324 that corresponds precisely to a physical volume unit.

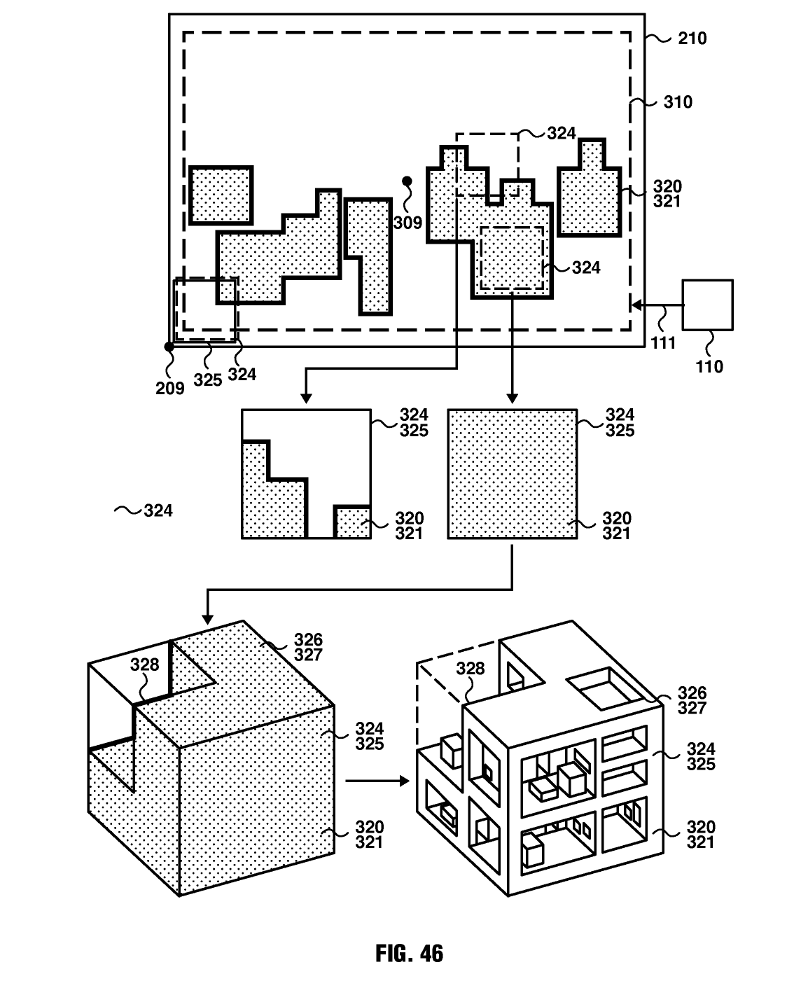

FIG. 46 shows an exemplary schematic diagram illustrating measurement of density 323 of geometric features 326 of virtual objects 320 per one virtual space volume unit 324, wherein the virtual space volume unit 324 is a conceptual measurement unit being superimposed on and effectively corresponding to one cubic foot 325 of physical space, according to one embodiment of the present invention. Each detailed 321 virtual object 320 that is placed into and occupies the shared virtual space 310 is a virtual object 320 that has a density 323 of geometric features 326, the points 327, per one virtual space volume unit 324 substantially higher than 10000. The density 323 of a virtual object 320 can be determined by measuring the quantity of points 327 in such one virtual space volume unit 324 that is superimposed on and effectively corresponds to one cubic foot 325 of physical space. Such portion of the shared virtual space 310 is selected for the purpose of performing the measurement of density 323, which is of the size of one virtual space volume unit 324 that corresponds to one cubic foot 325 of physical space, and that is fully occupied by virtual objects 320. The virtual objects 320 that fully occupy the one virtual space volume unit 324 can comprise parts that form empty spaces, such as rooms.

The measurement of density 323 can be performed by only calculating quantity of points 327 for such volume of the shared virtual space 310 that is fully enclosed by virtual objects 320, or for such volume of the shared virtual space 310 that includes the empty spaces formed by some parts of some virtual objects 320. The points 326 constitute the geometric features 327 of virtual objects 320, which define the spatial form 328 of the virtual objects 320. Virtual objects 320 that are measured and density 323 of points 326 of which per one virtual space volume unit 324 that is superimposed on and corresponds to one cubic foot 325 of physical space is substantially higher than 10000, can be regarded as detailed 321 virtual objects 320. Such detailed 321 virtual objects 320 can for example be virtual representations of buildings, buildings with interior spaces, buildings with interior spaces and furniture, whole cities, cities with surrounding terrain and trees, landscapes with fauna and flora, human bodies, human body section cuts, machines, machine section cuts, fictive or real environments, planets or other cosmic objects. Such examples of detailed 321 virtual objects 320 can contain so much detail that viewing them with conventional techniques would be very difficult or impossible. By viewing them using manually positioned portable interactive devices 600 that are tracked in the shared physical space 210, viewing and interacting with such detailed 321 virtual objects 320 of the shared virtual space 310 superimposed on a shared physical space 210 is possible. By placing such virtual objects 320 into the shared virtual space 310, the operation of populating 906 the shared virtual space 310 with detailed 321 virtual objects 320 is performed by the computing device 500.

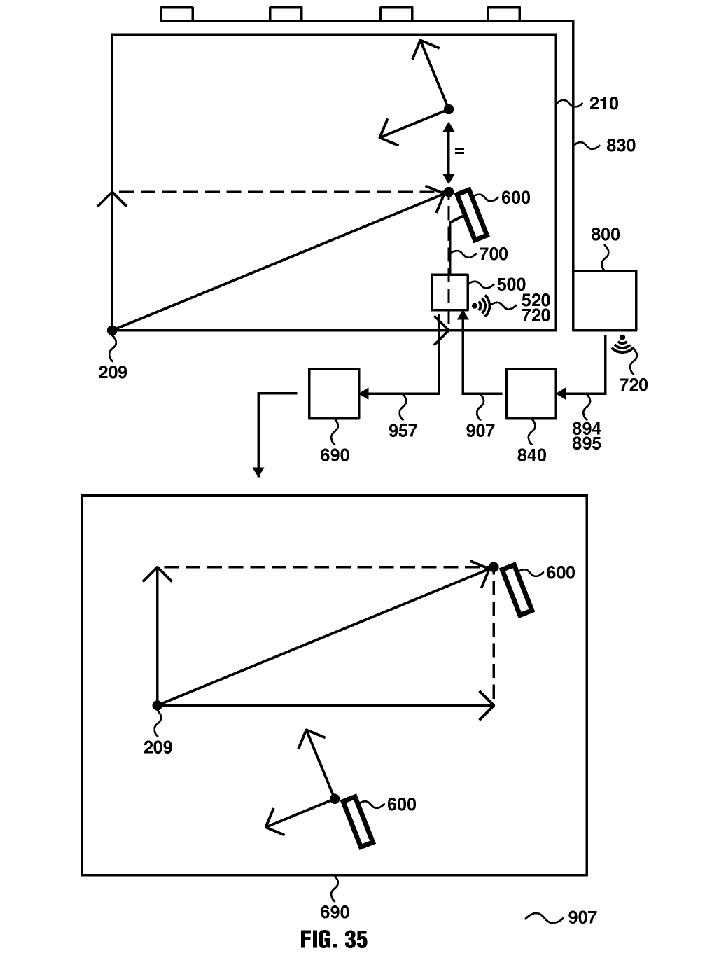

Next, an operation of acquiring 907 tracking data 840 from the tracking server 800 is performed by the computing device 500. FIG. 35 shows an exemplary schematic diagram illustrating one operation of the method 900, the operation of acquiring 907 tracking data 840 from a tracking server 800, according to one embodiment of the present invention. The tracking server 800, which is tracking the position and rotation of the portable interactive device 600 in the shared physical space 210, independently of the computing device 500, performs operations for enabling the computing device 500 to acquire tracking data 840. The tracking server 800 is running 894 a network server sharing 895 the tracking data 840 with other computing devices, including the computing device 500 used to perform operations of the method 900. The computing device 500 therefore performs the operation of acquiring 907 tracking data 840 from the tracking server 800 using a connection 720 between the computing device 500 and the tracking server 800. The connection 720 is a wireless local area network connection 725, but can be also implemented as a different kind of network connection. The acquired tracking data 840 is used to determine 957 the position and rotation 690 of the portable interactive device 600 in the shared physical space 210 by the computing device 500. The determined position and rotation 690 is relative to the origin 209 of the coordinate system of the shared physical space 210.

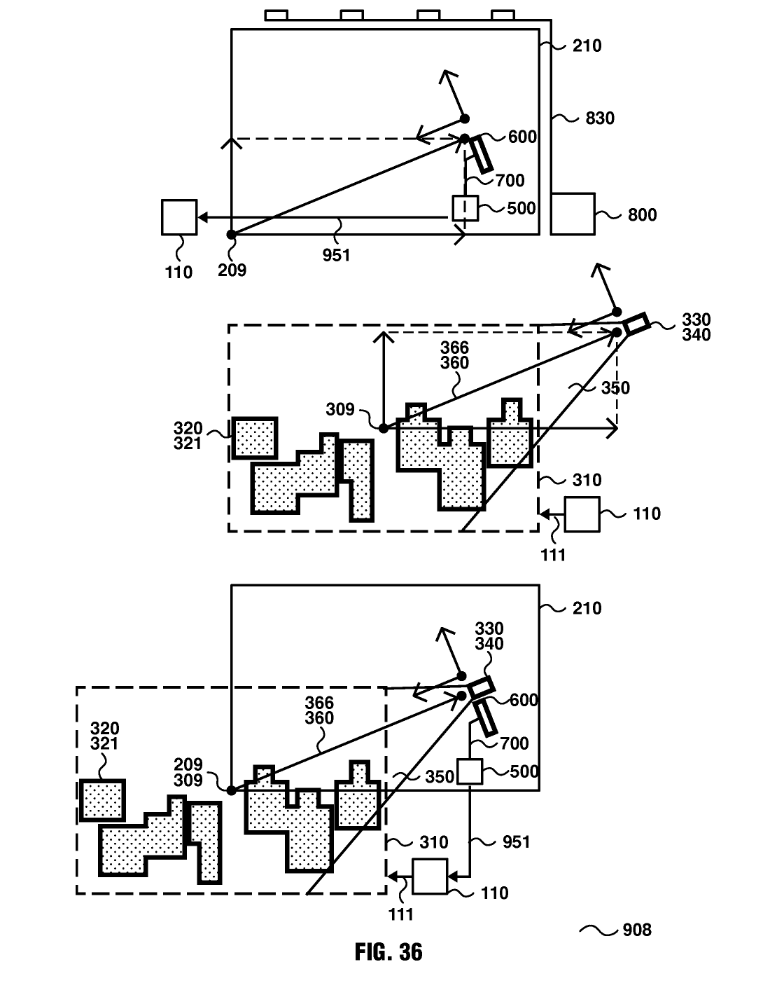

Next, an operation of applying 908 transformation 360 to each included virtual camera object 330 in the shared virtual space 310 is performed by the computing device 500. FIG. 36 shows an exemplary schematic diagram illustrating one operation of the method 900, the operation of applying 908 transformation 360 to the at least one virtual camera object 330, according to one embodiment of the present invention. The shared physical space 210, in which the portable interactive device 600 is manually positioned, exists without any spatial relationship to the shared virtual space 310. During this operation 908, transformation 360 that is based on the acquired tracking data 840 and a superimposing transformation 361 is applied to the virtual camera object 330. When more virtual camera objects 330 exist in the shared virtual space 310 that have been placed by the computing device 500, the operation 908 can include applying a transformation 360 to multiple virtual camera objects. The superimposing transformation 361 is a transformation, that causes the shared virtual space 310 to appear superimposed on the shared physical space 210 when the shared virtual space 310 is viewed on the portable interactive device 600 by a user. When the operation 908 is performed for the first time after the multi-user virtual reality session 110 is accessed 901, the superimposing transformation 361 is a vector with a value of zero, as it is not yet set. Such transformation 360 is a specific transformation 366 that is affected only by the tracking data 840.

When this operation 908 is performed, the virtual camera object 330 is positioned in the shared virtual space 310 by being directly affected by the position and rotation 690 of the portable interactive device 600 in the shared physical space 210. Therefore, a relationship is created between the shared physical space 210 and the shared virtual space 310 that can be perceived when the shared virtual space 310 is viewed on the portable interactive device 600. The positioning of the virtual camera object 330 is performed, by applying the same values that describe the position and rotation 690 of the portable interactive device 600 and that are stored in the acquired tracking data 840, directly to the position and rotation of the virtual camera object 330. Since the specific transformation 360, a base transformation 366, which is only affected by the position and rotation 690 of the portable interactive device 600, is applied to the virtual camera object 330 without being modified in any way, the relationship between the two spaces is uncontrolled. The shared virtual space 310 and virtual objects 320, 321 that it comprises, can for example appear to be too small, too large, misaligned, incorrectly rotated, or only partially superimposed on the shared physical space 210 after application of such transformation 360,366 to the virtual camera object 330. The misalignment of the two spaces, that results from applying the transformation 360 for the first time after accessing 901 the multi-user virtual reality session 110 in the form of the specific transformation 366, which is only affected by the position and rotation 690 of the portable interactive device 600, is solved once the superimposing transformation 361 is set at least once during the following operation.

This operation 908 can be repeated once every unit of time that is as short as the time required to generate and display a single view 370 of the shared virtual space 310. Such frequency can ensure that the movement of the virtual camera object 330 within the shared virtual space 310 is as fluid as movement of the portable interactive device 600 within the shared physical space 210. If more smoothness is required that cannot be achieved by a user when he is manually positioning the portable interactive device 600 in the shared physical space 210, smoothing can be applied 958 to transformation 360, which modifies the values of the transformation 360 applied to the virtual camera object 330, such as positions and rotations, so that the values change over time more smoothly. It can be understood that since the movement of the portable interactive device 600 within the shared physical space 210 directly influences the movement of the virtual camera object 330 within the shared virtual space 310, this operation 908 allows control 968 of the view 370 of the shared virtual space 310 with manual movement of the portable interactive device 600 within the shared physical space 210. Also, when the view 370 is changed with such manual movement of the portable interactive device 600, the points of the shared virtual space 310 that are encompassed 391 by the virtual cursor 390 of the graphical user interface overlay 380 that is overlaying the view 370 change as well. This allows users to interact with certain parts of detailed 321 virtual objects 320 by precisely targeting the parts with the manual movement of the portable interactive device 600 in the shared physical space 210.

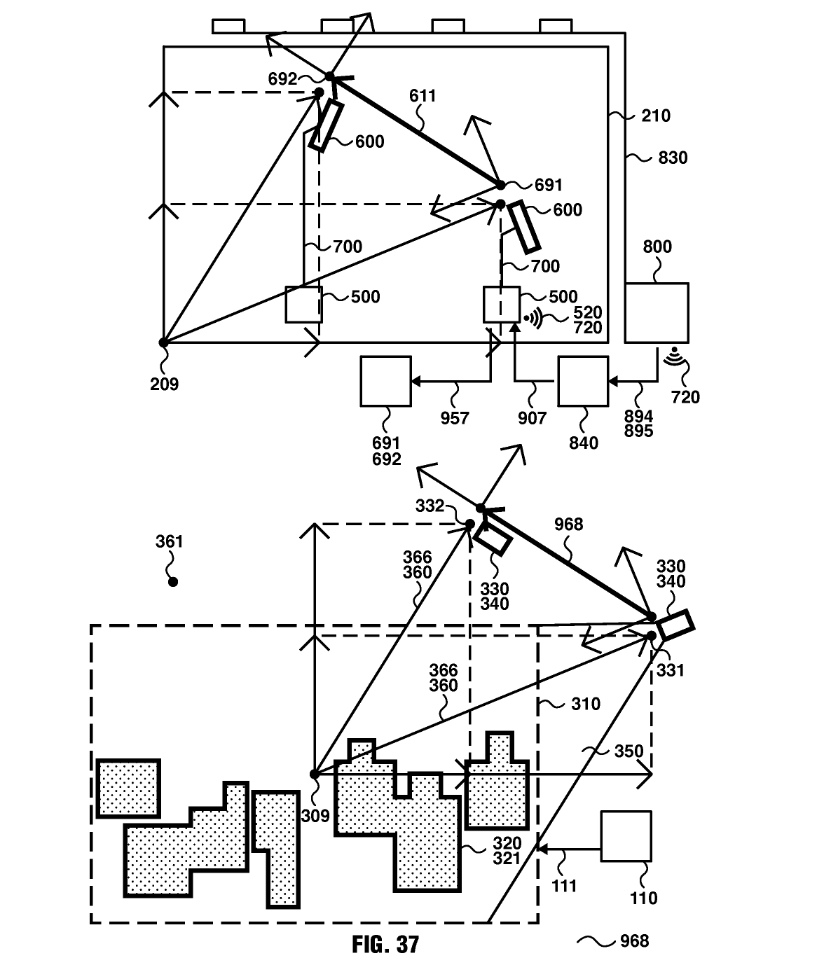

FIG. 37 shows an exemplary schematic diagram illustrating how allowing control 968 of the view 370 of the shared virtual space 310 and the points encompassed by the virtual cursor 390 can be performed during the applying 908 transformation 360 to each included virtual camera object 330 in the shared virtual space 310 operation, according to one embodiment of the present invention. The portable interactive device 600 is positioned and rotated in the shared physical space 210 in the first position and rotation 691. During this operation 908, transformation 360 is applied to the virtual camera object 330 that is located in the shared virtual space 310. The virtual camera object 330 is therefore also positioned and rotated into a first position and rotation 331. The transformation 360 is based on the first position and rotation 691 of the portable interactive device 600 that is determined from the acquired tracking data 840. The transformation 360 is also based on the superimposing transformation 361, which is not yet set and has a zero value, as the operation 908 is performed for the first time after the operation of accessing 901 the multi-user virtual reality session 110 has been performed. Therefore, the superimposing transformation 361 does not yet affect the positioning of the virtual camera object 330 in the shared virtual space 310 and the base transformation applied 360, 366 and the positioning is only affected by the position and rotation 691 of the portable interactive device 600 in the shared physical space 210.

As the a user manually moves 611 and positions and rotates the portable interactive device 600 into a second position and rotation 692, and as the applying 908 transformation 360 operation is performed again, the virtual camera object 330 acquires a second position and rotation 332 as well. In this example, the superimposing transformation 361 remains of a zero value even after it has been set, in order to not cause other changes in the relationship of the portable interactive device 600 and the virtual camera object 330. This way, it is clearly visible, that the manual movement 611 of the portable interactive device 600 in the shared physical space 210 caused an equivalent movement of the virtual camera object 330 within the shared virtual space 310. This way, the operation of applying 908 transformation 360 operation allows control 968 of the view 370 of the shared virtual space 310 and the points encompassed by the virtual cursor 390.

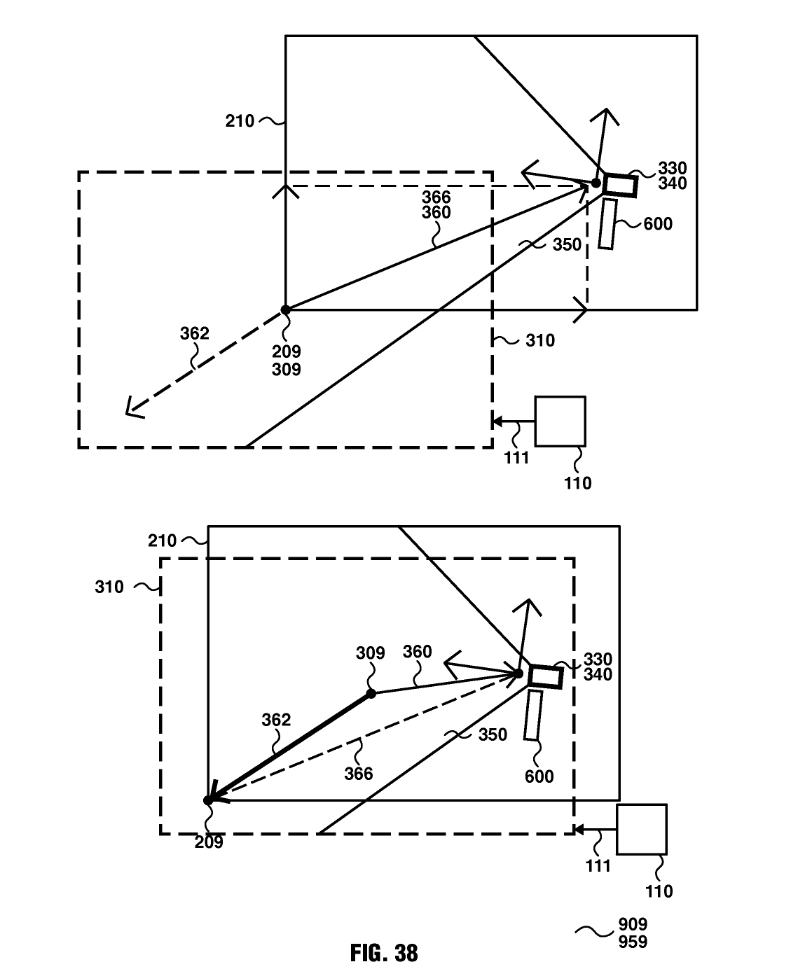

Next, an operation of superimposing 909 the shared virtual space 310 on the shared physical space 210 is performed by the computing device 500. FIGS. 38-40 show exemplary schematic diagrams illustrating one operation of the method 900, the operation of superimposing 909 the shared virtual space 310 on the shared physical space 210, according to one embodiment of the present invention. The operation 909 is performed by setting 959 the superimposing transformation 361, that is being applied to the virtual camera object 330 during the previously described operation of applying 908 transformation 360 to the virtual camera object 330. The superimposing transformation 361 can comprise three separate transformation components, a translation component 362, a rotation component 363 and a scale component 364.

FIG. 38 shows an exemplary schematic diagram illustrating how setting 959 the translation component 362 of the superimposing transformation 361 is performed, during the operation of superimposing 909 the shared virtual space 310 on the shared physical space 210, according to one embodiment of the present invention. The virtual camera object 330 is positioned and rotated in the shared virtual space 310, by the transformation 360, 366 applied to it, which is based on the position and rotation of the portable interactive device 600. A translation component 362 can be a three-dimensional vector. In order for the shared virtual space 310 to appear superimposed on the shared physical space 210, when the shared virtual space 310 is viewed on the portable interactive device 600, the translation component 362 is set and added to the base transformation 366 already applied to the virtual camera object 330. The translation component 362 vector is configured to be of such direction and magnitude, that adding it to the base transformation 366 results in the overall transformation 360 applied to the virtual camera object 330 to cause such positioning of the virtual camera object 330, that the shared virtual space 310 appears to be superimposed on the shared physical space 210. This appearance is perceived when the shared virtual space 310 is viewed on the portable interactive device 600 located in the shared physical space 210. The translation component 362 can be modified by a user, so that it causes a different or a more suitable positioning of the virtual camera object 330. A translation component 362 modified in such way can cause a positioning of the virtual camera object 330, during which the shared virtual space 310 appears to be superimposed on the shared physical space 210 precisely the way it is required by the user. When one user modifies the translation component 362, all users need to start using the modified translation component 362, so that the shared virtual space 310 continues to be superimposed for all users identically on the shared physical space 210. The superimposing transformation 361 with all its components therefore needs to be shared by the computing device 500 with other computing devices.

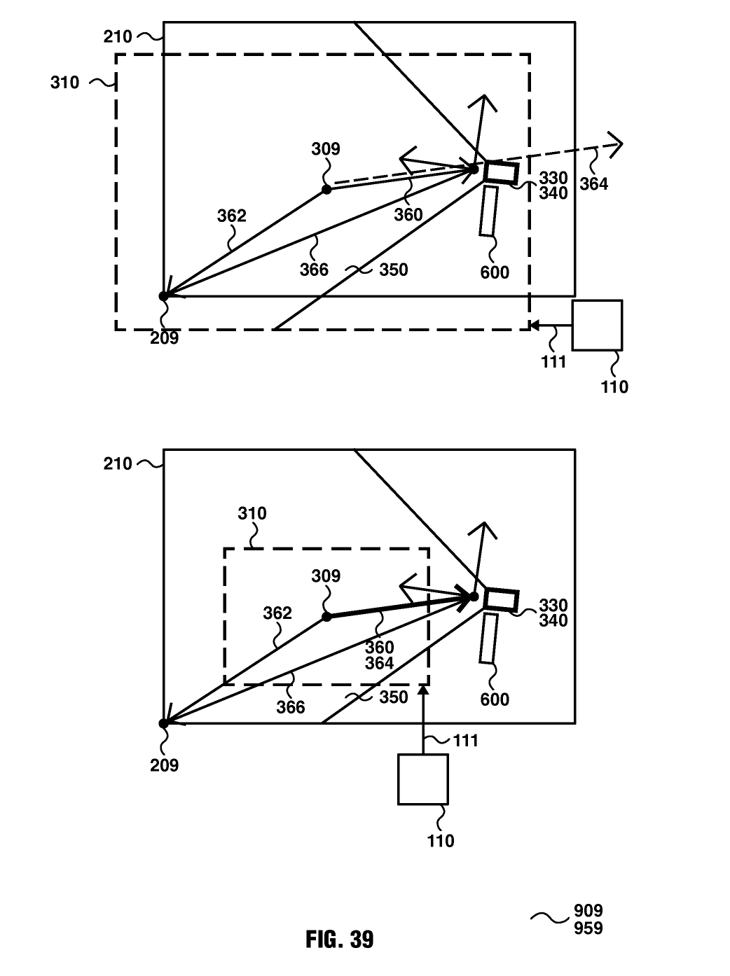

FIG. 39 shows an exemplary schematic diagram illustrating how setting 959 the scale component 364 of the superimposing transformation 361 is performed, during the operation of superimposing 909 the shared virtual space 310 on the shared physical space 210, according to one embodiment of the present invention. The virtual camera object 330 is positioned and rotated in the shared virtual space 310, by the transformation 360 applied to it, which is based on the base transformation 366 and the translation component 362 of the superimposing transformation 361. The shared virtual space 310 already appears to be superimposed on the shared physical space 210 when viewed using a portable interactive device 600. The spatial relationship of the two spaces can be further modified by setting the scale component 364 of the superimposing transformation 361 and applying it to the transformation 360 applied to the virtual camera object 330. The scale component 364 can be a vector, but since only uniform scaling is desired, can be a single numerical value, or a vector with the same direction as the transformation 360 vector.

The scale component 364 is implemented in this example as a vector with the same direction as the transformation 360 applied to the virtual camera object. In order to change the spatial relationship of the shared virtual space 310 and the shared physical space 210 in terms of their relative scale, as it appears when the shared virtual space 310 is viewed using the portable interactive device 600, the magnitude of the scale component 364 needs to be set to be smaller or greater than the magnitude of the transformation 360 vector. The relative scale of the two spaces can be described as the ratio between the size of the bounding volume of the shared physical space 210 and the size of the bounding volume of the shared virtual space 310, as the sizes appear when the shared virtual space 310 is viewed using the portable interactive device 600. The magnitude of the scale component 364 can be set to be smaller than the magnitude of the transformation 360 vector, when it is intended that the overall transformation 360 applied to the virtual camera object 330 causes such positioning of the virtual camera object 330, that the shared virtual space 310 appears to be larger in size than without the scale component applied 364. The magnitude of the scale component 364 can be set to be greater than the magnitude of the transformation 360 vector, when it is intended that the overall transformation 360 applied to the virtual camera object 330 causes such positioning of the virtual camera object 330, that the shared virtual space 310 appears to be smaller in size than without the scale component applied 364. This appearance of size differences is perceived when the shared virtual space 310 is viewed on the portable interactive device 600 located in the shared physical space 210.

During this operation of superimposing 909 the shared virtual space 310 on the shared physical space 210, setting 959 the scale component 364 of the superimposing transformation 361 is performed by setting the scale component 364 to be of a greater magnitude, than is the magnitude of the transformation 360 already applied to the virtual camera object 330. This results in the overall transformation 360 applied to the virtual camera object 330 to cause such positioning of the virtual camera object 330, that the relative scale between the shared physical space 210 and the shared virtual space 310 appears to be changed in such way, that the shared virtual space 310 appears to be smaller in relation to the shared physical space 210, than it appeared before the scale component 364 has been set and applied. This appearance is perceived when the shared virtual space 310 is viewed on the portable interactive device 600 located in the shared physical space 210. The scale component 364 can also be modified by a user, so that it causes a different or a more suitable positioning of the virtual camera object 330, a more suitable relative scale of the two spaces, and a more suitable superimposing transformation 361 applied to the virtual camera object 330.

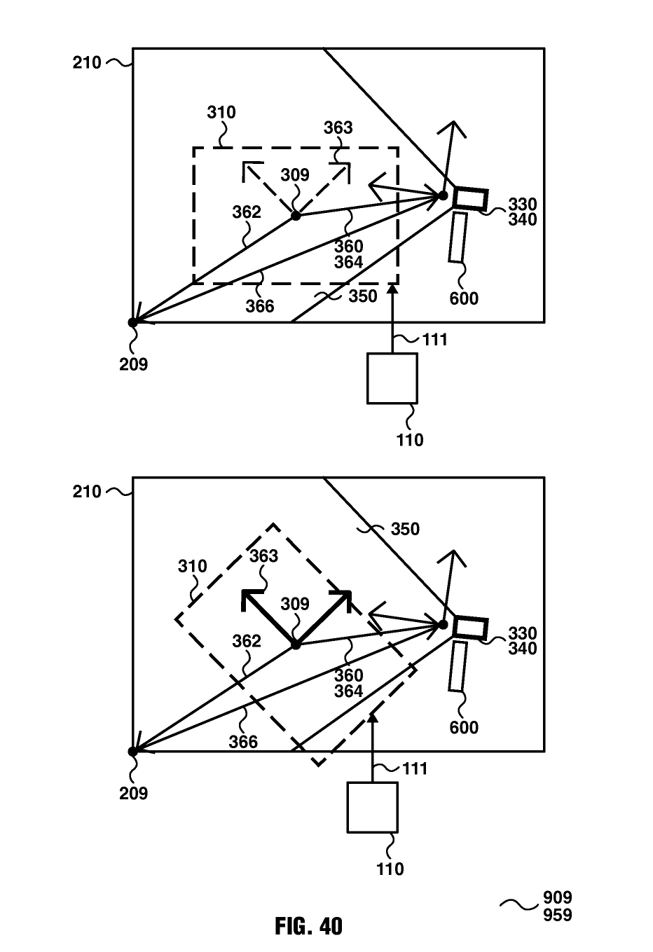

FIG. 40 shows an exemplary schematic diagram illustrating how setting 959 the rotation component 363 of the superimposing transformation 361 is performed, during the operation of superimposing 909 the shared virtual space 310 on the shared physical space 210, according to one embodiment of the present invention. The virtual camera object 330 is positioned and rotated in the shared virtual space 310, by the transformation 360 applied to it, which is based on the base transformation 366 and the translation component 362 of the superimposing transformation 361, and magnitude of which is modified by the scale component 364. The shared virtual space 310 appears to be superimposed on the shared physical space 210 when viewed using the portable interactive device 600. Also, the relative scale of the two spaces, as it appears when the shared virtual space 310 is viewed using the portable interactive device 600, is modified by applying the scale component 364 so that the shared virtual space 310 appears to be smaller in relation to the shared physical space 210, than it appeared before the scale component 364 has been set and applied. The spatial relationship of the two spaces can be further modified by setting the rotation component 363 of the superimposing transformation 361 and applying it to the transformation 360 applied to the virtual camera object 330. The rotation component 363 can be a vector or can also be a set of three angles, with each angle representing rotation around one axis.

In order to cause a change in the spatial relationship of the two spaces, the rotation component 363 is implemented as a vector with a different direction than the vector that represents the rotation of the shared virtual space 310 coordinate system at the origin 309. Therefore, such rotation component 363 is applied to the position and rotation of the virtual camera object 330, that the shared virtual space 310 coordinate system appears to be rotated at its origin 309 in the direction set by the rotation component 363, as the direction of the rotation component 363 appears when it is viewed using the portable interactive device 600 from the shared physical space 210. The rotation component 363 can be used to cause such appearance of rotation of the shared virtual space 310, that it is more precisely superimposed on the shared physical space 210, when such space is bounded by partitions such as walls, floors or ceilings that are not perfectly perpendicular to one another.

The translation component 362, the rotation component 363, and the scale component 364 of the superimposing transformation 361 can be set independently of each other and one component does not affect the resulting transformation caused by another component. The components can be set in any order, as long as the superimposing transformation 361 is applied in such way, that the result of each component is completely independent of the result caused by another component. The superimposing transformation 361 can be performed by separately applying each of the components to the position and rotation of the virtual camera object 330, or can be substituted by a transformation matrix, that includes values for all components and that is applied to the virtual camera object 330 at once.

Thus, the operation of superimposing 909 the shared virtual space 310 on the shared physical space 210 is performed by setting 959 all the components of the superimposing transformation 361, that is being applied to the virtual camera object 330 during the previously described operation of applying 908 transformation 360 to the virtual camera object 330. When the operation of applying 908 the transformation 360 to the virtual camera object 330 is performed again, the overall transformation 360 applied to the virtual camera object will not be affected only by the base transformation 360, that is based only on the position and rotation 690 of the portable interactive device 600 in the shared physical space 210, but also on the superimposing transformation 361 that is now set 959 to a value other than zero by completing this operation 909.

In this example, the superimposing transformation 361 is further set to cause the shared virtual space 310 to appear superimposed on the share physical space 210 in such way, that it is completely encapsulated by and it is completely aligned with the shared physical space 210.

The operation of superimposing 909 the shared virtual space 310 on the shared physical space 210 can be performed variously, as setting 959 the superimposing transformation 361 can be performed in multiple ways. One way of setting 959 the superimposing transformation 361 is by loading and applying 969 a stored superimposing transformation 361. Another way of setting 959 the superimposing transformation 361 is by first creating and storing 979 a new superimposing transformation 361 and then loading and applying 969 the newly created stored superimposing transformation 361 to the transformation 360 applied to the position and rotation of the virtual camera object 330. Creating of a new superimposing transformation 361 can be performed by manually manipulating values that modify each component 362, 363, 364 of the superimposing transformation 361 individually. Such manual manipulation can be performed by registering input signals 632 received from the portable interactive device 600 using the connection 700 between the computing device 500 and the portable interactive device 600, and executing functions corresponding to the registered input signals 632. These functions performed by the computing device 500 then modify the components 362, 363, 364 of the superimposing transformation 361. Storing and loading the superimposing transformation 361 configuration can be performed by writing and reading data from any memory 512 of the computing device 500 or memory, that the computing device 500 has access to. Applying the superimposing transformation 361 is performed during the previously described operation of applying 908 transformation 360 to the virtual camera object 330.

For the purpose of allowing manipulation of values that modify the components 362, 363, 364 of the superimposing transformation 361 by registering input signals 632 performed by a user, various interactive objects such as menus, text fields, buttons, sliders or three-dimensional virtual objects can be provided by being displayed in the view 370 of the shared virtual space 310 and/or the graphical user interface overlay 380. These various interactive objects can then be manipulated by performing input signals 632 that allow manipulation of such interactive objects, on the portable interactive device 600 by a user. Other interactions can be performed, and other functions can be initiated by a user, when the following operations are performed by the computing device 500.

Interaction with detailed 321 virtual objects 320 of the shared virtual space 310 superimposed on the shared physical space 210 is possible by performing several remaining operations. One of the operations that allow the actual interaction with virtual objects 320, is an operation of identifying 910 points 391 in the shared virtual space 310, which are encompassed by the virtual cursor 390. Another one of the operations that allow the actual interaction with virtual objects 320, is an operation of receiving 911 input signals 632 from the portable interactive device 600. And the last one of the operations that allow the actual interaction with virtual objects 320, is an operation of executing 912 functions corresponding to the input signals 632 and the identified points 392.

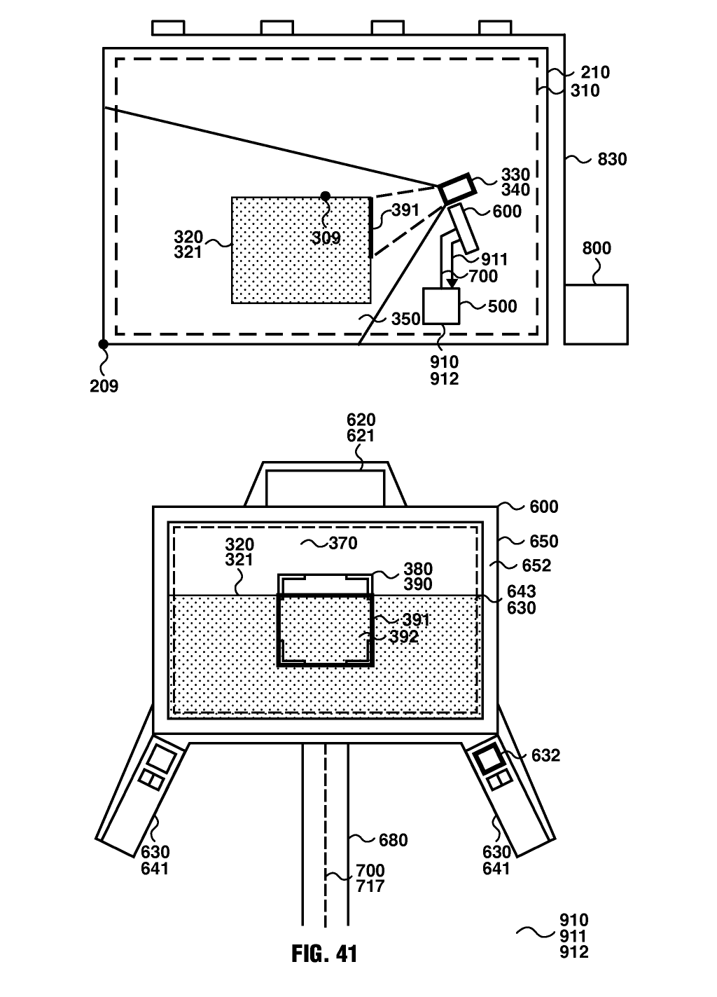

FIG. 41 shows an exemplary schematic diagram illustrating three operations of the method 900, the operations of identifying 910 points 391 in the shared virtual space 310 encompassed by the virtual cursor 380, receiving 911 input signals 632 from the portable interactive device 600, and executing 912 functions corresponding to the input signals 632 and the identified points 392, according to one embodiment of the present invention. During these operations, the portable interactive device 600 is positioned in the shared physical space 210 and is displaying a view of the shared virtual space 310 that contains detailed 321 virtual objects 320 of the shared virtual space 310. The shared virtual space 310 and the detailed 321 virtual objects 320 it contains appear to be superimposed on the shared physical space 210 as the shared virtual space 310 is viewed using the portable interactive device 600 located within the shared physical space 210. The view 370 of the shared virtual space 310 is overlaid with a graphical user interface overlay 380 that comprises a virtual cursor 390. The virtual cursor is encompassing points in the shared virtual space 310. The encompassed points 391 are points, that are located on one or more detailed 321 virtual objects 320, which are populating the shared virtual space 310, and projection of the points in the view 370 of the shared virtual space 310 is overlaid by the virtual cursor 390.

The operation of identifying 910 points 391 in the shared virtual space 310, which are encompassed by the virtual cursor 390 is performed by storing the encompassed points 391, which can be interacted with, and which are located on the detailed 321 virtual objects 320 as one or more variables. The variables that contain information about the encompassed points that can be interacted with are called the identified points 392. Identified points 392 can be further used as input parameters for other functions, such as functions that correspond to input signals 362 performed by a user.

The operation of receiving 911 input signals 632 from the portable interactive device 600 is performed by receiving data or signals which describe the performed input signals 632 and then storing the data or signals that describe the performed input signals 632. The input signals 632 are performed by a user using an input device module 630 of the portable interactive device 600, which registers the input signals 632 and transmits the input signals 630 to the computing device 500 using a connection 700 established between the computing device 500 and the portable interactive device 600. The data or signals that are transmitted from the portable interactive device 600 to the computing device 500 using the connection 700 can be any form of data or signals, which are readable by the computing device. The received input signals 632 are stored as one or more variables. The variables that contain information describing the performed input signals 632 can be further used as input parameters for other functions, such as functions that directly correspond to the received input signals 362.

The operation of executing 912 functions corresponding to the received input signals 632 and the identified points 392 is performed by simply determining what functions correspond to the received input signals 632 and then performing the corresponding functions with the identified points 392 as input parameters of the functions. The received input signals 632 can also be used as input parameters of such functions. The functions can be any other one or more processes or operations, that have not been described here, which are generally used for enabling interaction with the detailed 321 virtual objects 320 of the shared virtual space 310 superimposed for all users identically on the shared physical space 210, but can also be used for other purposes as well, such as modification of the detailed 321 virtual objects 320.

The overall result of performing all of these operations of the method 900 by the computing device 500 is that a multi-user group 160 is able to interact with detailed 321 virtual objects 320 of a shared virtual space 310 that is at the same time superimposed for all users identically on a shared physical space 210. The experiences that can be achieved by individual users of such multi-user group 160 during such interaction, which is enabled by the various embodiments of the present invention that were described, are collectively called a multi-user virtual reality interaction environment experience 100.

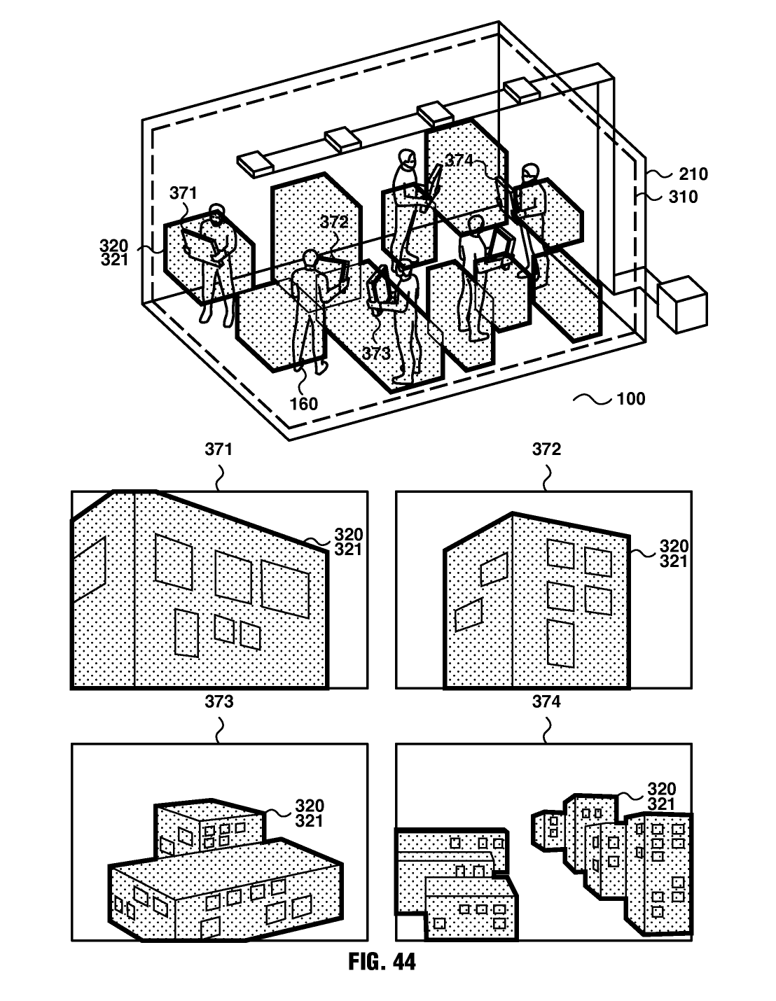

FIG. 44 shows an exemplary schematic diagram of such interaction with detailed 321 virtual objects 320 of a shared virtual space 310 that is at the same time superimposed for all users identically on a shared physical space 210, which is enabled by the various embodiments of the present invention, according to one embodiment of the present invention. The performance of the depicted interaction by users of the multi-user group 160 results in creating a multi-user virtual reality interaction environment experience 100 with simultaneous virtual and physical collaboration and communication of users of the multi-user group 160. Each user is manually positioning and operating a portable interactive device with a tracker 600 and each user is viewing an individual view 371, 372, 373, 374 of the shared virtual space 310 each displayed using one unique portable interactive device with a tracker 600. The portable interactive devices 600 operated by these users are tracked in the shared physical space 210 by the tracking server 800. Therefore, the motion that the users of the multi-user group 160 perform with their portable interactive devices 600 is captured and applied to the virtual camera objects 330 that comprise virtual cameras 340, fields of view 350 of which define the views 371, 372, 373, 374 generated and displayed by the portable interactive devices 600.

Users of the multi-user group 160 are therefore able to manually position their portable interactive devices 600 and view completely individual views 371, 372, 373, 374 of the shared virtual space 310. Users of the multi-user group 160 can also communicate and collaborate with each other within the shared physical space 210 as their view of one another is not obstructed and normal face-to-face communication is possible. The two spaces, the shared virtual space 310 and the shared physical space 210 are highly interrelated and intuitive to navigate and collaborate in, as positions of users within the shared physical space 210, which can be perceived by each individual user by simply looking around the shared physical space 210, directly indicate their areas of interaction within the shared virtual space 310. Positions and rotations of portable interactive devices 600 within the shared physical space 210 also indicate what portion of the shared virtual space 310 each user is currently viewing. The freedom of movement, precision and familiarity, which stem from natural human ability to use hands to manipulate physical objects, allow each user of the multi-user group 160 to effortlessly acquire a great range of views 370 of the shared virtual space 310. Such great range of possible views 370 is illustrated by the set of individual views 371, 372, 373, 374, each view 370 of which results simply from different positioning of the portable interactive devices 600 in the shared physical space. The great range of possible views 370 is achieved by various positioning of the virtual camera objects 330 in the shared virtual space 310, in which fields of view 350 of individual virtual cameras 340 of the virtual camera objects 330 can be used to define the individual views 371, 372, 373, 374. The views 370 reveal various parts of the detailed 321 virtual objects 320 of the shared virtual space 310, and allow users of the multi-user group 160 to interact with variously small or large parts of the detailed 321 virtual objects 320. Using hand movement to manually position the portable interactive devices 600 gives greater precision, range of views, and freedom of movement, than any other body part could give if it was used to control the views 370.

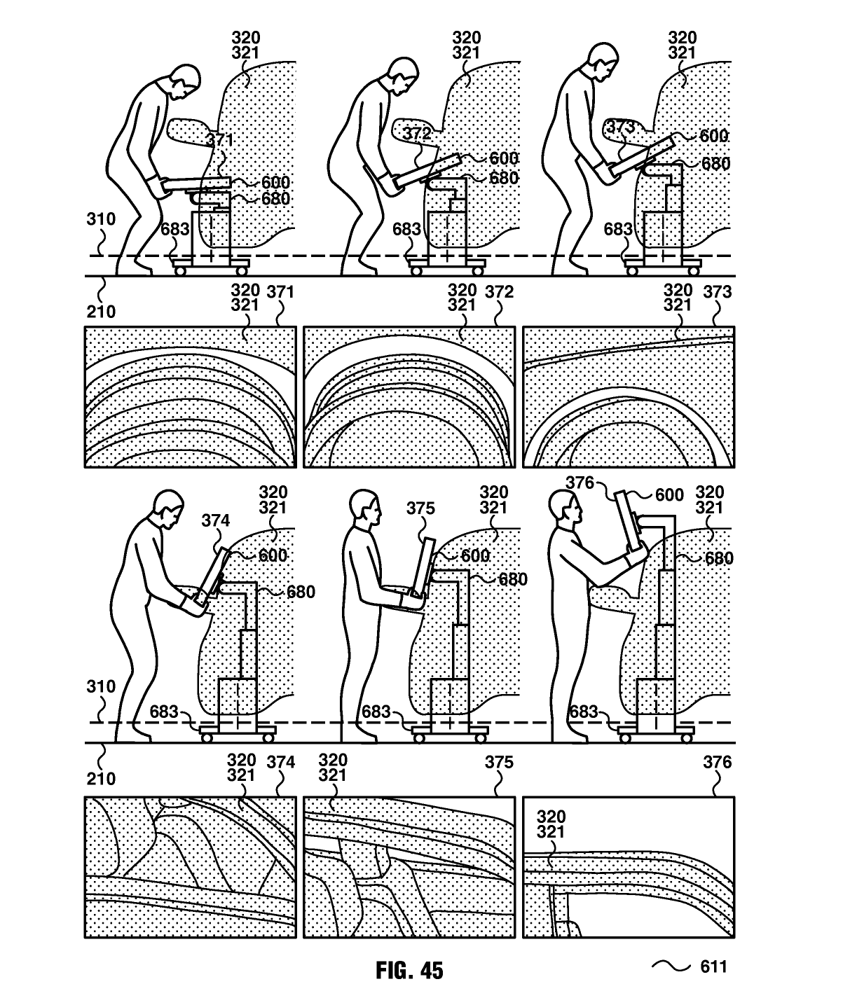

FIG. 45 shows an exemplary schematic diagram illustrating manual movement 611 of a portable interactive device 600 within a shared physical space 210 and a sequence of views 371, 372, 373, 374, 375 of a shared virtual space 310 resulting from the manual movement 611 of the portable interactive device 600 within the shared physical space 210, according to one embodiment of the present invention. The depicted portable interactive device 600 is manually moved in the shared physical space 210 and the view 370 of the shared virtual space 310 is being controlled by this movement with great precision, resulting in a sequence of views 371, 372, 373, 374, 375 which shows a great range of possible angles and distances in the shared virtual space 310 from which the views 370 that contain the detailed 321 virtual objects 320 can be generated. Such high precision and range is achieved with only a simple manual movement 611 of the portable interactive device 600 that causes the virtual camera object 330 to be positioned in the shared virtual space 310 into all the various positions, in which the field of view 350 of its virtual camera 340 can be used to define individual views 370 of the sequence of views 371, 372, 373, 374, 375. The individual views 370 of the sequence of views 371, 372, 373, 374, 375 demonstrate the simplicity with which a user can precisely regulate the parts of the detailed 321 virtual objects 320 that are displayed to him in the views 370. The portable interactive device 600 in this example is attached to an adjustable mount 680, which is attached to a wheeled chassis 683. It is therefore also shown, that such adjustable mount 680 further reinforces the ease of interaction with the detailed 321 virtual objects 320, as it allows the portable interactive device 600 to be manually positioned in the shared physical space 210 naturally and in all possible directions and rotated around all three axes of the shared physical space 210, but it also lifts the weight of the portable interactive device 600 from the hands of the user. Using the portable interactive device 600 configured this way allows the user to concentrate only on performing the manual movement 611 and interacting with the displayed detailed 321 virtual objects 320, without worrying about the weight of the portable interactive device 600.

The precision of interaction with detailed 321 virtual objects 320 of the shared virtual space 310 is further supported by the inclusion of a virtual cursor 390 as part of the graphical user interface overlay 380. The virtual cursor 390 is displayed overlaying the view 370 of the shared virtual space 310 and is used to precisely encompass points 391 and identify points 392 that are located on the detailed 321 virtual objects 320. The virtual cursor 390 enables to use the manual movement 611 of the portable interactive device 600 in the shared physical space 210 not only for manipulation of the view 370 of the shared virtual space 310, but also for precise targeting of detailed 321 virtual objects 320, and their parts or points that are located on them. Therefore, with simple manual movement 611 of the portable interactive device 600, a user can precisely target and identify points of interaction with detailed 321 virtual objects 320 as well as change the displayed view 370 of the shared virtual space 310. This means, that input signals 632 are not required to be used for manipulating views 370 and for targeting, selecting or identifying detailed 321 virtual objects 320 or their parts, and are reserved only for performing the actual interactions with the detailed 321 virtual objects 320. This further contributes to the intuitiveness of the interaction that is provided by the various embodiments of the present invention.

All the various embodiments of the present invention contribute to enabling multi-user interaction with detailed 321 virtual objects 320 of a shared virtual space 310 superimposed for all users identically on a shared physical space 210. To enable such interaction, problems of conventional techniques for enabling interaction with virtual spaces, which prevent them from enabling multi-user interaction with detailed 321 virtual objects 320 of a shared virtual space 310 superimposed for all users identically on a shared physical space 210, are overcome by the various embodiments of the present invention and further advantages are provided. Not all advantages are required to be exhibited by the systems, devices, methods and computer-readable storage mediums provided by the various embodiments of the present invention during their implementation, for them to properly enable the multi-user interaction described herein.

Various embodiments of the present invention overcome problems of conventional techniques for providing interaction with virtual spaces, primarily by allowing multiple users to shared the same physical space and collaborate and communicate within it naturally and with face-to-face contact, while interacting with the virtual space. Problems of some conventional techniques are further overcome by exhibiting various advantages by the various embodiments, such as allowing multiple users to share the same virtual space from the shared physical space and collaborate simultaneously within the two spaces; allowing users to interact with virtual spaces using devices that do not separate location of performing motion input from the location of visual output of the devices; allowing users to utilize the whole shared physical space for motion input and interaction, not being attached to a certain area; keeping users visually connected to their surrounding physical space; allowing precise, natural and effortless viewing of details of detailed virtual objects without having to move into awkward positions to reveal the details; simplifying implementation by not requiring perfect synchronization of the motion of virtual cameras with the motion of display devices to prevent motion sickness of users; not requiring special software functions for zooming in on the details of detailed virtual objects; providing individual views to each user, while also maintaining a shared virtual space superimposed on the shared physical space identically for all users; allowing users to clearly see positions of other users in physical space and their areas of interaction in virtual space by simply looking around; being independent of reference objects or images in physical space, usage of which prevents multiple users to use the same physical space for interaction; being feasible and suitable for regular indoor environment usage; allowing multiple devices to be tracked in physical space by sharing tracking data with multiple computing devices; providing precise mechanism for targeting, selecting and identifying points for interacting with detailed virtual objects in the form of a motion controlled virtual cursor; allowing display devices of hand-operated devices to be of larger sizes than standard sizes of mobile devices; or allowing usage of stationary computing devices with less limited processing capabilities than those of mobile devices.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, for example by designing electronic circuits to perform the operation, by programming programmable electronic circuits, such as microprocessors, to perform the operation, or any combination thereof. Further, while the embodiments described above can make reference to specific hardware and software components, those skilled in the art will appreciate that different combinations of hardware and/or software components can also be used and that particular operations described as being implemented in hardware might also be implemented in software or vice versa.

Computer programs incorporating various features of the present invention can be encoded and stored on various computer-readable storage media; suitable media include magnetic disk or tape, optical storage media such as compact disk (CD) or digital versatile disk (DVD), flash memory, and other non-transitory media. Computer readable media encoded with the program code can be packaged with a compatible electronic device, or the program code can be provided separately from electronic devices, for example via internet download or as a separately packaged computer-readable storage medium. Such computer programs may be implemented in a high-level procedural or object-oriented programming language, or in assembly or machine language if desired, and in any case, the language may be compiled or interpreted language.

Although a few embodiments of the present invention have been illustrated in the accompanying drawings and described in the foregoing description, it will be appreciated by those skilled in the art that changes and modifications can be made to these embodiments without departing from the principles and spirit of the invention. Accordingly, the presently described embodiments are in all respects to be illustrative and not restrictive, and the present invention is not limited to the described embodiments. The embodiments were chosen and described in order to best explain the principles of the invention and its practical applications, to thereby enable those skilled in the art to best utilize the invention and various embodiments with various modifications as are suited to the particular use contemplated. The scope of the invention should not be limited by any of the described embodiments, but should be defined only in accordance with the appended claims and their equivalents. All changes that come within the meaning and range of the equivalents of the appended claims are intended to be included within the scope of the invention.

What is claimed is:

1. A method for enabling multi-user interaction with detailed virtual objects of a shared virtual space superimposed for all users identically on a shared physical space, the method comprising:
at a computing device connected to one portable interactive device with a tracker:
accessing a multi-user virtual reality session, which is managing a shared virtual space;
placing at least one virtual camera object into the shared virtual space, wherein the at least one virtual camera object comprises at least one virtual camera;
generating a view of the shared virtual space defined by the field of view of the at least one virtual camera of the at least one virtual camera object;
generating a graphical user interface overlay comprising a virtual cursor encompassing points in the shared virtual space;
transmitting the view of the shared virtual space and the graphical user interface overlay to the portable interactive device to be displayed, by means of the connection between the computing device and the portable interactive device;
populating the shared virtual space with at least one detailed virtual object;
acquiring tracking data from a tracking server, wherein the tracking data is used to determine the position and rotation of the portable interactive device in the shared physical space;
applying transformation to the at least one virtual camera object in the shared virtual space basing on the tracking data and a superimposing transformation, thereby allowing control of the view of the shared virtual space and the points encompassed by the virtual cursor with manual movement of the portable interactive device within the shared physical space;
superimposing the shared virtual space on the shared physical space by setting the superimposing transformation applied to the at least one virtual camera object;
identifying points in the shared virtual space encompassed by the virtual cursor, wherein the identified points are located on the at least one detailed virtual object;
receiving input signals from the portable interactive device, by means of the connection between the computing device and the portable interactive device; and
executing functions corresponding to the input signals and the identified points located on the at least one detailed virtual object;
wherein the at least one detailed virtual object is a virtual object occupying the shared virtual space with density of geometric features per one virtual space volume unit substantially higher than 10000, the one virtual space volume unit being a conceptual measurement unit being superimposed on and effectively corresponding to one cubic foot of physical space; and
wherein the geometric features of virtual objects are points that define the spatial form of the virtual objects.

2. The method of claim 1, wherein the portable interactive device with a tracker has one or more of the following characteristics:
the portable interactive device with a tracker comprises an input device module registering one or more of the following input signals:
pressing physical buttons, moving physical joysticks, touching touch sensitive surfaces, moving virtual joysticks on touch sensitive surfaces, tapping virtual buttons on touch sensitive surfaces, performing hand gestures on touch sensitive surfaces, performing hand gestures in-air, performing eye movement, or performing sounds;
the portable interactive device with a tracker comprises a device module enabling the connection of the portable interactive device with a tracker to the computing device, the device module selected from the group consisting of
a thin client, an ultra-thin client, or a zero client;
the portable interactive device with a tracker comprises a complementary display module displaying one or more of the following:
the view of the shared virtual space, or the graphical user interface overlay comprising the virtual cursor;
the tracker is a device from the group consisting of
an electromagnetic tracking sensor, a set of passive tracking markers bearing a retro-reflective material acting as a single rigid object, a set of active tracking markers emitting light acting as a single rigid object, or a set of infrared tracking sensors; or
the tracker is mechanically attached to the portable interactive device.

3. The method of claim 1, wherein the computing device has one or more of the following characteristics:
the computing device is connected to the portable interactive device with a tracker by a connection selected from the group consisting of
an internet connection, a wide area network connection, a metropolitan area network connection, a wired local area network connection, a wireless local area network connection, a radio wave connection, or a computer bus connection;
the computing device is a device selected from the group consisting of
a computer, a portable computer, a wearable computer, a tablet, a mobile phone, a gaming console or a portable gaming console;
the computing device and the portable interactive device with a tracker are combined into a composite device;
the computing device and the tracking server are combined into a composite device; or
the computing device is a virtual machine running on a physical server.

4. The method of claim 1, characterized by one or more of the following characteristics:
the accessing a multi-user virtual reality session operation is performed by joining the session using a network connection established between the computing device and another computing device;
the accessing a multi-user virtual reality session operation is performed by hosting the session, wherein the session is made accessible to other computing devices using a network connection;
the acquiring tracking data from a tracking server operation is performed using a connection between the computing device and the tracking server, the connection selected from the group consisting of
an internet connection, a wide area network connection, a metropolitan area network connection, a wired local area network connection, a wireless local area network connection, a radio wave connection, or a computer bus connection; or
the applying transformation to the at least one virtual camera object operation further comprises
applying smoothing to the transformation applied to the at least one virtual camera object.

5. The method of claim 1, wherein said placing at least one virtual camera object into the shared virtual space operation comprises
placing multiple virtual cameras as hierarchy children of the at least one virtual camera object, the virtual cameras being variously positioned in the shared virtual space in relation to the at least one virtual camera object and inheriting changes in position and rotation of the at least one virtual camera object;
and said generating a view of the shared virtual space operation comprises
generating multiple views of the shared virtual space, each view of the shared virtual space being defined by the field of view of a different virtual camera of the at least one virtual camera object.

6. The method of claim 1, wherein said generating a graphical user interface overlay operation further comprises
applying a configuration to the virtual cursor selected from the group consisting of:
a configuration setting the virtual cursor to be opaque;
a configuration setting the virtual cursor to be transparent;
a configuration setting the virtual cursor to be semi-transparent;
a configuration setting the virtual cursor to occupy a rectangle of such size in pixels, so that it is equivalent to the size of a display of the portable interactive device that is used to display the graphical user interface overlay; or
a configuration setting the virtual cursor to not change its position within the graphical user interface overlay.

7. The method of claim 1, wherein said superimposing the shared virtual space on the shared physical space operation comprises setting the superimposing transformation applied to the at least one virtual camera object by performing one of the following:
loading and applying a stored superimposing transformation configuration; or
creating and storing a new superimposing transformation configuration, and loading and applying the new superimposing transformation configuration;
wherein said creating a new superimposing transformation configuration operation is performed by receiving input signals from the portable interactive device and executing functions corresponding to the input signals, the functions modifying the translation component, the rotation component and the scale component of the superimposing transformation.

8. A non-transitory computer-readable storage medium storing one or more programs, the one or more programs comprising instructions, which when executed by a computing device connected to one portable interactive device with a tracker cause the computing device to perform operations for enabling multi-user interaction with detailed virtual objects of a shared virtual space superimposed for all users identically on a shared physical space, the operations comprising:
accessing a multi-user virtual reality session, which is managing a shared virtual space;
placing at least one virtual camera object into the shared virtual space, wherein the at least one virtual camera object comprises at least one virtual camera;
generating a view of the shared virtual space defined by the field of view of the at least one virtual camera of the at least one virtual camera object;
generating a graphical user interface overlay comprising a virtual cursor encompassing points in the shared virtual space;
transmitting the view of the shared virtual space and the graphical user interface overlay to the portable interactive device to be displayed, by means of the connection between the computing device and the portable interactive device;
populating the shared virtual space with at least one detailed virtual object;
acquiring tracking data from a tracking server, wherein the tracking data is used to determine the position and rotation of the portable interactive device in the shared physical space;
applying transformation to the at least one virtual camera object in the shared virtual space basing on the tracking data and a superimposing transformation, thereby allowing control of the view of the shared virtual space and the points encompassed by the virtual cursor with manual movement of the portable interactive device within the shared physical space;
superimposing the shared virtual space on the shared physical space by setting the superimposing transformation applied to the at least one virtual camera object;
identifying points in the shared virtual space encompassed by the virtual cursor, wherein the identified points are located on the at least one detailed virtual object;
receiving input signals from the portable interactive device, by means of the connection between the computing device and the portable interactive device; and
executing functions corresponding to the input signals and the identified points located on the at least one detailed virtual object;
wherein the at least one detailed virtual object is a virtual object occupying the shared virtual space with density of geometric features per one virtual space volume unit substantially higher than 10000, the one virtual space volume unit being a conceptual measurement unit being superimposed on and effectively corresponding to one cubic foot of physical space; and
wherein the geometric features of virtual objects are points that define the spatial form of the virtual objects.

9. The non-transitory computer readable storage medium of claim 8, wherein the portable interactive device with a tracker has one or more of the following characteristics:
the portable interactive device with a tracker comprises an input device module registering one or more of the following input signals:
pressing physical buttons, moving physical joysticks, touching touch sensitive surfaces, moving virtual joysticks on touch sensitive surfaces, tapping virtual buttons on touch sensitive surfaces, performing hand gestures on touch sensitive surfaces, performing hand gestures in-air, performing eye movement, or performing sounds;
the portable interactive device with a tracker comprises a device module enabling the connection of the portable interactive device with a tracker to the computing device, the device module selected from the group consisting of
a thin client, an ultra-thin client, or a zero client;
the portable interactive device with a tracker comprises a complementary display module displaying one or more of the following:
the view of the shared virtual space, or the graphical user interface overlay comprising the virtual cursor;
the tracker is a device selected from the group consisting of
an electromagnetic tracking sensor, a set of passive tracking markers bearing a retro-reflective material acting as a single rigid object, a set of active tracking markers emitting light acting as a single rigid object, or a set of infrared tracking sensors; or
the tracker is mechanically attached to the portable interactive device.

10. The non-transitory computer readable storage medium of claim 8, wherein the computing device has one or more of the following characteristics:
the computing device is connected to the portable interactive device with a tracker by a connection selected from the group consisting of
an internet connection, a wide area network connection, a metropolitan area network connection, a wired local area network connection, a wireless local area network connection, a radio wave connection, or a computer bus connection;
the computing device is a device selected from the group consisting of
a computer, a portable computer, a wearable computer, a tablet, a mobile phone, a gaming console or a portable gaming console;
the computing device and the portable interactive device with a tracker are combined into a composite device;
the computing device and the tracking server are combined into a composite device; or
the computing device is a virtual machine running on a physical server.

11. The non-transitory computer readable storage medium of claim 8, wherein the instructions have one or more of the following characteristics:
the instructions causing the computing device to perform operations are configured to cause the computing device to perform the accessing a multi-user virtual reality session operation by joining the session using a network connection established between the computing device and another computing device;
the instructions causing the computing device to perform operations are configured to cause the computing device to perform the accessing a multi-user virtual reality session operation by hosting the session, wherein the session is made accessible to other computing devices using a network connection;
the instructions causing the computing device to perform operations are configured to cause the computing device to perform the acquiring tracking data from a tracking server operation using a connection between the computing device and the tracking server, the connection selected from the group consisting of
an internet connection, a wide area network connection, a metropolitan area network connection, a wired local area network connection, a wireless local area network connection, a radio wave connection, or a computer bus connection; or
the instructions causing the computing device to perform the applying transformation to the at least one virtual camera object operation further comprise instructions for
applying smoothing to the transformation applied to the at least one virtual camera object.

12. The non-transitory computer readable storage medium of claim 8, wherein the instructions causing the computing device to perform said placing at least one virtual camera object into the shared virtual space operation comprise instructions for:
placing multiple virtual cameras as hierarchy children of the at least one virtual camera object, the virtual cameras being variously positioned in the shared virtual space in relation to the at least one virtual camera object and inheriting changes in position and rotation of the at least one virtual camera object;
and the instructions causing the computing device to perform said generating a view of the shared virtual space operation comprise instructions for:
generating multiple views of the shared virtual space, each view of the shared virtual space being defined by the field of view of a different virtual camera of the at least one virtual camera object.

13. The non-transitory computer readable storage medium of claim 8, wherein the instructions causing the computing device to perform said generating a graphical user interface overlay operation further comprise instructions for:
applying a configuration to the virtual cursor selected from the group consisting of:
a configuration setting the virtual cursor to be opaque;
a configuration setting the virtual cursor to be transparent;
a configuration setting the virtual cursor to be semi-transparent;
a configuration setting the virtual cursor to occupy a rectangle of such size in pixels, so that it is equivalent to the size of a display of the portable interactive device that is used to display the graphical user interface overlay; or
a configuration setting the virtual cursor to not change its position within the graphical user interface overlay.

14. The non-transitory computer readable storage medium of claim 8, wherein the instructions causing the computing device to perform said superimposing the shared virtual space on the shared physical space operation comprise instructions for setting the superimposing transformation applied to the at least one virtual camera object by performing one of the following:
loading and applying a stored superimposing transformation configuration; or
creating and storing a new superimposing transformation configuration, and loading and applying the new superimposing transformation configuration;
wherein the instructions causing the computing device to perform operations are configured to perform said creating a new superimposing transformation configuration operation by receiving input signals from the portable interactive device and executing functions corresponding to the input signals, the functions modifying the translation component, the rotation component and the scale component of the superimposing transformation.

15. A system for enabling multi-user interaction with detailed virtual objects of a shared virtual space superimposed for all users identically on a shared physical space, the system comprising:
at least one portable interactive device, the at least one portable interactive device comprising:
a tracker;
a display device module displaying a view of a shared virtual space and a graphical user interface overlay comprising a virtual cursor;
an input device module registering input signals;
a connection to one computing device;
a tracking server tracking the position and rotation of the at least one portable interactive device with a tracker connected to the one computing device in the shared physical space; and
at least one computing device with a connection to one portable interactive device with a tracker, the at least one computing device comprising:
one or more processors;
memory; and
one or more programs, wherein the one or more programs are stored in the memory and configured to be executed by the one or more processors, the one or more programs comprising instructions causing the at least one computing device to perform operations for enabling multi-user interaction with detailed virtual objects of a shared virtual space superimposed for all users identically on a shared physical space, the operations comprising:
accessing a multi-user virtual reality session, which is managing a shared virtual space;
placing at least one virtual camera object into the shared virtual space, wherein the at least one virtual camera object comprises at least one virtual camera;
generating a view of the shared virtual space defined by the field of view of the at least one virtual camera of the at least one virtual camera object;
generating a graphical user interface overlay comprising a virtual cursor encompassing points in the shared virtual space;
transmitting the view of the shared virtual space and the graphical user interface overlay to the portable interactive device to be displayed, by means of the connection between the at least one computing device and the one portable interactive device;
populating the shared virtual space with at least one detailed virtual object;
acquiring tracking data from a tracking server, wherein the tracking data is used to determine the position and rotation of the portable interactive device in the shared physical space;
applying transformation to the at least one virtual camera object in the shared virtual space basing on the tracking data and a superimposing transformation, thereby allowing control of the view of the shared virtual space and the points encompassed by the virtual cursor with manual movement of the portable interactive device within the shared physical space;
superimposing the shared virtual space on the shared physical space by setting the superimposing transformation applied to the at least one virtual camera object;
identifying points in the shared virtual space encompassed by the virtual cursor, wherein the identified points are located on the at least one detailed virtual object;
receiving input signals from the portable interactive device, by means of the connection between the at least one computing device and the one portable interactive device; and
executing functions corresponding to the input signals and the identified points located on the at least one detailed virtual object;
wherein the at least one detailed virtual object is a virtual object occupying the shared virtual space with density of geometric features per one virtual space volume unit substantially higher than 10000, the one virtual space volume unit being a conceptual measurement unit being superimposed on and effectively corresponding to one cubic foot of physical space; and
wherein the geometric features of virtual objects are points that define the spatial form of the virtual objects.

16. The system of claim 15, wherein the tracking server comprises:
a tracking device module;
one or more processors;
memory; and
one or more programs, wherein the one or more programs are stored in the memory and configured to be executed by the one or more processors, the one or more programs comprising instructions causing the tracking server to perform operations for allowing computing devices to acquire tracking data, the operations comprising:
acquiring raw tracking data from the tracking device module;
storing the raw tracking data in the memory;
generating tracking data comprising tracker position and rotation data relative to an origin of the shared physical space from the stored raw tracking data; and
running a network server sharing the tracking data with other computing devices;
wherein the tracking device module is configured to track the position and rotation of the at least one portable interactive device with a tracker in the shared physical space by means of a tracking device selected from the group consisting of:
a set of tracking cameras, a set of electromagnetic receptors, or a set of infrared projectors.

17. The system of claim 15, wherein the portable interactive device with a tracker has one or more of the following characteristics:
the at least one portable interactive device comprises an input device module registering one or more of the following input signals:
pressing physical buttons, moving physical joysticks, touching touch sensitive surfaces, moving virtual joysticks on touch sensitive surfaces, tapping virtual buttons on touch sensitive surfaces, performing hand gestures on touch sensitive surfaces, performing hand gestures in-air, performing eye movement, or performing sounds;
the at least one portable interactive device comprises a device module enabling the connection of the at least one portable interactive device to the one computing device, the device module selected from the group consisting of
a thin client, an ultra-thin client, or a zero client;
the at least one portable interactive device comprises a complementary display module displaying one or more of the following:
the view of the shared virtual space, or the graphical user interface overlay comprising the virtual cursor;
the tracker is a device selected from the group consisting of
an electromagnetic tracking sensor, a set of passive tracking markers bearing a retro-reflective material acting as a single rigid object, a set of active tracking markers emitting light acting as a single rigid object, or a set of infrared tracking sensors; or
the tracker is mechanically attached to the at least one portable interactive device.

18. The system of claim 15, wherein the computing device has one or more of the following characteristics:
the at least one computing device is connected to the one portable interactive device with a tracker by a connection selected from the group consisting of
an internet connection, a wide area network connection, a metropolitan area network connection, a wired local area network connection, a wireless local area network connection, a radio wave connection, or a computer bus connection;
the at least one computing device is a device selected from the group consisting of
a computer, a portable computer, a wearable computer, a tablet, a mobile phone, a gaming console or a portable gaming console;
the at least one computing device and the one portable interactive device with a tracker are combined into a composite device;
the at least one computing device and the tracking server are combined into a composite device; or
the at least one computing device is a virtual machine running on a physical server.

19. The system of claim 15, wherein the tracking server has one or more of the following characteristics:
the tracking server and the at least one computing device are combined into a composite device; or
the tracking server is a virtual machine running on a physical server.

20. The system of claim 15, wherein the instructions have one or more of the following characteristics:
the instructions causing the at least one computing device to perform operations are configured to cause the at least one computing device to perform the accessing a multi-user virtual reality session operation by joining the session using a network connection established between the at least one computing device and another computing device;
the instructions causing the at least one computing device to perform operations are configured to cause the at least one computing device to perform the accessing a multi-user virtual reality session operation by hosting the session, wherein the session is made accessible to other computing devices using a network connection;
the instructions causing the at least one computing device to perform operations are configured to cause the at least one computing device to perform the acquiring tracking data from a tracking server operation using a connection between the at least one computing device and the tracking server, the connection selected from the group consisting of
an internet connection, a wide area network connection, a metropolitan area network connection, a wired local area network connection, a wireless local area network connection, a radio wave connection, or a computer bus connection; or
the instructions causing the at least one computing device to perform the applying transformation to the at least one virtual camera object operation further comprise instructions for
applying smoothing to the transformation applied to the at least one virtual camera object.

21. The system of claim 15, wherein the instructions causing the at least one computing device to perform said placing at least one virtual camera object into the shared virtual space operation comprise instructions for:
placing multiple virtual cameras as hierarchy children of the at least one virtual camera object, the virtual cameras being variously positioned in the shared virtual space in relation to the at least one virtual camera object and inheriting changes in position and rotation of the at least one virtual camera object;
and the instructions causing the at least one computing device to perform said generating a view of the shared virtual space operation comprise instructions for:
generating multiple views of the shared virtual space, each view of the shared virtual space being defined by the field of view of a different virtual camera of the at least one virtual camera object.

22. The system of claim 15, wherein the instructions causing the at least one computing device to perform said generating a graphical user interface overlay operation further comprise instructions for:
applying a configuration to the virtual cursor selected from the group consisting of:
a configuration setting the virtual cursor to be opaque;
a configuration setting the virtual cursor to be transparent;
a configuration setting the virtual cursor to be semi-transparent;
a configuration setting the virtual cursor to occupy a rectangle of such size in pixels, so that it is equivalent to the size of a display of the at least one portable interactive device that is used to display the graphical user interface overlay; or
a configuration setting the virtual cursor to not change its position within the graphical user interface overlay.

23. The system of claim 15, wherein the instructions causing the at least one computing device to perform said superimposing the shared virtual space on the shared physical space operation comprise instructions for setting the superimposing transformation applied to the at least one virtual camera object by performing one of the following:
loading and applying a stored superimposing transformation configuration; or
creating and storing a new superimposing transformation configuration, and loading and applying the new superimposing transformation configuration;
wherein the instructions causing the at least one computing device to perform operations are configured to perform said creating a new superimposing transformation configuration operation by receiving input signals from the one portable interactive device and executing functions corresponding to the input signals, the functions modifying the translation component, the rotation component and the scale component of the superimposing transformation.

24. A portable interactive device, comprising:
a tracker;
a display device module displaying a view of a shared virtual space and a graphical user interface overlay comprising a virtual cursor;
an input device module registering input signals;
a connection to one computing device, the computing device comprising:
one or more processors;
memory; and
one or more programs, wherein the one or more programs are stored in the memory and configured to be executed by the one or more processors, the one or more programs comprising instructions causing the computing device to perform operations for enabling multi-user interaction with detailed virtual objects of a shared virtual space superimposed for all users identically on a shared physical space, the operations comprising:
accessing a multi-user virtual reality session, which is managing a shared virtual space;
placing at least one virtual camera object into the shared virtual space, wherein the at least one virtual camera object comprises at least one virtual camera;
generating a view of the shared virtual space defined by the field of view of the at least one virtual camera of the at least one virtual camera object;
generating a graphical user interface overlay comprising a virtual cursor encompassing points in the shared virtual space;
transmitting the view of the shared virtual space and the graphical user interface overlay to the portable interactive device to be displayed, by means of the connection between the computing device and the portable interactive device;
populating the shared virtual space with at least one detailed virtual object;
acquiring tracking data from a tracking server, wherein the tracking data is used to determine the position and rotation of the portable interactive device in the shared physical space;
applying transformation to the at least one virtual camera object in the shared virtual space basing on the tracking data and a superimposing transformation, thereby allowing control of the view of the shared virtual space and the points encompassed by the virtual cursor with manual movement of the portable interactive device within the shared physical space;
superimposing the shared virtual space on the shared physical space by setting the superimposing transformation applied to the at least one virtual camera object;
identifying points in the shared virtual space encompassed by the virtual cursor, wherein the identified points are located on the at least one detailed virtual object;
receiving input signals from the portable interactive device, by means of the connection between the computing device and the portable interactive device; and
executing functions corresponding to the input signals and the identified points located on the at least one detailed virtual object;
wherein the at least one detailed virtual object is a virtual object occupying the shared virtual space with density of geometric features per one virtual space volume unit substantially higher than 10000, the one virtual space volume unit being a conceptual measurement unit being superimposed on and effectively corresponding to one cubic foot of physical space; and
wherein the geometric features of virtual objects are points that define the spatial form of the virtual objects.

25. The device of claim 24, characterized by one or more of the following characteristics:
the input device module registering input signals registers one or more of the following input signals:
pressing physical buttons, moving physical joysticks, touching touch sensitive surfaces, moving virtual joysticks on touch sensitive surfaces, tapping virtual buttons on touch sensitive surfaces, performing hand gestures on touch sensitive surfaces, performing hand gestures in-air, performing eye movement, or performing sounds;
the portable interactive device with a tracker comprises a device module enabling the connection of the portable interactive device with a tracker to the computing device, the device module selected from the group consisting of
a thin client, an ultra-thin client, or a zero client;
the portable interactive device with a tracker comprises a complementary display module displaying one or more of the following:
the view of the shared virtual space, or the graphical user interface overlay comprising the virtual cursor;
the tracker is a device selected from the group consisting of
an electromagnetic tracking sensor, a set of passive tracking markers bearing a retro-reflective material acting as a single rigid object, a set of active tracking markers emitting light acting as a single rigid object, or a set of infrared tracking sensors; or
the tracker is mechanically attached to the one portable interactive device.

26. The device of claim 24, wherein the computing device has one or more of the following characteristics:
the one computing device is connected to the portable interactive device by a connection selected from the group consisting of
an internet connection, a wide area network connection, a metropolitan area network connection, a wired local area network connection, a wireless local area network connection, a radio wave connection, or a computer bus connection;
the one computing device is a device selected from the group consisting of
a computer, a portable computer, a wearable computer, a tablet, a mobile phone, a gaming console or a portable gaming console;
the one computing device and the portable interactive device are combined into a composite device;
the one computing device and the tracking server are combined into a composite device; or
the one computing device is a virtual machine running on a physical server.

27. The device of claim 24, wherein the instructions have one or more of the following characteristics:
the instructions causing the one computing device to perform operations are configured to cause the one computing device to perform the accessing a multi-user virtual reality session operation by joining the session using a network connection established between the one computing device and another computing device;
the instructions causing the one computing device to perform operations are configured to cause the one computing device to perform the accessing a multi-user virtual reality session operation by hosting the session, wherein the session is made accessible to other computing devices using a network connection;
the instructions causing the one computing device to perform operations are configured to cause the one computing device to perform the acquiring tracking data from a tracking server operation using a connection between the one computing device and the tracking server, the connection selected from the group consisting of
an internet connection, a wide area network connection, a metropolitan area network connection, a wired local area network connection, a wireless local area network connection, a radio wave connection, or a computer bus connection; or
the instructions causing the one computing device to perform the applying transformation to the at least one virtual camera object operation further comprise instructions for
applying smoothing to the transformation applied to the at least one virtual camera object.

28. The device of claim 24, wherein the instructions causing the one computing device to perform said placing at least one virtual camera object into the shared virtual space operation comprise instructions for:
placing multiple virtual cameras as hierarchy children of the at least one virtual camera object, the virtual cameras being variously positioned in the shared virtual space in relation to the at least one virtual camera object and inheriting changes in position and rotation of the at least one virtual camera object;
and the instructions causing the one computing device to perform said generating a view of the shared virtual space operation comprise instructions for:
generating multiple views of the shared virtual space, each view of the shared virtual space being defined by the field of view of a different virtual camera of the at least one virtual camera object.

29. The device of claim 24, wherein the instructions causing the one computing device to perform said generating a graphical user interface overlay operation further comprise instructions for:
applying a configuration to the virtual cursor selected from the group consisting of:
a configuration setting the virtual cursor to be opaque;
a configuration setting the virtual cursor to be transparent;
a configuration setting the virtual cursor to be semi-transparent;
a configuration setting the virtual cursor to occupy a rectangle of such size in pixels, so that it is equivalent to the size of a display of the portable interactive device that is used to display the graphical user interface overlay; or
a configuration setting the virtual cursor to not change its position within the graphical user interface overlay.

30. The device of claim 24, wherein the instructions causing the one computing device to perform said superimposing the shared virtual space on the shared physical space operation comprise instructions for setting the superimposing transformation applied to the at least one virtual camera object by performing one of the following:
loading and applying a stored superimposing transformation configuration; or
creating and storing a new superimposing transformation configuration, and loading and applying the new superimposing transformation configuration;
wherein the instructions causing the one computing device to perform operations are configured to perform said creating a new superimposing transformation configuration operation by receiving input signals from the portable interactive device and executing functions corresponding to the input signals, the functions modifying the translation component, the rotation component and the scale component of the superimposing transformation.

31. The device of claim 24, further comprising
an adjustable mount holding the position and rotation of the portable interactive device within the shared physical space, the adjustable mount being attached to a wheeled chassis enabling movement of the portable interactive device in the shared physical space, without performing adjustments to the adjustable mount.
